(19) United States
(12) Patent Application Publication
(10) Pub. No.: US 2026/0213281 A1
(43) Pub. Date: Jul. 23, 2026

(54) WINDING DEVICE, BATTERY PROCESSING DEVICE AND BATTERY PRODUCTION LINE

(71) Applicant: CONTEMPORARY AMPEREX TECHNOLOGY CO., LIMITED, Ningde (CN)

(72) Inventors: Zhongping Luo, Ningde (CN); Ming Xie, Ningde (CN); Xin Zhang, Ningde (CN); Zhibin Li, Ningde (CN); Wenfa Lin, Ningde (CN); Minghao Tang, Ningde (CN); Shengwu Zhang, Ningde (CN)

(21) Appl. No.: 19/557,158

(22) Filed: Mar. 5, 2026

Related U.S. Application Data
(63) Continuation of application No. PCT/CN2024/135267, filed on Nov. 28, 2024.

(30) Foreign Application Priority Data
Sep. 28, 2023 (CN) 202322664538.X
Nov. 10, 2023 (CN) 202311498575.6
Jan. 11, 2024 (CN) 202410043912.0
Jan. 11, 2024 (CN) 202420072183.7
May 7, 2024 (CN) 202410557506.6
May 7, 2024 (CN) 202410557866.6
Sep. 28, 2024 (WO) PCT/CN2024/122087

(51) Int. Cl. H01M 10/0587; G06T 7/00; G06T 7/13

(52) U.S. Cl. CPC H01M 10/0587; G06T 7/0006; G06T 7/13; G06T 2207/10004; G06T 2207/30108

(57) ABSTRACT

Provided are a winding device, a battery processing device and a battery production line, which belong to the technical field of battery manufacturing. The winding device includes a first combining mechanism, a winding mechanism, and a first detection apparatus. The first combining mechanism is configured to combine incoming materials including at least a first electrode plate, a first separator, and a second electrode plate into a first composite plate. The first detection apparatus includes a first image acquisition apparatus and a processor; the first image acquisition apparatus is disposed between the first combining mechanism and the winding mechanism an configured to obtain edge position images of at least one of the first electrode plate and the second electrode plate in the first composite plate; and the processor is configured to determine an edge distance based on the edge position images and judge whether the edge distance meets a threshold.

### CROSS-REFERENCE TO RELATED APPLICATIONS

The present application is a continuation of International Application No. PCT/CN2024/135267, filed on Nov. 28, 2024, which claims priority to Chinese patent application No. PCT/CN2024/122087 filed on Sep. 28, 2024, Chinese patent application No. 202322664538.X filed on Sep. 28, 2023, Chinese patent application No. 202311498575.6 filed on Nov. 10, 2023, Chinese patent application No. 202410043912.0 filed on Jan. 11, 2024, Chinese patent application No. 202420072183.7 filed on Jan. 11, 2024, Chinese patent application No. 202410557866.6 filed on May 7, 2024, and Chinese patent application No. 202410557506.6 filed on May 7, 2024, and claims priority to these Chinese Patent applications, which are hereby incorporated into the present disclosure as a reference.

### TECHNICAL FIELD

The present application relates to the technical field of batteries, and in particular, to a winding device, a battery processing device and a battery production line.

### BACKGROUND

In the related technologies, during the production of electrode assemblies using winding devices, negative electrode plates, positive electrode plates and separators are fed into winding mechanisms separately; and detectors are disposed at the winding mechanisms to measure the offset between the layers. This approach is prone to the problem that OH (overhang) detection is missed.

### SUMMARY OF THE INVENTION

Embodiments of the present application provide a winding device, a battery processing device and a battery production line. The winding device is capable of increasing the product percent of pass and alleviating the problem that OH detection is missed.

In a first aspect, embodiments of the present application provide a winding device for producing an electrode assembly including a first electrode plate, a second electrode plate, a first separator and a second separator, where the winding device includes a first combining mechanism configured to combine incoming materials including at least the first electrode plate, the first separator and the second electrode plate into a first composite plate; a winding mechanism located downstream of the first combining mechanism and configured to wind the incoming material including at least the first composite plate into the electrode assembly; and a first detection apparatus including a first image acquisition apparatus and a processor; where the first image acquisition apparatus is located between the first combining mechanism and the winding mechanism and configured to obtain edge position images of at least one of the first electrode plate and the second electrode plate in the first composite plate; and the processor is configured to determine an edge distance based on the edge position images and judge whether the edge distance meets a threshold.

In the above technical solution, the first composite plate is obtained by combining the first electrode plate, the second electrode plate, and at least one separator in advance through the first combining mechanism before entering the winding mechanism; the first composite plate is detected by the first detection apparatus before entering the winding mechanism so as to obtain the quality of the first composite plate; and the qualified first composite plate is then conveyed to the winding mechanism. Since the relative positions between the positive electrode plate and the negative electrode plate, as well as between the electrode plates and separators, remain stable after combination, displacement or misalignment is minimized. Accordingly, after the qualified first composite plate is wound by the winding mechanism, the OH value associated with the electrode plates remains within acceptable limits, thereby alleviating the problem of outflow of defective wound products. Moreover, since the first composite plate is detected before entering the winding mechanism, the first image acquisition apparatus is not obstructed by the winding mechanism, the head of the first composite plate is not blocked by the winding mechanism, eliminating detection blind spots. This enables comprehensive detection of the first composite plate, which is conducive to alleviating the problem that OH detection is missed.

In some embodiments, the first image acquisition apparatus is configured to obtain edge position images of the first electrode plate and the first separator in the first composite plate, and the edge distance includes an edge distance between the first electrode plate and the first separator.

In the above technical solution, it is possible to determine whether the edge distance by which the first separator extends beyond the first electrode plate meets the corresponding threshold requirement on one or both sides of the first composite plate in a width direction. And/or, it is possible to determine whether the edge distance by which the first separator extends beyond the first electrode plate meets the corresponding threshold requirement at the head and/or tail of the first composite plate in a length direction.

In some embodiments, the first image acquisition apparatus is configured to obtain edge position images of the second electrode plate and the first separator in the first composite plate, and the edge distance includes an edge distance between the second electrode plate and the first separator.

In the above technical solution, it is possible to determine whether the edge distance by which the first separator extends beyond the second electrode plate meets the corresponding threshold requirement on one or both sides of the second composite plate in the width direction. And/or, it is possible to determine whether the edge distance by which the first separator extends beyond the second electrode plate meets the corresponding threshold requirement at the head and/or tail of the first composite plate in the length direction.

In some embodiments, the first image acquisition apparatus is configured to obtain edge position images of the first electrode and plate the second electrode plate in the first composite plate; or the first image acquisition apparatus is configured to obtain edge position images of the first electrode, the second electrode plate and the first separator in the first composite plate; and the edge distance includes an edge distance between the first electrode plate and the second electrode plate.

In the above technical solution, it is possible to determine whether the edge distance between the first electrode plate and the second electrode plate meets the corresponding threshold requirement on one or both sides of the first composite plate in the width direction. And/or, it is possible to determine whether the edge distance between the first electrode plate and the second electrode plate meets the corresponding threshold requirement at the head and/or tail of the first composite plate in the length direction.

In some embodiments, the first image acquisition apparatus is configured to obtain widthwise-side edge position images of the first composite plate in a width direction, and the processor is configured to determine a widthwise edge distance based on the widthwise-side edge position images, and judge whether the widthwise edge distance meets a corresponding threshold.

In the above technical solution, it is possible to determine the OH condition of the first composite plate in the width direction. For example, when the detection object are the first electrode plate and the first separator, it is possible to determine whether the edge distance by which the first separator extends beyond the first electrode plate meets the corresponding threshold requirement on one or both sides of the first composite plate in the width direction. For example, when the detection object are the second electrode plate and the first separator, it is possible to determine whether the edge distance by which the first separator extends beyond the second electrode plate meets the corresponding threshold requirement on one or both sides of the first composite plate in the width direction. For example, when the detection object are the second electrode plate and the first electrode plate, it is possible to determine whether the edge distance between the first electrode plate and the second electrode plate meets the corresponding threshold requirement on one or both sides of the first composite plate in the width direction.

In some embodiments, the first image acquisition apparatus includes a first acquisition unit, the first acquisition unit includes two groups of CCD cameras, the two groups of CCD cameras are arranged, in a thickness direction of the first composite plate, on two sides of the first composite plate respectively, and the two groups of CCD cameras are respectively configured to obtain the widthwise-side edge position images of the first composite plate in the width direction.

In the above technical solution, image acquisition can be performed from both sides of the first composite plate in the thickness direction, so that relatively accurate and clear image information can be obtained regardless of whether image information of the first electrode plate or the second electrode plate needs to be acquired.

In some embodiments, each group of CCD cameras in the first acquisition unit includes two CCD cameras, the two CCD cameras in the same group are spaced apart in the width direction of the first composite plate, and the two CCD cameras in the same group are respectively configured to obtain the widthwise-side edge position images of edge positions of two sides of the first composite plate in the width direction.

In the above technical solution, a single first acquisition unit can simultaneously acquire image information of both sides of the first composite plate in the width direction, enabling OH determination on one or both widthwise sides.

In some embodiments, the first image acquisition apparatus includes a second acquisition unit, the second acquisition unit includes an X-ray camera, and the X-ray camera is configured to obtain the widthwise-side edge position images of the first composite plate in the width direction.

In the above technical solution, the second acquisition unit only needs to be arranged on one side of the first composite plate in the thickness direction, and does not need to be arranged on both sides of the first composite plate in the thickness direction, thereby saving space and simplifying configuration.

In some embodiments, the first image acquisition apparatus is configured to obtain lengthwise-end edge position images of the first electrode plate and the second electrode plate in the length direction of the first composite plate, and the processor is configured to determine an edge distance between the heads and/or tails of the first electrode plate and the second electrode plate based on the lengthwise-end edge position images of the first electrode plate and the second electrode plate, and judge whether the edge distance meets a corresponding threshold.

In the above technical solution, it is possible to determine the OH condition of the first composite plate in the length direction. And/or, it is possible to determine whether the edge distance between the first electrode plate and the second electrode plate meets the corresponding threshold requirement at the head and/or tail of the first composite plate in the length direction, thereby alleviating the problem that OH detection is missed.

In some embodiments, the first image acquisition apparatus includes a third acquisition unit, the third acquisition unit includes two groups of CCD cameras, the two groups of CCD cameras are arranged, in the thickness direction of the first composite plate, on two sides of the first composite plate, and the two groups of CCD cameras are respectively configured to obtain edge position images of the heads or tails of the first electrode plate and the second electrode plate in the length direction of the first composite plate.

In the above technical solution, image acquisition can be performed from both sides of the first composite plate in the thickness direction, so that the acquired image information of the first electrode plate and the second electrode plate are relatively accurate and clear, which is conducive to more accurately determining the OH problem at the heads and/or tails of the first electrode plate and the second electrode plate in the length direction.

In some embodiments, the first image acquisition apparatus includes a fourth acquisition unit, the fourth acquisition unit includes an X-ray camera, and the X-ray camera is configured to obtain edge position images of the heads or tails of the first electrode plate and the second electrode plate in the length direction of the first composite plate.

In the above technical solution, the fourth acquisition unit only needs to be arranged on one side of the first composite plate in the thickness direction, and does not need to be arranged on both sides of the first composite plate in the thickness direction, thereby saving space and simplifying configuration.

In some embodiments, the winding device further includes a rejection mechanism located between the first image acquisition apparatus and the winding mechanism, where the rejection mechanism is configured to reject a first composite plate that fails to meet the threshold based on a signal, indicating that the edge distance does not meet the threshold, sent by the processor.

In the above technical solution, after the processor determines that the threshold is not met, it can reject the non-compliant first composite plate and prevent it from being wound onto the winding mechanism. This prevents defective products from outflow, controls the quality of wound products, and avoids generating winding scrap to avoid unnecessary waste.

In some embodiments, the fourth feeding mechanism is arranged upstream of the first combining mechanism, and the first combining mechanism is configured to combine the incoming materials including at least the first electrode plate, the first separator, the second electrode plate and the second separator into a first composite plate.

In the above technical solution, when the fourth feeding mechanism is arranged upstream of the first combining mechanism to ensure the second separator is also combined in the first composite plate, the first composite plate detected by the first image acquisition apparatus includes at least four stacked layers: the first electrode plate, the first separator, the second electrode plate, and the second separator, facilitating more comprehensive detection. Moreover, the first combining mechanism can combine at least the first electrode plate, the first separator, the second electrode plate, and the second separator into the first composite plate. Compared to the solution of combining these four layers at the position of a winding needle, this approach lowers functional demands on the winding needle and is conducive to increasing winding speed of the winding needle and improving the production efficiency. Furthermore, it enables the combination of the electrode plates and the separators prior to winding, thereby minimizing displacement of the electrode plates and separators in the winding process and improving the quality of the electrode assembly.

In some embodiments, the first combining mechanism is an edge sealing mechanism, and is configured to seal and connect at least one of two side edges of the first separator and the second separator in the width direction.

In the above technical solution, since the edge sealing mechanism can connect edges of the first separator and the second separator together to achieve edge sealing, the first and second separators will not separate upon removal of the external force, preventing exposure of the second electrode plate; gaps are less prone to folding during winding of the electrode assembly, and the electrolyte filling process is less susceptible to hole disturbance, thereby effectively lowering the risk of the second electrode plate overlapping with the first electrode plate or with a housing of a battery cell and alleviating the problem of lithium plating.

In some embodiments, the winding device further includes a second combining mechanism located upstream of the first combining mechanism and downstream of a first feeding mechanism and a third feeding mechanism and configured to combine the first electrode plate and the first separator into a second composite plate.

In the above technical solution, by means of the second combining mechanism arranged upstream of the first combining mechanism, the first electrode plate and the first separator can be combined preferentially. The number of material layers combined here is small, and accordingly the combination quality can be better controlled, the relative positions of the first electrode plate and the first separator, as well as the respective states of the first electrode plate and the first separator can be better guaranteed, thereby improving the product quality.

In some embodiments, the second combining mechanism is a composite mechanism and configured to fixedly connect the first electrode plate and the first separator in the second composite plate.

In the above technical solution, since the second combining mechanism is set as the composite mechanism, the offset of the first electrode plate relative to the first separator during winding and use can be reduced, which is conducive to improving the accuracy of the relative positions between the materials, thereby improving the product quality.

In some embodiments, the winding device further includes a second image acquisition apparatus located between the second combining mechanism and the first combining mechanism and configured to detect the second composite plate.

In the above technical solution, since the second image acquisition apparatus is arranged between the second combining mechanism and the first combining mechanism, the second image acquisition apparatus can detect the second composite plate that is combined by the second combining mechanism and has not enter the first combining mechanism, so as to discover defects and abnormalities of the second composite plate in time to facilitate prompt response to issues arising in the second composite plate, thereby reducing the negative impact on subsequent processes and improving the product quality.

In some embodiments, the winding device further includes a first temporary storage mechanism disposed between the second combining mechanism and the first combining mechanism and configured to store the second composite plate temporarily.

In the above technical solution, the first temporary storage mechanism is arranged between the second combining mechanism and the first combining mechanism. The first temporary storage mechanism can store part of the second composite plate temporarily after the first electrode plate and the first separator are combined. The first temporary storage mechanism can store part of the second composite plate temporarily when the winding needle switches or other tension is reduced, and release the temporarily stored second composite plate when the tension is normal, so as to reduce the negative impact from switching of the winding needle, cutting of the electrode plates or other situations on the feeding of the first feeding mechanism and the third feeding mechanism, and reduce the occurrence of slowdown or shutdown of the first feeding mechanism and the third feeding mechanism, enabling continuous feeding of the first feeding mechanism and the third feeding mechanism and improving production efficiency.

In some embodiments, the winding device includes a first cutting mechanism configured to cut the first electrode plate and disposed between the first feeding mechanism and the second combining mechanism.

In the above technical solution, during production, the first temporary storage mechanism stores the material temporarily and can continuously transfer the material downstream, so that the winding needle can work without slowdown and will not be affected by the operation of the first cutting mechanism upstream of the first temporary storage mechanism. Through temporary storage of the first temporary storage mechanism, the first temporary storage mechanism can still convey the second composite plate to the first combining mechanism in the process of the first cutting mechanism cutting the first electrode plate, without reducing the speed of the winding needle, thereby improving the winding efficiency and improving the overall production capacity. Moreover, the first cutting mechanism may be arranged spatially away from the winding mechanism to overcome the adverse effect on the quality of the electrode assembly caused by chips formed by cutting falling into the electrode assembly wound on the winding needle, thereby facilitating further improvement of the quality of the electrode assembly.

In some embodiments, the second electrode plate and the second separator are separately fed into the first combining mechanism, and the winding device includes a second cutting mechanism configured to cut the second electrode plate and disposed between the second feeding mechanism and the first combining mechanism.

In the above technical solution, the second cutting mechanism may be arranged spatially away from the winding mechanism to overcome the adverse effect on the quality of the electrode assembly caused by chips formed by cutting falling into the electrode assembly wound on the winding needle, thereby facilitating further improvement of the quality of the electrode assembly.

In some embodiments, the second cutting mechanism includes a cam cutter.

In the above technical solution, the second cutting mechanism does not need to track the second electrode plate, and the second electrode plate does not need to slow down in response to the cutting, so the second cutting mechanism can cut the second electrode plate without slowdown, which can improve production capacity. Besides, because the space requirement for tracking is eliminated, it is conducive to reducing space occupation.

In some embodiments, the winding device further includes a third combining mechanism located upstream of the first combining mechanism and downstream of a second feeding mechanism and a fourth feeding mechanism and configured to combine the second electrode plate and the second separator into a third composite plate.

In the above technical solution, by means of the third combining mechanism arranged upstream of the first combining mechanism, the second electrode plate and the second separator can be combined preferentially. The number of material layers combined here is small, and accordingly the combination quality can be better controlled, the relative positions of the second electrode plate and the second separator, as well as the respective states of the second electrode plate and the second separator can be better guaranteed, thereby improving the product quality.

In some embodiments, the third combining mechanism is a composite mechanism and configured to fixedly connect the second electrode plate and the second separator in the third composite plate.

In the above technical solution, the offset of the second electrode plate relative to the second separator during winding and use can be reduced, which is conducive to improving the accuracy of the relative positions between the materials, thereby improving the product quality.

In some embodiments, the winding device further includes a third image acquisition apparatus located between the third combining mechanism and the first combining mechanism and configured to detect the third composite plate.

In the above technical solution, since the third image acquisition apparatus is arranged between the third combining mechanism and the first combining mechanism, the third image acquisition apparatus can detect the third composite plate that is combined by the third combining mechanism and has not enter the first combining mechanism, so as to discover defects and abnormalities of the third composite plate in time to facilitate prompt response to issues arising in the third composite plate, thereby reducing the negative impact on subsequent processes and improving the product quality.

In some embodiments, the winding device further includes a second temporary storage mechanism disposed between the third combining mechanism and the first combining mechanism and configured to store the third composite plate temporarily.

In the above technical solution, the second temporary storage mechanism can store the third composite plate temporarily. When there is a speed difference before and after the second temporary storage mechanism, the second temporary storage mechanism can temporarily store and duly release part of the third composite plate in time, thereby solving the problem of speed reduction or the problem of wrinkles caused by insufficient tension, and improving the production capacity and product quality. Furthermore, the second temporary storage mechanism can store part of the second composite plate temporarily after the second electrode plate and the second separator are combined. The second temporary storage mechanism can store part of the third composite plate temporarily when the winding needle switches or other tension is reduced, and release the temporarily stored third composite plate when the tension is normal, so as to reduce the negative impact from switching of the winding needle, cutting of the electrode plates or other situations on the feeding of the second feeding mechanism and the fourth feeding mechanism, and reduce the occurrence of slowdown or shutdown of the second feeding mechanism and the fourth feeding mechanism, enabling continuous feeding of the second feeding mechanism and the fourth feeding mechanism and improving production efficiency.

In some embodiments, the winding device includes a second cutting mechanism configured to cut the second electrode plate and disposed between the second feeding mechanism and the third combining mechanism.

In the above technical solution, during production, the second temporary storage mechanism stores the material temporarily and can continuously transfer the material downstream, so that the winding needle can work without slowdown and will not be affected by the operation of the second cutting mechanism upstream of the second temporary storage mechanism. Through temporary storage of the second temporary storage mechanism, the second temporary storage mechanism can still convey the third composite plate to the third combining mechanism in the process of the second cutting mechanism cutting the second electrode plate, without reducing the speed of the winding needle, thereby improving the winding efficiency and improving the overall production capacity. Moreover, the second cutting mechanism may be arranged spatially away from the winding mechanism to overcome the adverse effect on the quality of the electrode assembly caused by chips formed by cutting falling into the electrode assembly wound on the winding needle, thereby facilitating further improvement of the quality of the electrode assembly.

In some embodiments, the winding device further includes a fifth combining mechanism located upstream of the first combining mechanism and downstream of the third feeding mechanism, the second feeding mechanism, and the fourth feeding mechanism and configured to combine the first separator, the second electrode plate, and the second separator into a fifth composite plate.

In the above technical solution, by means of the fifth combining mechanism and the first combining mechanism, the second separator, the second electrode plate, the first separator and the first electrode plate are formed into the first composite plate through two steps in succession. In this way, the operation of forming the first composite plate from the second separator, the second electrode plate, the first separator and the first electrode plate can be more strictly controlled, which helps to improve the quality of the first composite plate and further helps to improve the quality of the electrode assembly. According to the above technical solution, the fifth composite plate including the second electrode plate can be formed by the fifth combining mechanism first, and then the first composite plate including the first electrode plate can be formed by the first combining mechanism. The second electrode plate and the first electrode plate are combined successively. In this way, the combination quality of the second electrode plate and the first electrode plate can be controlled separately, which can help to improve the quality of the first composite plate and thus improve the quality of the electrode assembly.

In some embodiments, the fifth combining mechanism is an edge sealing mechanism, and is configured to seal and connect at least one of two side edges of the first separator and the second separator in the width direction.

In the above technical solution, since the edge sealing mechanism can connect edges of the first separator and the second separator together to achieve edge sealing, the first and second separators will not separate upon removal of the external force, preventing exposure of the second electrode plate; gaps are less prone to folding during winding of the electrode assembly, and the electrolyte filling process is less susceptible to hole disturbance, thereby effectively lowering the risk of the second electrode plate overlapping with the first electrode plate or with a housing of a battery cell and alleviating the problem of lithium plating. For example, the edge sealing mechanism may include two edge sealing rollers arranged opposite to each other. The two edge sealing rollers can heat edges of both sides of the first separator and the second separator and apply a predetermined pressure in the thickness direction to achieve an edge-sealing connection of the first separator and the second separator.

In some embodiments, the fifth combining mechanism is a composite mechanism, and is configured to fixedly connect the second electrode plate, the first separator and the second separator in the fifth composite plate, respectively.

In the above technical solution, the offset of the first electrode plate relative to the first separator and the second separator during winding and use can be reduced, which is conducive to improving the accuracy of the relative positions between the materials, thereby improving the product quality.

In some embodiments, the first combining mechanism is a composite mechanism and is configured to fixedly connect the fifth composite plate and the first electrode plate.

In the above technical solution, when the first combining mechanism is a composite mechanism and is configured to fixedly connect the fifth composite plate and the first electrode plate, the offset of the first electrode plate relative to the fifth composite plate during winding and use can be reduced, which is conducive to improving the accuracy of the relative positions between the materials, thereby improving the product quality.

In some embodiments, the winding device further includes a fifth image acquisition apparatus located between the fifth combining mechanism and the first combining mechanism and configured to detect the fifth composite plate.

In the above technical solution, the fifth image acquisition apparatus can detect the fifth composite plate to obtain the combination state of the first separator, the second electrode plate, and the second separator, so as to strictly control the quality of the fifth composite plate, which can help to improve the quality of the electrode assembly.

In some embodiments, the winding device further includes a fourth temporary storage mechanism disposed between the fifth combining mechanism and the first combining mechanism and configured to store the fifth composite plate temporarily.

In the above technical solution, the fourth temporary storage mechanism can store the fifth composite plate temporarily. When there is a speed difference before and after the fourth temporary storage mechanism, the fourth temporary storage mechanism can temporarily store and duly release part of the fifth composite plate in time, thereby solving the problem of speed reduction or the problem of wrinkles caused by insufficient tension, and improving the production capacity and product quality.

In some embodiments, the winding device includes a second cutting mechanism configured to cut the second electrode plate and disposed between the second feeding mechanism and the fifth combining mechanism.

In the above technical solution, when the second cutting mechanism needs to slow down to cut off the second electrode plate, the fourth temporary storage mechanism can release the temporarily stored fifth composite plate to supply it to the first combining mechanism, so that the first combining mechanism can continuously and uninterruptedly combine the fifth composite plate and the first electrode plate to form the first composite plate without stopping, and the winding mechanism can continuously and uninterruptedly wind the first composite plate without stopping. In this way, the winding efficiency of the winding device can be improved, thereby improving the production efficiency of the electrode assembly. Moreover, the second cutting mechanism may be arranged spatially away from the winding mechanism to overcome the adverse effect on the quality of the electrode assembly caused by chips formed by cutting falling into the electrode assembly wound on the winding needle, thereby facilitating further improvement of the quality of the electrode assembly.

In some embodiments, the winding device further includes a fifth temporary storage mechanism disposed between the first combining mechanism and the winding mechanism and configured to store the first composite plate temporarily.

In the above technical solution, the fifth temporary storage mechanism can store the first composite plate between the first combining mechanism and the winding mechanism temporarily. When there is a speed difference before and after the fifth temporary storage mechanism, the fifth temporary storage mechanism can temporarily store and duly release part of the first composite plate in time, thereby solving the problem of speed reduction or the problem of wrinkles caused by insufficient tension, and improving the production capacity and product quality.

In some embodiments, the winding device includes a first cutting mechanism configured to cut the first electrode plate and disposed between the first feeding mechanism and the first combining mechanism.

In the above technical solution, when the first cutting mechanism needs to slow down to cut off the first electrode plate, the fifth temporary storage mechanism can release the temporarily stored first composite plate to the winding mechanism, so that the winding mechanism can continuously and uninterruptedly wind the first composite plate without stopping. In this way, the winding efficiency of the winding device can be improved, thereby improving the production efficiency of the electrode assembly. Moreover, the first cutting mechanism may be arranged spatially away from the winding mechanism to overcome the adverse effect on the quality of the electrode assembly caused by chips formed by cutting falling into the electrode assembly wound on the winding needle, thereby facilitating further improvement of the quality of the electrode assembly.

In some embodiments, the winding device further includes a third cutting mechanism configured to cut the first separator and the second separator and disposed between the first combining mechanism and the winding mechanism.

In the above technical solution, the length of the separator can be made longer than the length of the electrode plate easily, thereby meeting the design requirements of the electrode assembly; and only one third cutting mechanism needs to be disposed, which can simplify the device, reduce costs and save space.

In some embodiments, the second separator and the first composite plate are combined at a position downstream of the first image acquisition apparatus.

In the above technical solution, the first image acquisition apparatus arranged upstream of the winding mechanism can more comprehensively detect the first composite plate consisting of three stacked layers including the first electrode plate, the first separator and the second electrode plate, reducing the detection blind spots and improving the detection precision. In addition, both sides of the first composite plate are electrode plates. In the process of conveying the first composite plate, friction forces on both sides of the first composite plate along its thickness direction are consistent. When the first composite plate passes through transfer rollers, it is not easy for the electrode plate to detach from the rollers.

In some embodiments, the first combining mechanism is a composite mechanism and is configured to fixedly connect both the first electrode plate and the second electrode to the first separator in the first composite plate.

In the above technical solution, the offset of the first electrode plate relative to the first separator, the offset of the second electrode plate relative to the first separator, and the offset of the first electrode plate relative to the second electrode plate can be reduced during winding and use, which is conducive to improving the accuracy of the relative positions between the materials, thereby improving the product quality.

In some embodiments, the winding device further includes a sixth combining mechanism located between the first combining mechanism and the winding mechanism, where the fourth feeding mechanism is located upstream of the sixth combining mechanism and the sixth combining mechanism and is configured to combine the first composite plate and the second separator into a sixth composite plate.

In the above technical solution, the sixth combining mechanism is arranged downstream of the first combining mechanism, the second separator provided by the sixth combining mechanism can be first combined with the first composite plate and then fed into the winding mechanism together, so that the relative positions of the second separator and the sixth composite plate are more reliable and not easy to misalign, which is conducive to improving the reliability of the second separator insulating the first electrode plate from the second electrode plate in the electrode assembly after winding. Furthermore, by spacing the sixth combining mechanism from the winding mechanism, the problem of crowded space around the winding mechanism can be avoided. In addition, in the winding device, unwinding mechanisms are separated from the winding mechanisms, making the layout flexible and convenient.

In some embodiments, the sixth combining mechanism is an edge sealing mechanism, and is configured to seal and connect edges of two sides of the first separator and the second separator in the width direction.

In the above technical solution, the first and second separators will not separate, thereby preventing exposure of the second electrode plate; the separators are less prone to folding during winding of the electrode assembly; and the electrolyte filling process is less susceptible to hole disturbance, thereby effectively lowering the risk of the second electrode plate overlapping with the first electrode plate or with a housing of a battery cell and alleviating the problem of lithium plating.

In some embodiments, the winding device further includes a sixth image acquisition apparatus located between the sixth combining mechanism and the winding mechanism and configured to detect the sixth composite plate.

In the above technical solution, the sixth image acquisition apparatus is arranged between the sixth combining mechanism and the winding mechanism, and can comprehensively detect the state of the sixth composite plate, with high-accuracy detection result. When the sixth combining mechanism is an edge sealing mechanism, the sixth image acquisition apparatus may be configured to detect the edge sealing state of the sixth composite plate, thereby improving the reliability of the edge sealing and enabling the separator to reliably limit and protect the second electrode plate.

In some embodiments, the winding device further includes a third cutting mechanism configured to cut the first separator and the second separator and disposed between the sixth combining mechanism and the winding mechanism.

In the above technical solution, the length of the separator can be made longer than the length of the electrode plate easily, thereby meeting the design requirements of the electrode assembly; and only one third cutting mechanism needs to be disposed, which can simplify the device, reduce costs and save space.

In some embodiments, the winding device further includes a sixth temporary storage mechanism disposed between the first combining mechanism and the winding mechanism and configured to store the first composite plate temporarily.

In the above technical solution, the sixth temporary storage mechanism can store the first composite plate between the first combining mechanism and the winding mechanism temporarily. When there is a speed difference before and after the sixth temporary storage mechanism, the sixth temporary storage mechanism can temporarily store and duly release part of the first composite plate in time, thereby solving the problem of speed reduction or the problem of wrinkles caused by insufficient tension, and improving the production capacity and product quality.

In some embodiments, the winding device includes s a first cutting mechanism for cutting the first electrode plate and a second cutting mechanism for cutting the second electrode plate; the first cutting mechanism is disposed between the first feeding mechanism and the first combining mechanism, and the second cutting mechanism is disposed between the second feeding mechanism and the first combining mechanism.

In the above technical solution, when the first electrode plate and the second electrode plate are cut in advance before they enter the first combining mechanism, the sixth temporary storage mechanism can temporarily store and release the first composite plate, ensuring that the winding mechanism can wind the electrode plates without interruption during cutting, and significantly improving winding efficiency. Moreover, both the first cutting mechanism and the second cutting mechanism may be arranged spatially away from the winding mechanism to solve the adverse effect on the quality of the electrode assembly caused by chips formed by cutting falling into the electrode assembly wound on the winding needle, thereby facilitating further improvement of the quality of the electrode assembly.

In some embodiments, the first electrode plate, the first separator, and the second electrode plate are fed into the first combining mechanism separately.

In the above technical solution, the mechanism may be simplified, the need to provide another combining mechanism upstream of the first combining mechanism is omitted, thereby saving space.

In some embodiments, the fourth feeding mechanism and the first composite plate are combined at the winding mechanism.

In the above technical solution, the mechanism may be simplified, the need to provide another combining mechanism downstream of the first combining mechanism is omitted, thereby saving space.

In a second aspect, embodiments of the present application provide a battery processing device, including a winding device.

According to the battery processing device provided in the embodiment of the present application, by using the winding device described in the above embodiments, the layout rationality of the winding device can be improved to improve the layout rationality of the battery processing device, which facilitates the layout of functional apparatuses such as the first temporary storage apparatus, the second temporary storage apparatus, the first image acquisition apparatus, and the second image acquisition apparatus, thereby helping to improve the quality of the electrode assembly to improve the quality of the battery.

In a third aspect, embodiments of the present application provide a battery production line, including a winding device or a battery processing device.

According to the battery production line provided in the embodiment of the present application, by using the winding device or battery processing device described in the above embodiments, the layout rationality of the winding device can be improved to improve the layout rationality of the battery processing device, which facilitates the layout of functional apparatuses such as the first temporary storage apparatus, the second temporary storage apparatus, the first image acquisition apparatus, and the second image acquisition apparatus, thereby helping to improve the quality of the electrode assembly to improve the quality of the battery.

The above description is only an overview of the technical solution of the present application. In order to more clearly understand the technical means of the present application to implement same according to the contents of the Specification, and in order to enable the above and other objectives, features, and advantages of the present application to be more obvious and understandable, Detailed Description of the present application is hereby exemplarily described below.

### DESCRIPTION OF DRAWINGS

To more clearly describe the technical solutions of the embodiments of the present application, the drawings to be used in the embodiments will be briefly introduced below, and it should be understood that the following drawings only show some embodiments of the present application, and therefore should not be considered as limiting the scope of the present application. For those of ordinary skills in the art, other relevant drawings may also be obtained based on these drawings without creative efforts.

FIG. 1 is a schematic diagram of a battery according to some embodiments of the present application;

FIG. 2 is a schematic diagram of a battery cell according to some embodiments of the present application;

FIG. 3 is a schematic diagram of an electrode assembly according to some embodiments of the present application;

FIG. 4 is a schematic diagram of a winding device according to some embodiments of the present application;

FIG. 5 is a schematic diagram of a winding device according to some embodiments of the present application;

FIG. 6 is a schematic diagram of detection of a first detection mechanism according to some embodiments of the present application;

FIG. 7 is a schematic diagram of detection of a first detection mechanism according to some embodiments of the present application;

FIG. 8 is a schematic diagram of detection of a second detection mechanism according to some embodiments of the present application;

FIG. 9 is a schematic diagram of detection of a second detection mechanism according to some embodiments of the present application;

FIG. 10 is a schematic diagram of a winding device according to some embodiments of the present application;

FIG. 11 is a schematic diagram of a winding device according to some embodiments of the present application;

FIG. 12 is a schematic diagram of a winding device according to some embodiments of the present application;

FIG. 13 is a partial enlarged view of FIG. 12;

FIG. 14 is a schematic diagram of a winding device according to some embodiments of the present application;

FIG. 15 is a schematic diagram of a winding device according to some embodiments of the present application;

FIG. 16 is a schematic diagram of a winding device according to some embodiments of the present application;

FIG. 17 is a schematic diagram of a winding device according to some embodiments of the present application;

FIG. 18 is a schematic diagram of a winding device according to some embodiments of the present application;

FIG. 19 is a schematic diagram of a winding device according to some embodiments of the present application;

FIG. 20 is a schematic diagram of a winding device according to some embodiments of the present application;

FIG. 21 is a schematic diagram of a winding device according to some embodiments of the present application;

FIG. 22 is a schematic diagram of a winding mechanism according to some embodiments of the present application;

FIG. 23 is a detection schematic diagram of a seventh image acquisition apparatus according to some embodiments of the present application;

FIG. 24 is a detection schematic diagram of a tenth image acquisition apparatus according to some embodiments of the present application;

FIG. 25 is a schematic diagram of a first composite plate according to some embodiments of the present application;

FIG. 26 is a detection schematic diagram of a sixth image acquisition apparatus according to some embodiments of the present application;

FIG. 27 is a detection schematic diagram of an eighth image acquisition apparatus according to some embodiments of the present application;

FIG. 28 is a detection schematic diagram of an eighth image acquisition apparatus according to some embodiments of the present application;

FIG. 29 is a schematic diagram of a battery production line according to some embodiments of the present application;

FIG. 30 is a detection schematic diagram of a first detection apparatus according to some embodiments of the present application;

FIG. 31 is a schematic diagram of a second acquisition unit according to some embodiments of the present application;

FIG. 32 is a schematic diagram of a third acquisition unit according to some embodiments of the present application;

FIG. 33 is a schematic diagram of a fourth acquisition unit according to some embodiments of the present application; and

FIG. 34 is a schematic diagram of a rejection mechanism and other components according to some embodiments of the present application;

### REFERENCE SIGNS

Battery production line 1000; Battery processing device 1001;
Winding device 100; Assembling device 400; Stacking device 500;
First device 101; Second device 102;
First feeding mechanism 11; Second feeding mechanism 12; First conveying belt 14; Second conveying belt 15;
Third feeding mechanism 21; Fourth feeding mechanism 22;
First combining mechanism 31; First composite roller 311 of the first mechanism; Second composite roller 312 of the first mechanism; First composite gap 313;
Second combining mechanism 32; Third combining mechanism 33; Fourth combining mechanism 34;
Fifth combining mechanism 35; First composite roller 351 of the fifth mechanism; Second composite roller 352 of the fifth mechanism; Fifth composite gap 353;
Sixth combining mechanism 36;
Winding mechanism 40; Turret 41; Workstation 401; Winding station 4101; Finishing station 4102;
Gluing station 4103; Blanking station 4104; Retraction station 4105; Winding needle 42;
Finishing assembly 43; Finishing roller 431; Gluing roller 432;
Blanking mechanism 50; Clamping jaw 51; Platform 52;
First cutting mechanism 61; First cutter 611; First abutting member 612;
Second cutting mechanism 62; First cam cutter 621; Second abutting member 622;
Third cutting mechanism 63; Second cam cutter 631; Third abutting member 632;
First rectification apparatus 66; Second rectification apparatus 67; Third rectification apparatus 68;
First detection apparatus 70; First image acquisition apparatus 71; Processor 702;
First acquisition unit 711; Second acquisition unit 712;
Third acquisition unit 713; Fourth acquisition unit 714;
Second image acquisition apparatus 72; Third image acquisition apparatus 73;
Fifth image acquisition apparatus 75; Sixth image acquisition apparatus 76; First detector 761; Second detector 762;
Seventh image acquisition apparatus 77; Eighth image acquisition apparatus 78;
Ninth image acquisition apparatus 791; Tenth image acquisition apparatus 792;
First temporary storage mechanism 81; First fixed roller 811; First floating roller 812;
Second temporary storage mechanism 82;
Fourth temporary storage mechanism 84; Fourth fixed roller 841; Fourth floating roller 842;
Fifth temporary storage mechanism 85; Fifth fixed roller 851; Fifth floating roller 852;
Sixth temporary storage mechanism 86; Sixth fixed roller 861; Sixth floating roller 862;
First conveying member 91; Second conveying member 92; Third conveying member 93;
Fourth conveying member 94; Fifth conveying member 95; Sixth conveying member 96;
First insert feeding mechanism 97; Second insert feeding mechanism 98; Rejection mechanism 99;
Electrode assembly 200;
First electrode plate a; Second electrode plate b; First separator c; Second separator d;
First composite plate e; Second composite plate f; Third composite plate g;
Fourth composite plate h; Fifth composite plate j; Sixth composite plate k;
Seventh composite plate m;
Battery 300; Battery cell 301; Housing 3011.

### DETAILED DESCRIPTION

In order to make the objects, technical solutions and advantages of embodiments of the present application clearer, the technical solutions in the embodiments of the present application will be clearly described below with reference to the drawings for the embodiments of the present application. Apparently, the described embodiments are some of, rather than all of, the embodiments of the present application. All other embodiments obtained by those of ordinary skill in the art based on the embodiments in the present application without any creative effort shall fall within the scope of protection of the present application.

Unless otherwise defined, all technical and scientific terms used in the present application have the same meanings as those commonly understood by those skilled in the art to which the present application belongs. The terms used in the specification of the present application are merely for the purpose of describing specific embodiments, but are not intended to limit the present application. The terms “include” and “have” and any variations thereof in the specification and the claims of the present application as well as the above description of the drawings are intended to cover non-exclusive inclusions. The terms “first,” “second,” and the like in the specification and the claims of the present application as well as the above drawings are used to distinguish different objects, rather than to describe a specific order or primary-secondary relationship.

Reference in the present application to an “embodiment” means that a particular feature, structure, or characteristic described in connection with the embodiment can be included in at least one embodiment of the present application. The appearance of this phrase in various places in the specification does not necessarily refer to the same embodiment, nor is it a separate or alternative embodiment that is mutually exclusive with other embodiments.

In the description of the present application, it should be noted that the terms “mounting,” “connecting,” “connection” and “attachment” should be understood in a broad sense, unless otherwise explicitly specified or defined, for example, it may be a fixed connection, a detachable connection or an integrated connection; and may be a direct connection or an indirect connection through an intermediate medium, or may be a communication between the interior of two elements. For those of ordinary skill in the art, the specific meanings of the above terms in the present application can be understood according to specific situations.

In the present application, the term “and/or” is merely an association that describes the associated object, indicating that there can be three kinds of relationships, for example, A and/or B may denote the following three situations: A exists alone, A and B exist at the same time, and B exists alone. In addition, the character “/” in the present application generally means that the associated objects before and after it are in an “or” relationship.

In the embodiments of the present application, the same reference numerals denote the same components, and for the sake of brevity, detailed descriptions of the same components are omitted in different embodiments. It should be understood that the thickness, length, width and other dimensions of the various components in the embodiments of the present application shown in the drawings, as well as the overall thickness, length, width and other dimensions of an integrated apparatus, are for illustrative purposes only, and should not constitute any limitation to the present application.

In the present application, the phrase “plurality of” refers to more than two (including two).

At present, from the perspective of the development of the market situation, batteries are more and more widely used. Batteries are not only used in energy storage power systems such as hydropower, thermal power, wind power and solar power stations, but also widely used in electric vehicles such as electric bicycles, electric motorcycles, and electric vehicles, as well as aerospace and other fields. With the continuous expansion of the application field of batteries, the market demand is also constantly expanding.

A battery cell includes an electrode assembly; and the electrode assembly includes a positive electrode plate, a negative electrode plate and a separator. In the related technologies, during the production of electrode assemblies using winding devices, negative electrode plates, positive electrode plates and separators are fed into winding mechanisms separately; and detectors are disposed at the winding mechanisms to measure the offset between the layers. However, this approach is prone to the problem that OH (overhang) detection is missed.

Based on this, the present application proposes a winding device, in which the positive electrode plate and the negative electrode plate are first combined with the separator and detected before entering the winding mechanism, and then are wound by means of the winding mechanism, thereby solving the problem that OH detection is missed.

According to embodiments of the present application, the winding device of is used for production of an electrode assembly. The electrode assembly can be used for a battery cell, and the battery cell can be used for a battery. The electrical device may include a battery cell or a battery in any of the following embodiments. Specifically, the electrical device may uses batteries or battery cells as power sources. The electrical device may be, but is not limited to, a mobile phone, a tablet, a laptop, an electric toy, an electric tool, a battery vehicle, an electric vehicle, a ship, a spacecraft, and the like. Here, electric toys may include fixed or mobile electric toys, e.g., game consoles, electric car toys, electric ship toys, and electric airplane toys, and spacecrafts may include airplanes, rockets, space shuttles, and spaceships, etc.

In the following embodiments, for convenience of description, the electrical device being a vehicle is taken as an example for illustration.

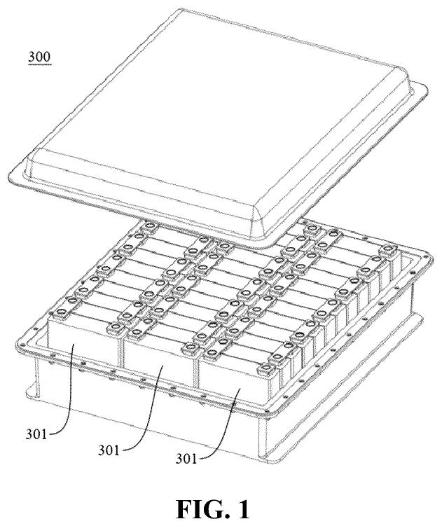

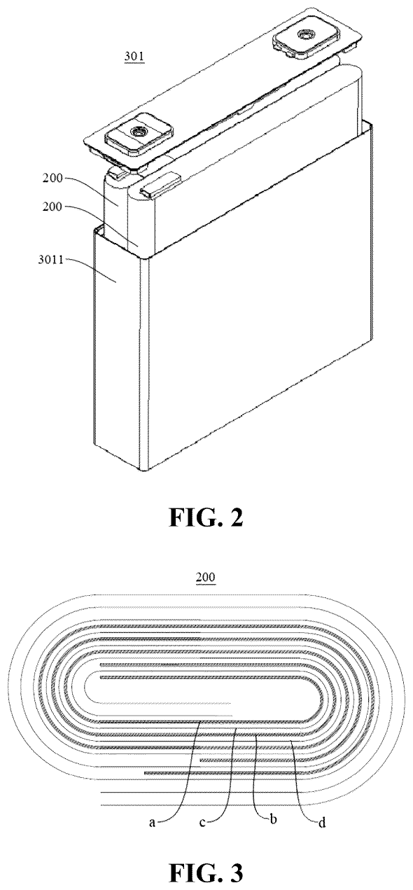

Referring to FIG. 1 and FIG. 2, the interior of the vehicle is provided with a battery 300, and the battery 300 may be arranged at the bottom or head or tail of the vehicle. The battery 300 may be used as a power supply for the vehicle, for example, the battery 300 may be used as an operating power source for the vehicle. The vehicle may further include a controller and a motor. The controller is configured to control the battery 300 to supply power to the motor, for example, to supply power for starting, navigation and driving of the vehicle.

In the embodiments of the present application, the battery 300 may not only be used as an operating power source for the vehicle, but also as a driving power source for the vehicle, to replace or partially replace fuel or natural gas to provide driving power for the vehicle.

In the embodiments of the present application, as shown in FIG. 1, the battery 300 is a single physical module that includes one or more battery cells 301 for providing a higher voltage and capacity. For example, the battery 300 mentioned in the present application may include a battery module, a battery pack, etc. Some batteries 300 may each include a box for enclosing one or more battery cells 301 or battery modules. The box may prevent liquids or other foreign matters from affecting charging or discharging of the battery cells 301. Of course, some batteries 300 may not include the above-mentioned box and may be directly arranged in a battery installation compartment of the electrical device.

In the present application, the battery cell 301 may include a lithium-ion secondary battery, a lithium-ion primary battery, a lithium-sulfur battery, a sodium/lithium-ion battery, a sodium-ion battery or a magnesium-ion battery, etc., which is not limited in the embodiments of the present application. The battery cell 301 may be cylindrical, flat, rectangular, or in other shapes, which is also not limited in the embodiments of the present application. Battery cells 301 are typically divided into three types by packaging methods: cylindrical cells, prismatic cells, and pouch cells, which are also not limited in the embodiments of the present application.

For example, as shown in FIG. 2, the battery cell 301 may include a housing 3011, an electrode assembly 200 and an electrolyte. The housing 3011 is used for accommodating the electrode assembly 200 and the electrolyte. One or more electrode assemblies 200 may be accommodated in the housing 3011 of the battery cell 301.

For example, as shown in FIG. 3, the electrode assembly 200 is the component within the battery cell 301 where electrochemical reactions occur. The electrode assembly 200 includes multiple layers of materials arranged in stacking, such as a first electrode plate a, a second electrode plate b, a first separator c, and a second separator d. The battery cell 301 works mainly relying on the movement of metal ions between the first electrode plate a and the second electrode plate b. One of the first electrode plate a and the second electrode plate b is a negative electrode plate, and the other one is a positive electrode plate.

The negative electrode plate includes a negative electrode current collector and a negative electrode active material layer. The negative electrode active material layer is coated on a surface of the negative electrode current collector. A current collector not coated with the negative electrode active material layer protrudes from the current collector coated with the negative electrode active material layer, and the current collector not coated with the negative electrode active material layer serves as a negative electrode tab. Taking a lithium-ion battery as an example, the material of the negative current collector may be aluminum, and the negative active material may be lithium cobalt oxide, lithium iron phosphate, ternary lithium, lithium manganate, or the like.

The positive electrode plate includes a positive electrode current collector and a positive electrode active material layer. The positive electrode active material layer is coated on a surface of the positive electrode current collector. A current collector not coated with the positive electrode active material layer protrudes from the current collector coated with the positive electrode active material layer, and the current collector not coated with the positive electrode active material layer serves as a positive electrode tab. The material of the positive electrode current collector may be copper, and the positive electrode active material may be carbon, silicon, or the like.

In order to ensure that no fusing occurs when a large current passes, there are a plurality of negative electrode tabs which are stacked together, and there are a plurality of positive electrode tabs which are stacked together. The separator (a first separator c, a separator d) may be made of a material such as polypropylene (PP) or polyethylene (PE).

With reference to the accompanying drawings, the following describes a winding device 100 for producing an electrode assembly 200 according to embodiments of the present application.

As shown in FIG. 3 and FIG. 4, the winding device 100 is used for production of an electrode assembly 200, and the electrode assembly 200 includes a first electrode plate a, a second electrode plate b, a first separator c and a second separator d. The winding device 100 includes a first combining mechanism 31 and a winding mechanism 40. The first combining mechanism 31 is configured to combine incoming materials including at least the first electrode plate a, the first separator c and the second electrode plate b into a first composite plate e. The winding mechanism 40 is located downstream of the first combining mechanism 31 and is configured to wind the incoming material including at least the first composite plate e to form the electrode assembly 200.

The second electrode plate b has a polarity different from the first electrode plate a. One of the first electrode plate a and the second electrode plate b is a positive electrode plate, and the other one is a negative electrode plate. That is, the first electrode plate a may be a positive electrode plate or a negative electrode plate; and the second electrode plate b may be a positive electrode plate or a negative electrode plate. For example, the first electrode plate a is a positive electrode plate, and the second electrode plate b is a negative electrode plate. For another example, the first electrode plate a is a negative electrode plate, and the second electrode plate b is a positive electrode plate.

The specific composition of the first composite plate e is not limited. Exemplarily, the first composite plate e may be a three-in-one composite plate, in which the first separator c is stacked between the first electrode plate a and the second electrode plate b. In this case, the winding mechanism 40 can wind the first composite plate e and the second separator d to form the electrode assembly 200. The length direction of the first composite plate e, the length direction of the first electrode plate a, the length direction of the second electrode plate b, and the length direction of the first separator c are consistent. The width direction of the first composite plate e, the width direction of the first electrode plate a, the width direction of the second electrode plate b, and the width direction of the first separator c are consistent. The thickness direction of the first composite plate e, the thickness direction of the first electrode plate a, the thickness direction of the second electrode plate b, and the thickness direction of the first separator c are consistent.

Alternatively, as an example, the first composite plate e may be a four-in-one composite plate, in which the first separator c is stacked between the first electrode plate a and the second electrode plate b while the second electrode plate b is stacked between the second separator d and the first separator c. In this case, the winding mechanism 40 can wind the first composite plate e to form the electrode assembly 200. The length direction of the first composite plate e, the length direction of the first electrode plate a, the length direction of the second electrode plate b, the length direction of the first separator c and the length direction of the second separator d are consistent. The width direction of the first composite plate e, the width direction of the first electrode plate a, the width direction of the second electrode plate b, the width direction of the first separator c and the width direction of the second separator d are consistent. The thickness direction of the first composite plate e, the thickness direction of the first electrode plate a, the thickness direction of the second electrode plate b, the thickness direction of the first separator c and the thickness direction of the second separator d are consistent.

Of course, the four-in-one composite plate may also be designed as the first electrode plate a being stacked between the second separator d and the first separator c. To simplify the description, the following mainly uses the second electrode plate b being stacked between the second separator d and the first separator c as an example.

In the embodiments of the present application, “combine” is understood in a broad sense, and a specific method can be selected according to the type of material to be combined. For example, it may include only stacking without connection between different layers, or it may include a composite connection between the electrode plates and the separators, or it may also include an edge sealing connection between the separators, etc.

For example, the word “combine” mentioned in the sentence “the first assembly unit 31 combines the incoming materials into the first composite plate e” is interpreted broadly. For example, it may involve merely stacking and combining the materials sequentially in the thickness direction, or it may involve not only stacking and combining the materials but also create an inseparable connection relation between the relevant layers. The connection relationship may include the aforementioned composite connection, edge-sealing connection, etc. The methods of composite connection and edge-sealing connection are not limited, and may be achieved, for example, by cold pressing, hot pressing, gluing, etc.

For example, in the above-mentioned three-in-one composite plate combined by the first combining mechanism 31, the first electrode plate a and the first separator c may be in contact but not connected to each other, or may be in contact and connected to each other, so that the first electrode plate a and the first separator c are in an inseparable state, either partially connected or integrally connected. Similarly, the second electrode plate b and the first separator c may be in contact but not connected to each other, or may be in contact and connected to each other, so that the second electrode plate b and the first separator c are in an inseparable state, either partially connected or integrally connected.

For example, in the above-mentioned four-in-one composite plate combined by the first combining mechanism 31, the first electrode plate a and the first separator c may be in contact but not connected to each other, or may be in contact and connected to each other, so that the first electrode plate a and the first separator c are in an inseparable state, either partially connected or integrally connected. Similarly, the second electrode plate b and the first separator c may be in contact but not connected to each other, or may be in contact and connected to each other, so that the second electrode plate b and the first separator c are in an inseparable state, either partially connected or integrally connected. The second separator c and an electrode plate adjacent thereto may be in contact but not connected to each other, or in contact and connected to each other, so that the second electrode plate b and the electrode plate adjacent thereto are in an separable state, either partially connected or integrally connected. The edge of the first separator c extending beyond the electrode plate and the edge of the second separator d extending beyond the electrode plate may be disconnected, continuously connected, or intermittently connected.

Exemplarily, the winding device 100 includes a first feeding mechanism 11, a second feeding mechanism 12, a third feeding mechanism 21, and a fourth feeding mechanism 22. The first feeding mechanism 11 is configured to release the first electrode a; the second feeding mechanism 12 is configured to release the second electrode plate b; the third feeding mechanism 21 is configured to release the first separator c; and the fourth feeding mechanism 22 is configured to release the second separator d.

The first feeding mechanism 11, the second feeding mechanism 12, the third feeding mechanism 21 and the fourth feeding mechanism 22 may all be unwinding mechanisms, which can carry wound materials and are configured to release the wound materials in a tape form. Exemplarily, the unwinding mechanisms may be, but are not limited to, rollers, reels, drums, rotating shafts, or the like. The specific design and features of the unwinding mechanisms may be set according to the width and thickness of the tape materials. The materials may be pre-wound and placed directly on the unwinding mechanisms, or may be wound in real time by the unwinding mechanisms.

For example, the unwinding mechanisms can rotate to wind and release the tape materials. For example, the unwinding mechanisms may be driving mechanisms, that is, the rotation of the unwinding mechanisms may be actively driven by electric motors, hydraulic systems, pneumatic systems, or the like. Alternatively, for another example, the unwinding mechanisms may be driven mechanisms, such as being pulled to rotate by the winding mechanism 40 described later, so that the materials are released in the form of a tape.

The number of any one of the first feeding mechanism 11, the second feeding mechanism 12, the third feeding mechanism 21, and the fourth feeding mechanism 22 may be one or more. When a plurality of feeding mechanisms are provided, a plurality of unwinding mechanisms can be used alternately to achieve continuous unwinding operations, thereby improving production efficiency.

Exemplarily, the first feeding mechanism 11 is used for winding the first electrode plate a and releasing the first electrode plate a. For example, the first feeding mechanism 11 is rotatable, so that the first feeding mechanism 11 can rotate and feed the first electrode plate a wound thereon to a subsequent mechanism. For example, the first feeding mechanism 11 may be cylindrical, prismatic, or of in other shapes. For example, the first feeding mechanism 11 may be made of plastic, metal or other materials. Exemplarily, there may be one or more first feeding mechanisms 11 for carrying and releasing the first electrode plate a. When there are a plurality of first feeding mechanisms 11, the plurality of first feeding mechanisms 11 can be used alternately to achieve continuous unwinding operations of the first electrode plate a, thereby improving production efficiency.

Exemplarily, the second feeding mechanism 12 is used for winding the second electrode plate b and releasing the second electrode plate b. For example, the second feeding mechanism 12 is rotatable, so that the second feeding mechanism 12 can rotate and feed the second electrode plate b wound thereon to a subsequent mechanism. For example, the second feeding mechanism 12 may be cylindrical, prismatic, or of in other shapes. For example, the second feeding mechanism 12 may be made of plastic, metal or other materials. Exemplarily, there may be one or more second feeding mechanisms 12 for carrying and releasing the second electrode plate b. When there are a plurality of second feeding mechanisms 12, the plurality of second feeding mechanisms 12 can be used alternately to achieve continuous unwinding operations of the second electrode plate b, thereby improving production efficiency.

Exemplarily, the third feeding mechanism 21 is used for winding the first separator c and releasing the first separator c. For example, the third feeding mechanism 21 is rotatable, so that the third feeding mechanism 21 can rotate and feed the third separator c wound thereon to a subsequent mechanism. For example, the third feeding mechanism 21 may be cylindrical, prismatic, or of in other shapes. For example, the third feeding mechanism 21 may be made of plastic, metal or other materials. Exemplarily, there may be one or more third feeding mechanisms 21 for carrying and releasing the first separator c. When there are a plurality of third feeding mechanisms 21, the plurality of third feeding mechanisms 21 can be used alternately to achieve continuous unwinding operations of the first separator c, thereby improving production efficiency.

Exemplarily, the fourth feeding mechanism 22 is used for winding the second separator d and releasing the second separator d. For example, the fourth feeding mechanism 22 is rotatable, so that the fourth feeding mechanism 22 can rotate and feed the second separator d wound thereon to a subsequent mechanism. For example, the fourth feeding mechanism 22 may be cylindrical, prismatic, or of in other shapes. For example, the fourth feeding mechanism 22 may be made of plastic, metal or other materials. Exemplarily, there may be one or more fourth feeding mechanisms 22 for carrying and releasing the second separator d. When there are a plurality of fourth feeding mechanisms 22, the plurality of fourth feeding mechanisms 22 can be used alternately to achieve continuous unwinding operations of the second separator d, thereby improving production efficiency.

As shown in FIG. 4, the winding mechanism 40 is configured to wind an unwound electrode assembly 200 to obtain a wound electrode assembly 200. Exemplarily, the winding mechanism 40 may include a winding needle 42, the tape-shaped electrode assembly 200 can be wound on the winding needle 42 as it rotates to form the electrode assembly 200 in a specific shape, that is, the winding needle 42 can rotate to wind the tape-shaped electrode assembly 200. For example, the winding needle 42 may be driven to rotate by an electric motor, a hydraulic system, a pneumatic system, or the like. For example, the winding needle 42 may be regular in shape such as cylindrical or conical, or it may be irregular in shape. According to the different shapes of the winding needle 42, the wound electrode assembly 200 may have different shapes.

As shown in FIG. 4, the first combining mechanism 31 is arranged downstream of the first feeding mechanism 11, the second feeding mechanism 12 and the third feeding mechanism 21. The first combining mechanism 31 is configured to combine the incoming materials including at least the first electrode plate a, the first separator c and the second electrode plate b into a first composite plate e. The winding mechanism 40 is located downstream of the first combining mechanism 31 and winds the incoming material including at least the first composite plate e to form the electrode assembly 200.

Here, “the first feeding mechanism 11, the second feeding mechanism 12 and the third feeding mechanism 21 are arranged upstream of the first combining mechanism 31” can be understood as: at least the first feeding mechanism 11, the second feeding mechanism 12 and the third feeding mechanism 21 are arranged upstream of the first combining mechanism 31.

For example, the first feeding mechanism 11, the second feeding mechanism 12 and the third feeding mechanism 21 may be arranged upstream of the first combining mechanism 31, while the fourth feeding mechanism 22 is not arranged upstream of the first combining mechanism 31. Alternatively, for another example, the first feeding mechanism 11, the second feeding mechanism 12, the third feeding mechanism 21 and the fourth feeding mechanism 22 may be arranged upstream of the first combining mechanism 31.

The first feeding mechanism 11 is arranged upstream of the first combining mechanism 31, so that the first electrode plate a released by the first feeding mechanism 11 can be conveyed to the first combining mechanism 31, and the first electrode plate a can serve as the incoming material for the first combining mechanism 31. The second feeding mechanism 12 is arranged upstream of the first combining mechanism 31, so that the second electrode plate b released by the second feeding mechanism 12 can be conveyed to the first combining mechanism 31, and the second electrode plate b can serve as the incoming material for the first combining mechanism 31. The third feeding mechanism 21 is arranged upstream of the first combining mechanism 31, so that the first separator c released by the third feeding mechanism 21 can be conveyed to the first combining mechanism 31, and the first separator c can serve as the incoming material for the first combining mechanism 31. The fourth feeding mechanism 22 is arranged upstream of the first combining mechanism 31, so that the second separator d released by the fourth feeding mechanism 22 can be conveyed to the first combining mechanism 31, and the second separator d can serve as the incoming material for the first combining mechanism 31.

Exemplarily, when the first feeding mechanism 11, the second feeding mechanism 12 and the third feeding mechanism 21 are arranged upstream of the first combining mechanism 31 while the fourth feeding mechanism 22 is not arranged upstream of the first combining mechanism 31, the incoming materials for the first combining mechanism 31 include the first electrode plate a, the second electrode plate b and the first separator c. In this case, the first combining mechanism 31 can combine the first electrode plate a, the first separator c and the second electrode plate b into a first composite plate e. Here, the first composite plate e may be defined as a three-in-one composite plate, in which the first separator c is stacked between the first electrode plate a and the second electrode plate b. Here, the winding mechanism 40 is located downstream of the first combining mechanism 31 and can wind the first composite plate e and the second separator d to form the electrode assembly 200.

Exemplarily, when the first feeding mechanism 11, the second feeding mechanism 12, the third feeding mechanism 21 and the fourth feeding mechanism 22 are arranged upstream of the first combining mechanism 31, the incoming materials for the first combining mechanism 31 include the first electrode plate a, the second electrode plate b and the first separator c. In this case, the first combining mechanism 31 can combine the first electrode plate a, the first separator c and the second electrode plate b into a first composite plate e. Here, the first composite plate e may be defined as a four-in-one composite plate, in which the first separator c is stacked between the first electrode plate a and the second electrode plate b, and the second electrode plate b is stacked between the second separator d and the first separator c. Here, the winding mechanism 40 is located downstream of the first combining mechanism 31 and can wind the first composite plate e to form the electrode assembly 200.

Of course, the present application is not limited to this. For example, in other embodiments of the present application, in addition to the first feeding mechanism 11, the second feeding mechanism 12, the third feeding mechanism 21 and the fourth feeding mechanism 22 arranged upstream of the first combining mechanism 31, other feeding mechanisms may also be provided. For example, when other material layers are stacked in the electrode assembly 200, feeding mechanisms for the other material layers may also be arranged upstream of the first combining mechanism 31 based on the selection.

Referring to FIGS. 4 and 30, the winding device 100 further includes a first detection apparatus 70. The first detection apparatus 70 includes a first image acquisition apparatus 71 and a processor 702. The first image acquisition apparatus 71 is located between the first combining mechanism 31 and the winding mechanism 40 and is configured to obtain edge position images of at least one of the first electrode plate a and the second electrode plate b in the first composite plate e. The processor 702 is configured to determine an edge distance based on the edge position images and judge whether the edge distance meets a predetermined threshold.

Exemplarily, the processor 702 may be connected in communication with the first image acquisition apparatus 71, so that the processor 702 can determine the edge distance based on the edge position images of at least one electrode plate obtained by the first image acquisition apparatus 71, and judge whether the edge distance meets the threshold based on the determined edge distance.

Here, “edge position image”, “edge distance” and “threshold” have multiple optional embodiments and can be specifically set according to the content to be judged.

For example, when it is necessary to determine the OH information in the width direction of the first composite plate e, the “edge position image” refers to a “widthwise-side edge position image” at the edge of at least one side of the first composite plate e in the width direction; the “edge distance” refers to a widthwise edge distance between at least one electrode plate in the first composite plate e and at least one remaining material layer in the first composite plate e; and the “threshold” refers to a threshold of the widthwise edge distance between at least one electrode plate in the first composite plate e and at least one remaining material layer in the first composite plate e.

For example, when it is necessary to determine the OH information in the length direction of the first composite plate e, the “edge position image” refers to a “lengthwise-end edge position image” at the edge of at least one end of the first composite plate e in the length direction; the “edge distance” refers to a head edge distance and/or tail edge distance of the two electrode plates in the first composite plate e; and the “threshold” refers to a threshold of the head edge distance and/or the threshold of the tail edge distance of the two electrode plates in the first composite plate e.

In addition, the size and determination of the threshold can be set according to actual conditions. For example, it can determine whether the measured edge distance is greater than a threshold. Alternatively, it can determine whether the measured edge distance is less than the threshold. Furthermore, it can determine whether the measured edge distance is less than a maximum threshold and greater than a minimum threshold, i.e., whether it lies within the threshold range.

Additionally, the first image acquisition apparatus 71 can not only obtain the edge position images of at least one electrode plate of the electrode plate a or the electrode plate b in the first composite plate e, but also obtain edge position images of other material layers in the first composite plate e as needed, thereby enabling the determination of the desired edge distance.

It should be noted that “the first image acquisition apparatus 71 is located between the first combining mechanism 31 and the winding mechanism 40” does not impose spatial position limitations (i.e., in terms of spatial arrangement, the relative positions of the first image acquisition apparatus 71, the first combining mechanism 31, and the winding mechanism 40 are not restricted). Rather, it imposes a limitation on the workstation order. That is, the first composite plate e formed by the first combining mechanism 31 can be detected by the first image acquisition apparatus 71 before entering the winding mechanism 40.

In the related technologies, during the production of electrode assemblies using winding devices, negative electrode plates, positive electrode plates and separators are fed into winding mechanisms separately; and detectors are disposed at the winding mechanisms to measure the offset between the layers. However, this approach is prone to the problem that OH (overhang) detection is missed, such as OH between the positive and negative electrode plates and OH between the separator and the electrode plate. Specifically, a detector performs OH detection just before an electrode plate enters the winding mechanism. If the angle between the electrode plate and the winding mechanism (i.e., the winding angle) deviates from a set angle, then after the electrode plate enters the winding mechanism, the OH value of a product wound on the winding mechanism will change relative to the previous detection result. Moreover, once the head of the electrode plate enters the winding mechanism, it will be blocked by the winding mechanism. The head of the electrode plate can no longer be detected, resulting in a detection blind spot. Therefore, it is no longer possible to determine the OH after the electrode plate enters the winding mechanism, leading to the miss of OH detection and increasing the risk of outflow of defective products.

In the embodiments of the present application, the first composite plate e is obtained by combining the first electrode plate a, the second electrode plate b, and at least one separator in advance through the first combining mechanism 31 before entering the winding mechanism 40; the first composite plate e is detected by the first detection apparatus 70 before entering the winding mechanism 40 so as to obtain the quality of the first composite plate e; and the qualified first composite plate e is then conveyed to the winding mechanism 40. Since the relative positions between the positive electrode plate and the negative electrode plate as well as between the electrode plates and separators in the first composite plate e after combination remain stable, displacement or misalignment is minimized. Accordingly, after the qualified first composite plate e is wound by the winding mechanism 40, the OH value associated with the electrode plates remains within acceptable limits, thereby alleviating the problem of outflow of defective wound products. Moreover, since the first composite plate e is detected before entering the winding mechanism 40, the first image acquisition apparatus 71 is not obstructed by the winding mechanism 40, the head of the first composite plate e is not blocked by the winding mechanism 40, eliminating detection blind spots. This enables comprehensive detection of the first composite plate e, which is conducive to alleviating the problem that OH detection is missed.

In some embodiments of the present application, the detection apparatus in the winding device 100 may only include the first detection apparatus 70; in some other embodiments of the present application, the detection apparatus in the winding device 100 may not only include the first detection apparatus 70, for example, it may also include any one of the group of a second detection apparatus, a third detection apparatus, a fifth detection apparatus, a sixth detection apparatus, a seventh detection apparatus, an eighth detection apparatus, a ninth detection apparatus, and a tenth detection apparatus described later.

Exemplarily, any other detection apparatus other than the first detection apparatus 70 (such as the second to tenth detection apparatuses) may include respective image acquisition apparatuses and respective processors, and the respective image acquisition apparatuses are connected in communication with the corresponding processors, thereby simplifying the communication routing. Any other detection apparatus other than the first detection apparatus 70 (such as the second to tenth detection apparatuses) may also only include respective image acquisition apparatuses without processors. In this case, their respective image acquisition apparatuses can be connected in communication with the processor 702 of the first detection apparatus 70. The processor 702 of the first detection apparatus 70 is a shared processor, thereby simplifying the device and reducing costs.

In the embodiments of the present application, the object for the first image acquisition apparatus 71 to obtain edge position images, may be specifically set according to the content to be judged.

For example, in some embodiments, the object for the first image acquisition apparatus 71 to obtain edge position images may include the first electrode plate a and the first separator c. Specifically, the first image acquisition apparatus 71 is configured to obtain the edge position images of the first electrode plate a and the first separator c in the first composite plate e, and the edge distance includes an edge distance between the first electrode plate a and the first separator c.

For example, when it is necessary to determine the OH information of the first electrode plate a and the first separator c in the width direction, the “edge position images” refers to edge position images of the same sides (one side or both sides) of the first electrode plate a and the first separator c in the width direction of the first composite plate e; the “edge distance” refers to an edge distance between the same sides of the first electrode plate a and the first separator c in the width direction of the first composite plate e; and the “threshold” refers to a threshold of the edge distance between the same sides of the first electrode plate a and the first separator c in the width direction of the first composite plate e. Thus, it is possible to determine whether the edge distance by which the first separator extends beyond the first electrode plate meets the corresponding threshold requirement on one or both sides of the first composite plate in the width direction.

For example, when it is necessary to determine the OH information of the first electrode plate a and the first separator c in the length direction, the “edge position images” refers to edge position images of the same ends (the heads or tails or the heads and tails) of the first electrode plate a and the first separator c in the length direction of the first composite plate e; the “edge distance” refers to an edge distance between the same ends of the first electrode plate a and the first separator c in the length direction of the first composite plate e; and the “threshold” refers to a threshold of the edge distance between the same ends of the first electrode plate a and the first separator c in the length direction of the first composite plate e. Thus, it is possible to determine whether the edge distance by which the first separator c extends beyond the first electrode plate a meets the corresponding threshold requirement at the head and/or tail of the first composite plate e in the length direction.

For example, in some embodiments, the object for the first image acquisition apparatus 71 to obtain edge position images may include the second electrode plate b and the first separator c. Specifically, the first image acquisition apparatus 71 is configured to obtain the edge position images of the second electrode plate b and the first separator c in the first composite plate e, and the edge distance includes an edge distance between the second electrode plate b and the first separator c.

For example, when it is necessary to determine the OH information of the second electrode plate b and the first separator c in the width direction, the “edge position images” refers to edge position images of the same sides (one side or both sides) of the second electrode plate b and the first separator c in the width direction of the first composite plate e; and the “edge distance” refers to an edge distance between the same sides of the second electrode plate b and the first separator c in the width direction of the first composite plate e; and the “threshold” refers to a threshold of the edge distance between the same sides of the second electrode plate b and the first separator c in the width direction of the first composite plate e. Thus, it is possible to determine whether the edge distance by which the first separator extends beyond the second electrode plate b meets the corresponding threshold requirement on one or both sides of the first composite plate e in the width direction.

For example, when it is necessary to determine the OH information of the second electrode plate b and the first separator c in the length direction, the “edge position images” refers to edge position images of the same ends (the heads or tails, or the heads and tails) of the second electrode plate b and the first separator c in the length direction of the first composite plate e; the “edge distance” refers to an edge distance between the same ends of the second electrode plate b and the first separator c in the length direction of the first composite plate e; and the “threshold” refers to a threshold of the edge distance between the same ends of the second electrode plate b and the first separator c in the length direction of the first composite plate e. Thus, it is possible to determine whether the edge distance by which the first separator c extends beyond the second electrode plate b meets the corresponding threshold requirement at the heads and/or tails of the first composite plate e in the length direction.

Exemplarily, the first image acquisition apparatus 71 can be used for detecting the relative positions of the first separator c and the electrode plate (the second electrode plate b and/or the first electrode plate a) in the first composite plate e, such as determining whether the first separator c can achieve insulation between the second electrode plate b and the first electrode plate a, the OH defect (i.e., the size of the edge of the first separator c extending beyond the edge of the electrode plate in the width direction of the electrode plate does not meet the desired size range) of the first separator c covering the electrode plate along the width direction, etc.

For example, in some embodiments, the object for the first image acquisition apparatus 71 to obtain edge position images may include the first electrode plate a and the second electrode plate b. Specifically, the first image acquisition apparatus 71 is configured to obtain the edge position images of the first electrode plate a and the second electrode plate b in the first composite plate e, and the edge distance includes an edge distance between the first electrode plate a and the second electrode plate b. Alternatively, in some embodiments, the object for the first image acquisition apparatus 71 to obtain edge position images may include the first electrode plate a, the first separator c and the second electrode plate b. Specifically, the first image acquisition apparatus 71 is configured to obtain the edge position images of the first electrode plate a, the first separator c and the second electrode plate b in the first composite plate e, and the edge distance includes an edge distance between the first electrode plate a and the second electrode plate b.

There are multiple alternative embodiments for determining the “edge distance” between the first electrode plate a and the second electrode plate b. For example, a direct approach may be adopted: directly detecting the edge positions of the first electrode plate a and the second electrode plate b, then calculating their difference directly to determine the edge distance between the first electrode plate a and the second electrode plate b. For example, to facilitate detection, an X-ray camera can be used to directly capture edges of the first electrode plate a and the second electrode plate b. Alternatively, for another example, an indirect approach may be adopted: first determining an edge distance OH1 between the first electrode plate a and the first separator c based on the edge positions of the first electrode plate a and the first separator c, and then determining an edge distance OH2 between the second electrode plate b and the first separator c based on the edge position of the second electrode plate b and the edge position of the first separator c, and calculating the difference between the edge distances OH1 and OH2, so as to determine the edge distance between the first electrode plate a and the second electrode plate b.

For example, when it is necessary to determine the OH information of the second electrode plate b and the first electrode plate a in the width direction, the “edge position images” refers to edge position images of the same sides (one side or both sides) of the second electrode plate b and the first electrode plate a in the width direction of the first composite plate e; and the “edge distance” refers to an edge distance between the same sides of the second electrode plate b and the first electrode plate a in the width direction of the first composite plate e; and the “threshold” refers to a threshold of the edge distance between the same sides of the second electrode plate b and the first electrode plate a in the width direction of the first composite plate e. Thus, it is possible to determine whether the edge distance between the first electrode plate a and the second electrode plate b meets the corresponding threshold requirement on one side or both sides of the first composite plate e in the width direction.

For example, when it is necessary to determine the OH information of the second electrode plate b and the first electrode plate a in the length direction, the “edge position images” refers to edge position images of the same ends (the heads or tails, or the heads and tails) of the second electrode plate b and the first electrode plate a in the length direction of the first composite plate e; the “edge distance” refers to an edge distance between the same ends of the second electrode plate b and the first electrode plate a in the length direction of the first composite plate e; and the “threshold” refers to a threshold of the edge distance between the same ends of the second electrode plate b and the first electrode plate a in the length direction of the first composite plate e. Thus, it is possible to determine whether the edge distance between the first electrode plate a and the second electrode plate b meets the corresponding threshold requirement at the head and/or tail of the first composite plate e in the length direction.

Exemplarily, the first image acquisition apparatus 71 can be used for determining the OH (i.e., the size of the edges on two sides of an active material area of the positive electrode plate extending beyond the edges on two sides of an active material area of the positive electrode plate in the width direction) of the positive electrode plate covering the negative electrode plate in the width direction. In this way, since the problem that OH detection is missed is alleviated, the distance between the widthwise sides of the positive electrode plate and the edge of the negative electrode plate in the electrode assembly 200 formed by subsequent winding can meet the requirements, which is conducive to solving the problem of lithium plating.

Exemplarily, the first image acquisition apparatus 71 can be used for determining the OH of the positive electrode plate that covers the negative electrode plate in the length direction and the width direction respectively. In this way, in the first composite plate e formed, the length and width of the positive electrode plate are both greater than those of the negative electrode plate, so that the positive electrode plate can completely cover the negative electrode plate.

In addition, when the first composite plate e includes the second separator d, the object for the first image acquisition apparatus 71 to obtain edge position images may also include the second separator d. For example, it can be determined, based on the edge position image of the second separator d and the edge position image of the second electrode plate b, whether the edge distance by which the second separator d extend beyond the second electrode plate b meets the corresponding threshold requirement. For another example, based on the edge position image of the second separator d and the edge position image of the first separator c, it can be determined whether the edge distance between the second separator d and the first separator c meets the corresponding threshold requirements (for example, when the edges of the two separators need to be sealed, it can be determined whether the edge sealing requirements are met), and the like.

In the embodiments of the present application, the specific type of the first image acquisition apparatus 71 is not limited, and may include, for example, a CCD camera, and an X-ray camera. Exemplarily, the processor 702 can convert the image information of the first composite plate e obtained by the first image acquisition apparatus 71 into a digital signal, followed by corresponding calculations and judgments.

For a clearer description, some optional embodiments of the first image acquisition apparatus 71 are described below in combination with some application scenarios, but the optional embodiments of the first image acquisition apparatus 71 are not limited to the following.

In some embodiments, the first image acquisition apparatus 71 is configured to obtain widthwise-side edge position images of the first composite plate e in a width direction, and the processor 702 is configured to determine an edge distance of one and/or both widthwise sides based on the widthwise-side edge position images, and judge whether the edge distance meets a corresponding threshold.

“The first image acquisition apparatus 71 is configured to obtain edge position images of at least one of the first electrode plate a and the second electrode plate b in the first composite plate e; the processor 702 is configured to determine an edge distance based on the edge position images of at least one electrode plate obtained by the first image acquisition apparatus 71 and judge whether the edge distance meets a predetermined threshold”, where the “edge position images” refers to the “widthwise-side edge position images” at the edge of at least one side of the first composite plate e in the width direction; the “edge distance” refers to a widthwise edge distance between at least one electrode plate in the first composite plate e and at least one remaining material layer in the first composite plate e; and the “threshold” is a threshold of the widthwise edge distance between at least one electrode plate in the first composite plate e and at least one remaining material layer in the first composite plate e.

Thus, it is possible to determine the OH condition of the first composite plate e in the width direction. For example, when the detection object refers to the first electrode plate a and the first separator c, it is possible to determine whether the edge distance by which the first separator c extends beyond the first electrode plate a meets the corresponding threshold requirement on one or both sides of the first composite plate e in the width direction. For example, when the detection object refers to the second electrode plate b and the first separator c, it is possible to determine whether the edge distance by which the first separator c extends beyond the second electrode plate b meets the corresponding threshold requirement on one or both sides of the first composite plate e in the width direction. For example, when the detection object refers to the second electrode plate b and the first electrode plate a, it is possible to determine whether the edge distance between the first electrode plate a and the second electrode plate b meets the corresponding threshold requirement on one or both sides of the first composite plate e in the width direction.

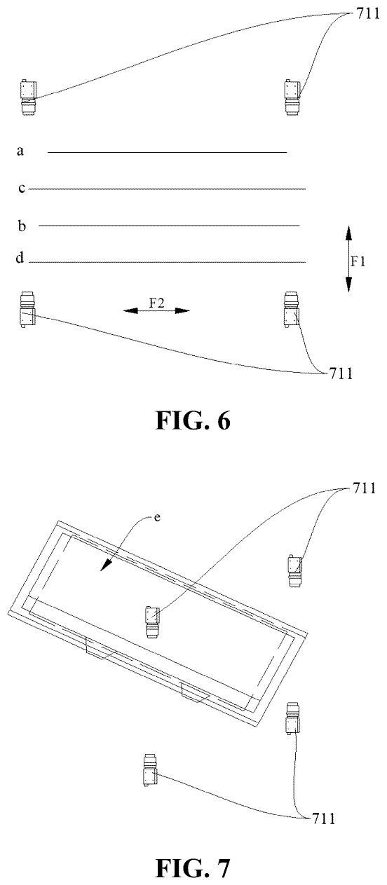

In some embodiments, when the first image acquisition apparatus 71 is used for obtaining the widthwise-side edge position images of the first composite plate e in the width direction, with reference to FIGS. 6 and 7, the first image acquisition apparatus 71 may include a first acquisition unit 711, the first acquisition unit 711 includes two groups of CCD cameras, the two groups of CCD cameras are arranged, in a thickness direction of the first composite plate e, on two sides of the first composite plate e respectively, and the two groups of CCD cameras are respectively configured to obtain the widthwise-side edge position images of the first composite plate e in the width direction.

Thus, image acquisition can be performed from both sides of the first composite plate e in the thickness direction, so that relatively accurate and clear image information can be obtained regardless of whether image information of the first electrode plate a or the second electrode plate b needs to be acquired.

Exemplarily, with reference to FIGS. 6 and 7, each group of CCD cameras in the first acquisition unit 711 includes two CCD cameras, the two CCD cameras in the same group are spaced apart in the width direction of the first composite plate e, and the two CCD cameras in the same group are respectively configured to obtain the widthwise-side edge position images of edge positions of two sides of the first composite plate e in the width direction.

Thus, a single first acquisition unit 711 can simultaneously acquire image information of both sides of the first composite plate in the width direction, enabling OH determination on one or both widthwise sides.

In some embodiments, when the first image acquisition apparatus 71 is used for obtaining the width-side edge position images of the first composite plate e in the width direction, with reference to FIG. 31, the first image acquisition apparatus 71 may include a second acquisition unit 712, the second acquisition unit 712 includes an X-ray camera, and the X-ray camera is configured to obtain the widthwise-side edge position images of the first composite plate e in the width direction.

Since the X-ray camera can achieve penetrating photography, it only needs to be arranged on one side of the first composite plate e in the thickness direction, and does not need to be arranged on both sides of the first composite plate e in the thickness direction, thereby saving space and simplifying configuration.

In some embodiments, the first image acquisition apparatus 71 is configured to obtain lengthwise-end edge position images of the first electrode plate a and the second electrode plate b in the length direction of the first composite plate e, and the processor 702 is configured to determine an edge distance between the heads and/or tails of the first electrode plate a and the second electrode plate b based on the lengthwise-end edge position images of the first electrode plate a and the second electrode plate b, and judge whether the edge distance meets a corresponding threshold. Alternatively, the first image acquisition apparatus 71 may also be configured to obtain lengthwise-end edge position images of the first electrode plate a the first separator c and the second electrode plate b in the length direction of the first composite plate e, and the processor 702 is configured to determine an edge distance between the heads and/or tails of the first electrode plate a, the first separator c and the second electrode plate b based on the lengthwise-end edge position images of the first electrode plate a, the first separator c and the second electrode plate b, and judge whether the edge distance meets a corresponding threshold.

For example, the first image acquisition apparatus 71 is configured to obtain head edge position images of the first electrode plate a and the second electrode plate b in the length direction of the first composite plate e, and the processor 702 is configured to determine a head edge distance between the heads and/or tails of the first electrode plate a and the second electrode plate b based on the head edge position images of the first electrode plate a and the second electrode plate b, and judge whether the head edge distance meets a corresponding threshold.

For another example, the first image acquisition apparatus 71 is configured to obtain tail edge position images of the first electrode plate a and the second electrode plate b in the length direction of the first composite plate e, and the processor 702 is configured to determine a tail edge distance between the heads and/or tails of the first electrode plate a and the second electrode plate b based on the tail edge position images of the first electrode plate a and the second electrode plate b, and judge whether the tail edge distance meets a corresponding threshold.

Thus, it is possible to determine the OH condition of the first composite plate e in the length direction. For example, it is possible to determine whether the edge distance between the first electrode plate a and the second electrode plate b meets the corresponding threshold requirement at the head and/or tail of the first composite plate e in the length direction. In the related technologies, since it is difficult to detect the head of the first composite plate e after it enters the winding mechanism, detection is performed before it enters the winding needle, which can alleviate the problem that OH detection is missed.

Two ends of the electrode plate (the first electrode plate a, the second electrode plate b) in the length direction of the first composite plate e are the head and the tail respectively. At the cut point of the electrode plate, the electrode plate is prone to shake. The phenomenon of the head of the electrode plate being offset is called “head shake”, and the phenomenon of the tail of the electrode plate being offset is called “tail shake”. Through the above description, the first detection apparatus 70 can be used for determining whether the first composite plate e has “head shake” and/or “tail shake”.

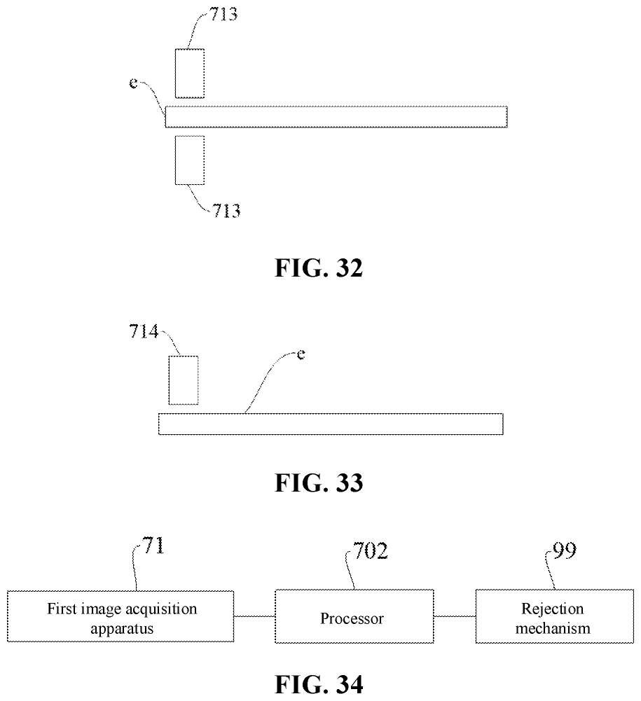

In some embodiments, when the first image acquisition apparatus 71 is used to obtain the lengthwise-end edge position images of the first electrode plate a and the second electrode plate b in the length direction of the first composite plate e, with reference to FIG. 32, the first image acquisition apparatus 71 includes a third acquisition unit 713, the third acquisition unit 713 includes two groups of CCD cameras, the two groups of CCD cameras are arranged, in a thickness direction of the first composite plate e, on two sides of the first composite plate e respectively, and the two groups of CCD cameras are respectively configured to obtain the head or tail edge position images of the first composite plate e and the second electrode plate b in the length direction of the first composite plate e.

Thus, image acquisition can be performed from both sides of the first composite plate e in the thickness direction, so that the acquired image information of the first electrode plate a and the second electrode plate b are relatively accurate and clear, which is conducive to more accurately determining the OH problem at the heads and/or tails of the first electrode plate a and the second electrode plate b in the length direction.

In some embodiments, when the first image acquisition apparatus 71 is used to obtain the lengthwise-end position images of the first electrode plate a and the second electrode plate b in the length direction of the first composite plate e, with reference to FIG. 33, the first image acquisition apparatus 71 includes a fourth acquisition unit 714, the fourth acquisition unit 714 includes an X-ray camera, and the X-ray camera is used to obtain the head or tail edge position images of the first electrode plate a and the second electrode plate b in the length direction of the first composite plate e.

Since the X-ray camera can achieve penetrating photography, it only needs to be arranged on one side of the first composite plate e in the thickness direction, and does not need to be arranged on both sides of the first composite plate e in the thickness direction, thereby saving space and simplifying configuration.

In some embodiments of the present application, the first acquisition unit 711 and the third acquisition unit 713 may be the same unit or may be separate units. When they are separate units, the first acquisition unit 711 and the third acquisition unit 713 may be disposed apart from each other.

In some embodiments of the present application, the second acquisition unit 712 and the fourth acquisition unit 714 may be the same unit or may be separate units. When they are separate units, the second acquisition unit 712 and the fourth acquisition unit 714 may be disposed apart from each other.

In some embodiments, with reference to FIG. 34, the winding device 100 further includes a rejection mechanism 99. The rejection mechanism 99 is located between the first image acquisition apparatus 70 and the winding mechanism 40, where the rejection mechanism 99 is configured to reject a first composite plate e that fails to meet the threshold based on a signal, indicating that the edge distance does not meet the threshold, sent by the processor 702. For example, the rejection mechanism 99 is connected in communication with the processor 702. The rejection mechanism 99 can receive the signal from the processor 702 indicating that the edge distance does not meet the threshold, and based on the signal, it rejects the first composite plate e that fails to meet the threshold.

For example, when the determined edge distance should be greater than the threshold but is instead less than the threshold, it fails to meet the threshold requirement and can be rejected. For another example, when the determined edge distance should be less than the threshold but is instead greater than the threshold, it fails to meet the threshold requirement and can be rejected. For yet another example, when the determined edge distance should be less than a maximum threshold and greater than a minimum threshold, i.e., when it should fall within the threshold range but is instead exceeds the threshold range, it fails to meet the threshold requirement and can be rejected. The threshold may be set according to actual conditions.

In the above technical solution, after the processor 702 determines that the threshold is not met, it can reject the non-compliant first composite plate e and prevent it from being wound onto the winding mechanism 40. This prevents defective products from outflow, controls the quality of wound products, and avoids generating winding scrap to avoid unnecessary waste. The related technologies involves alarm or marking, and rejection will not be performed before winding, which is prone to wastes or defective products.

In addition, exemplarily, the first image acquisition apparatus 71 is located after the first combining mechanism 31 and before the winding mechanism 40, and can also be configured to detect the state of the electrode plates (the second electrode plate b and/or the first electrode plate a) in the first composite plate e, such as whether the electrode plates have folded corners, whether the electrode plates are damaged, the width of active material layers of the electrode plates, and known defective electrode plates (such as defective products with yellow labels, etc.).

In addition, exemplarily, the first image acquisition apparatus 71 is located after the first combining mechanism 31 and before the winding mechanism 40, and can also be configured to detect the state of the first separator c in the first composite plate e, such as separator wrinkling, separator folding, and separator breakage.

In the related technologies, since the lamination of the electrode plates and the separator is usually carried out at the winding needle, it is not easy to detect the heads of the electrode plates and the separator entering the winding needle by the detection apparatus. This not only leads to the missed detection of OH (overhang, referring to excess part, which may occur between the positive electrode plate and the negative electrode plate or between the separator and electrode plates) but also increases the likelihood of missed detection for defects such as folding and crushing at the heads of the electrode plates. In the embodiments of the application, the first image acquisition apparatus 71 is arranged upstream of the winding mechanism 40, so that the first detection apparatus 71 can detect the first composite plate e more comprehensively, reducing the area of blind spots or undetectable parts, and alleviating the problem of missed detection for defects such as folding and crushing at the heads of the electrode plates. In addition, the positions between the positive and negative electrodes and between the electrode plates and the separator in the first composite plate e combined by the first combining mechanism 31 are relatively fixed and less prone to offset. The structure of the first composite plate e that passes the detection by the first detection apparatus 71 is not easy to change, thereby increasing the pass rate of the electrode assembly 200 wound subsequently.

In the related technologies, the winding device winds the first electrode plate, the first separator, the second electrode plate and the second separator at the winding needle, and uses a CCD image acquisition apparatus to detect them. The CCD image acquisition apparatus takes pictures toward the winding needle. Due to the angle limitation, the head of the electrode plate is difficult to be photographed by the CCD image acquisition apparatus during winding, and the tail of the electrode assembly is also difficult to be photographed during unwinding. There are detection blind spots, and it is difficult to detect the head and tail of the electrode plate, as well as the breakage of the head and tail. In the embodiments of the application, the first electrode plate a, the second electrode plate b and the first separator c are combined in advance by the first combining mechanism 31 before the electrode plate is wound, the first composite plate e is detected comprehensively by the first image acquisition apparatus 71 before the first complete plate e enters the winding mechanism 40, so that possible defects in the electrode plate and the separator can be discovered in time, such as the missed detection of OH (OH between the positive electrode plate and the negative electrode plate, may also be OH between the separator and the electrode plate), wrinkling of the head of the separator, crushing and breakage of the electrode plate, head shake and tail shake. This reduces the detection blind spots and enables timely rejection of unqualified products, thereby helping to improve the quality of the electrode assembly 200.

In the related technologies, during the manufacturing process of the battery cell, a winding machine is used to wind two electrode plates on different material lines together. The two electrode plates will be separately transferred to the winding needles of the winding mechanism. A certain relative position needs to be maintained between the two electrode plates, otherwise poor lithium plating is likely to occur. Specifically, there is an offset in the length or width direction of the two electrode plates. Lithium ions are not transferred from one electrode plate to the other, but are plated in the area outside the electrode plate, thereby generating lithium crystals, resulting in defects such as punctures and cuts of the electrode assembly formed from the electrode plate and leading to safety risks in the battery cell. In order to ensure the relative position of the two electrode plates, avoid punctures, cuts and other defects in the electrode assembly formed after winding, and avoid these adverse effects on subsequent processes (e.g., welding), a detector can be used to detect the electrode plates during or after winding to confirm that the two electrode plates in the detection area are in the correct position. However, when the detector detects two electrode plates during the winding process or two electrode plates after winding, there are blind spots in the field of view, which may lead to missed detection. Moreover, the two electrode plates have free ends, which is specifically manifested in that the two electrode plates do not deflect before entering the winding needle, but deflect after entering the winding needle. Therefore, at the beginning of winding, the detection of the relative position between the two electrode plates is inaccurate. In the embodiments of the present application, the first combining mechanism 31 in the winding device 100 combines the second electrode plate b, the first electrode plate a and the separator before entering the winding needle 42 to forma first composite plate e in a flattened state. Since the first composite plate e is in a flattened state and is not wound, the relative position between the second electrode plate b and the first electrode plate a are relatively stable, so that the first image acquisition apparatus 71 can accurately and easily detect the relative position between the second electrode plate b and the first electrode plate a, and there is no blind spot in shooting. The head, middle and tail of the entire first composite plate e can be photographed, so that the relative position between the second electrode plate b and the first electrode plate a is correct, and there is no missed detection of OH at the head or tail, which helps to improve the quality of the electrode assembly 200.

Moreover, in the embodiments of the application, since the first combining mechanism 31 and the winding mechanism 40 are provided, at least the second electrode plate b, the first separator c and the first electrode plate a are stacked and combined in sequence through the first combining mechanism 31 to form the first composite plate e, and the first composite plate e is then wound through the winding mechanism 40 to form the electrode assembly 200. In this way, the combining operation of at least the second electrode plate b, the first separator c and the first electrode plate a is separately arranged from the winding operation of the winding mechanism 40, so that there is no need to concentrate the combining of the second electrode plate b, the first separator c and the first electrode plate a at the winding needle 42 of the winding mechanism 40, so that there can be a larger space between at least the first feeding mechanism 11, the second feeding mechanism 12, the third feeding mechanism 21 and the winding mechanism 40, so as to improve the rationality of the layout of the winding device 100, and facilitate the layout of various functional devices and mechanisms, such as the layout of the above-mentioned first image acquisition apparatus 71, etc., which helps to improve the quality of the electrode assembly 200.

With reference to FIG. 4, in some embodiments, the winding device 100 further includes a first cutting mechanism 61 for cutting the first electrode plate a and a second cutting mechanism 62 for cutting the second electrode plate b. For example, when the first combining mechanism 31 is arranged upstream of the winding mechanism 40, both the first cutting mechanism 61 and the second cutting mechanism 62 may be arranged upstream of the first combining mechanism 31. For example, the first cutting mechanism 61 may be arranged between the first feeding mechanism 11 and the first combining mechanism 31, and the second cutting mechanism 62 may be arranged between the second feeding mechanism 12 and the first combining mechanism 31. Thus, both the first cutting mechanism 61 and the second cutting mechanism 62 may be arranged spatially away from the winding mechanism 40 to solve the adverse effect on the quality of the electrode assembly 200 caused by chips formed by cutting falling into the electrode assembly 200 wound on the winding needle 42, thereby facilitating further improvement of the quality of the electrode assembly 200.

With reference to FIG. 4, in some embodiments, the winding device 100 further includes a third cutting mechanism 63 for cutting the separator. Since the first separator c and the second separator d are both supplied in continuous coils, they need to be cut by the third cutting mechanism 63 after being combined with the first electrode plate a and the second electrode plate b.

The number of the third cutting mechanisms 63 is not limited, and may be, for example, one or two. For example, when the number of the third cutting mechanism 63 is one, the third cutting mechanism 63 can cut off the first separator c and the second separator d at the same time; for another example, when the number of the third cutting mechanism 63 is at least two, at least one third cutting mechanism 63 can be used to cut off the first separator c, and at least one third cutting mechanism 63 can be used to cut off the second separator d.

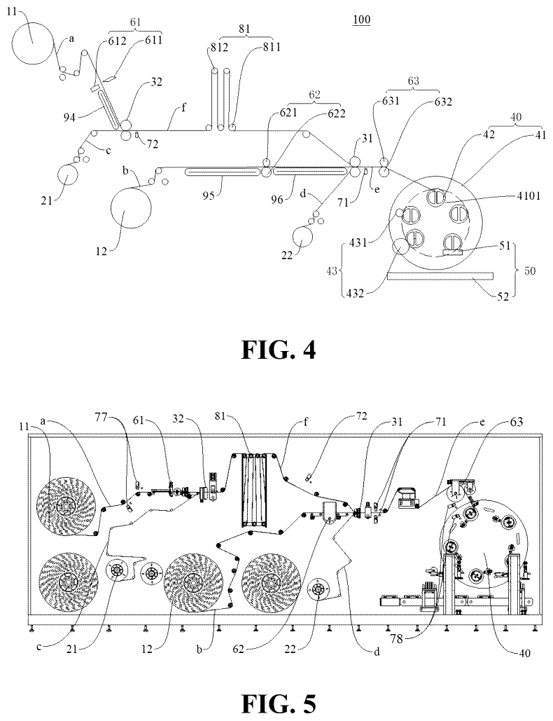

For example, when the first image acquisition apparatus 71 is disposed between the first combining mechanism 31 and the winding mechanism 40, the specific position of the third cutting mechanism 63 can be flexibly set. For example, the first image acquisition apparatus 71 may be disposed between the first combining mechanism 31 and the third cutting mechanism 63 (see FIG. 4 and FIG. 5), or the first image acquisition apparatus 71 may be disposed between the third cutting mechanism 63 and the winding mechanism 40.

With reference to FIG. 4, in some embodiments, the fourth feeding mechanism 22 is arranged upstream of the first combining mechanism 31 so that the second separator d is also combined in the first composite plate e, that is, the first combining mechanism 31 is used to combine the incoming materials including at least the first electrode plate a, the first separator c, the second electrode plate b and the second separator d into a first composite plate e.

The fourth feeding mechanism 22 is arranged upstream of the first combining mechanism 31, so that the second separator d released by the fourth feeding mechanism 22 can be conveyed to the first combining mechanism 31, and the second separator d can serve as the incoming material for the first combining mechanism 31. Exemplarily, the first combining mechanism 31 can combine the first electrode plate a, the first separator c, the second electrode plate b and the second separator d into a first composite plate e, so that the first composite plate e is a four-in-one composite plate. In the four-in-one composite plate, the first separator c is stacked between the first electrode plate a and the second electrode plate b, and the second separator d is stacked on the side of the first electrode plate a or the second electrode plate b that is away from the first separator c.

To simplify the description, the following description will be made by taking the second electrode plate b being stacked between the first separator c and the second separator d, in the first composite plate e, as an example. Of course, the first electrode plate a may also be stacked between the first separator c and the second separator d. Exemplarily, the first composite plate e is stacked in the order of the first electrode plate a, the first separator c, the second electrode plate b and the second separator d, the second electrode plate b is stacked between the first separator c and the second separator d, and the first separator c is stacked between the first electrode plate a and the second electrode plate b, the first electrode plate a is a negative electrode plate, and the second electrode plate b is a positive electrode plate.

The first electrode plate a, the second electrode plate b, the first separator c and the second separator d are all plate-like structures and have a thickness. For example, the second separator d, the second electrode plate b, the first separator c and the first electrode plate a are stacked in sequence, which means that the second separator d, the second electrode plate b, the first separator c and the first electrode plate a are stacked in sequence along the thickness direction of the electrode plate. In this case, the thickness direction of the second separator d, the thickness direction of the second electrode plate b, the thickness direction of the first separator c and the thickness direction of the first electrode plate a are parallel.

In the first composite plate e, the first separator c is arranged between the second electrode plate b and the first electrode plate a to achieve insulation between the second electrode plate b and the first electrode plate a. In the electrode assembly 200 formed by winding the first composite plate e, the second separator d is arranged between the second electrode plate b and the first electrode plate a to achieve insulation between the second electrode plate b and the first electrode plate a.

Thus, when the fourth feeding mechanism 22 is arranged upstream of the first combining mechanism 31 such that the second separator d is also combined in the first composite plate e, the first composite plate e detected by the first image acquisition apparatus 71 includes at least the first electrode plate a, the first separator c, the second electrode plate b and the second separator d which are stacked, facilitating a more comprehensive detection. For example, in addition to detecting the relative position between the second electrode plate b and the first electrode plate a in the first composite plate e, detecting the relative position between the first separator c and the electrode plate in the first composite plate e, detecting the state of the electrode plate (the second electrode plate b and/or the first separator d) in the first composite plate e, and detecting whether there is head shake or tail shake in the first composite plate e, as mentioned above, it can also be used to detect the relative position between the second separator d and the electrode plate (the second electrode plate b and/or the first electrode plate a), detect the state of the second separator d in the first composite plate e, and detect the relative position between the first separator c and the second separator d, etc. The expanded range of detectable information enables more thorough prevention of missed detection of defects, allowing for the timely rejection of unqualified products, thereby improving the quality of the electrode assembly 200.

Moreover, the first combining mechanism 31 can combine at least the first electrode plate a, the first separator c, the second electrode plate b and the second separator d to obtain a first composite plate e. Compared to the solution of combining these four layers at the winding needle 42, this approach lowers the functional demands on the winding needle 42, and is conducive to increasing the winding speed of the winding needle 42, and improving production efficiency. Furthermore, it enables the combination of the electrode plates and the separators prior to winding, thereby minimizing displacement of the electrode plates and separators in the winding process and improving the quality of the electrode assembly 200.

Referring to FIGS. 4 and 5, when the second separator d is also combined in the first composite plate e, the first combining mechanism 31 may be an edge sealing mechanism. The first combining mechanism 31 is configured to seal and connect at least one of the two side edges of the first separator c and the second separator d in the width direction.

Here, the edge sealing connection of edges of the two separators may be set only on a tab side in the width direction of the electrode plate, or only on a slitting side in the width direction of the electrode plate (i.e., the non-tab side), or simultaneously on both sides in the width direction of the electrode plate (i.e., the tab side and the slitting side). Here, the edge sealing of the edges of the two separators on the tab side may be continuous edge sealing or intermittent edge sealing that avoids the pole ear (i.e., edges of the tab area are not sealed), and the edge sealing of the two separators on the slitting side may be continuous edge sealing or intermittent edge sealing. In addition, the selection and function of the “edge sealing mechanism” mentioned in any subsequent embodiment of the present application may refer to this embodiment.

With reference to FIG. 6, for the electrode assembly 200, the material conveying direction of the second electrode plate b, the first electrode plate a, the first separator c, and the second separator d refers to a traveling direction of each material in the production process, i.e., the length direction of each material in the electrode assembly 200; a thickness direction F1 of the second electrode plate b, the first electrode plate a, the first separator c, and the second separator d refers to a direction in which the material size is smallest, i.e., a stacking direction of each material in the electrode assembly 200; and the width direction F2 of the second electrode plate b, the first electrode plate a, the first separator c, and the second separator d refers to a direction perpendicular to the thickness direction F1 and the material conveying direction. During the winding process of the electrode assembly 200, the winding axis is substantially parallel to the width direction F2.

The width of the first separator c is greater than the width of the second electrode plate b, and the width of the second separator d is greater than the width of the second electrode plate b. The edge sealing mechanism can seal the portion of the first separator c that extends beyond the edge of the second electrode plate b in the width direction F2 and the portion of the second separator d that extends beyond the edge of the second electrode plate b in the width direction F2. For example, the connection between the first separator c and the second separator d can be achieved by heating, pressurizing, and gluing. According to actual needs, the sealed edges of the first separator c and the second separator d may extend continuously or discontinuously along the material conveying direction, which falls within the protection scope of the present application.

For example, as shown in FIG. 6, the portion of the second separator d that extends beyond the left edge of the second electrode plate b is connected to the portion of the first separator c that extends beyond the left edge of the second electrode plate b to achieve left edge sealing. For example, as shown in FIG. 6, the portion of the second separator d that extends beyond the right edge of the second electrode plate b is connected to the portion of the first separator c that extends beyond the right edge of the second electrode plate b to achieve right edge sealing; the left edge sealing and the right edge sealing may be set at the same time, or only one of them may be set.

Therefore, since the edge sealing mechanism can connect edges of the first separator c and the second separator d together to achieve edge sealing, the first separator c and the second separator d will not separate upon removal of the external force, preventing exposure of the second electrode plate b; gaps are less prone to folding during winding of the electrode assembly 200, and the electrolyte filling process is less susceptible to hole disturbance, thereby effectively lowering the risk of the second electrode plate b overlapping with the first electrode plate a or with a housing 3011 of a battery cell 301 and alleviating the problem of lithium plating.

For example, with reference to FIG. 5, the edge sealing mechanism may include two edge sealing rollers arranged opposite to each other. The two edge sealing rollers can heat edges of both sides of the first separator c and the second separator d and apply a predetermined pressure in the thickness direction F1 to achieve an edge-sealing connection of the first separator c and the second separator d.

Exemplarily, with reference to FIG. 4, the first combining mechanism 31 may include two rollers arranged relatively spaced apart, or may include one roller and a support arranged relatively spaced apart from the roller, or may include a plurality of rollers or other structures; the roller in the first combining mechanism 31 may be a rotatable structure, a fixed structure, or a floating structure; the roller in the first combining mechanism 31 may also be a driving roller or a driven roller.

With reference to FIGS. 5 to 7, when the first combining mechanism 31 is an edge sealing mechanism, the first image acquisition apparatus 71 can be used to detect the edge sealing state of the first composite plate e.

The first image acquisition apparatus 71 is disposed downstream of the edge sealing mechanism, so that the first composite plate e can be conveyed to the first image acquisition apparatus 71 after edge sealing, and thus the first image acquisition apparatus 71 detects the state of the formed edge sealing. For example, edge sealing defects such as electrode plate folding, wrinkling of the first separator c and the second separator d, edge sealing failure, edge sealing misalignment, edge sealing size and grayscale difference can be detected. For example, the width and position of the edge sealing in the width direction F2 of the first separator c and the second separator d can be detected, so that the first separator c, the second separator d and the edge sealing mechanism can be adjusted according to the detection results. As the width of the formed edge sealing is 0.5-1 mm, and the edge sealing is roughly in the middle of the portion of the first separator c and the second separator d that extends beyond the edge of the second electrode plate b, the reliability of the edge sealing is improved, and the first separator c and the second separator d can reliably limit and protect the second electrode plate b. For example, as shown in FIGS. 6 and 7, the first image acquisition apparatus 71 is disposed on either side of the electrode assembly 200 in the thickness direction F1 to detect information such as the relative position between the second electrode plate b and the first electrode plate a.

The first image acquisition apparatus 71 may be a photoelectric sensor, an X-ray camera, a CCD (charge coupled device) visual sensor, and the types of different image acquisition apparatuses may be the same or different. For example, the first image acquisition apparatus 71 may include a CCD. The CCD can obtain optical images of the material to achieve detection. Furthermore, the CCD can also convert optical images into digital signals so that the optical images can be analyzed, processed and stored. For example, the first image acquisition apparatus 71 may include an X-ray camera, which can penetrate the first separator c and the second separator d to detect the position of the second electrode plate b on the inner layer. The X-ray camera has a high resolution and can penetrate objects for detection, thereby improving detection precision.

Of course, the present application is not limited to this. In other embodiments of the present application, the first combining mechanism 31 is not limited to being an edge sealing mechanism. For example, the first combining mechanism 31 may also be a mechanism for connecting and fixing at least two layers in the first composite plate e, or the first combining mechanism 31 may also be a mechanism for making the layers in the first composite plate e only stacked together without being connected.

With reference to FIGS. 4 and 5, in some embodiments, when the fourth feeding mechanism 22 is arranged upstream of the first combining mechanism 31, the first electrode plate a and the first separator c may be combined first. In some embodiments, the winding device 100 further includes a second combining mechanism 32. The second combining mechanism 32 is located upstream of the first combining mechanism 31 and downstream of the first feeding mechanism 11 and the third feeding mechanism 21 and configured to combine the first electrode plate a and the first separator c into a second composite plate f.

In this way, the first electrode plate a on the first feeding mechanism 11 and the first separator c on the third feeding mechanism 21 can both be conveyed to the second combining mechanism 32 and combined by the second combining mechanism 32. Here, the second combining mechanism 32 is used for combining the first electrode plate a and the first separator c; the combination of the first electrode plate a and the first separator c refers to the first electrode plate a and the first separator c being stacked into the second composite plate f, and the first electrode plate a and the first separator c in the second composite plate f can be only in contact but not connected to each other, or can be both in contact and connected to each other, that is, the first electrode plate a and the first separator c in the second composite plate f are in a connected or non-connected fitting state.

Thus, by means of the second combining mechanism 32 arranged upstream of the first combining mechanism 31, the first electrode plate a and the first separator c can be combined preferentially. The number of material layers combined here is small, and accordingly the combination quality can be better controlled, the relative positions of the first electrode plate a and the first separator c, as well as the respective states of the first electrode plate a and the first separator c can be better guaranteed, thereby improving the product quality.

The type of the second combining mechanism 32 is not limited and can be specifically configured according to whether the first electrode plate a and the first separator c in the second composite plate f need to be connected.

For example, referring to FIG. 4 and FIG. 5, the second combining mechanism 32 is a composite mechanism, and is configured to fixedly connect the first electrode plate a and the first separator c in the second composite plate f. Thus, the offset of the first electrode plate a relative to the first separator c during winding and use can be reduced, which is conducive to improving the accuracy of the relative positions between the materials, thereby improving the product quality. There is no limitation on the method of fixed connection, for example, the connection can be made by cold pressing, hot pressing, gluing, etc. Furthermore, the location of the fixed connection is not limited and may be the entire surface or a part thereof, such as a part in the center or a part at the edge.

For example, referring to FIG. 4, the second combining mechanism 32 may press the first electrode plate a onto the first separator c by pressure, or may adhere the first electrode plate a to the first separator c by gluing or other methods. For example, the second combining mechanism 32 may include two rollers arranged relatively spaced apart, or may include one roller and a support arranged relatively spaced apart from the roller, or may include a plurality of rollers or other structures; the roller in the second combining mechanism 32 may be a rotatable structure, a fixed structure, or a floating structure; the roller in the second combining mechanism 32 may also be a driving roller or a driven roller.

Exemplarily, with reference to FIG. 5, the second combining mechanism 32 can combine the first electrode plate a and the first separator c, that is, the first electrode plate a and the first separator c are connected together, for example, by heating, and pressurizing, thereby reducing the displacement of the first electrode plate a relative to the first separator c during winding and use, which is conducive to improving the accuracy of the relative positions between the materials. For example, the composite mechanism may include two composite rollers arranged opposite to each other, which can heat the first electrode plate a and the first separator c and apply a predetermined pressure along the thickness direction F1 to bond the first electrode plate a and the first separator c together, thereby realizing a composite connection between the first electrode plate a and the first separator c.

Of course, the present application is not limited to this. In other embodiments of the present application, the second combining mechanism 32 is not limited to being a composite mechanism. For example, the second combining mechanism 32 may also be a mechanism for stacking the first electrode plate a and the first separator c in the second composite plate f together without connecting them.

With reference to FIG. 4, in some embodiments, when the winding device 100 includes the second combining mechanism 32, the winding device 100 may further include a second detection apparatus, the second detection apparatus includes a second image acquisition apparatus 72, the second image acquisition apparatus 72 is located between the second combining mechanism 32 and the first combining mechanism 31, and is configured to detect the second composite plate f. The second image acquisition apparatus 72 may be connected in communication with the processor 702 n, or the second detection apparatus may be separately provided with a processor connected in communication with the second image acquisition apparatus 72.

It should be noted that “the second image acquisition apparatus 72 is located between the second combining mechanism 32 and the first combining mechanism 31” does not impose spatial position limitations (i.e., in terms of spatial arrangement, the relative positions of the second image acquisition apparatus 72, the first combining mechanism 31, and the second combining mechanism 32 are not restricted). Rather, it imposes a limitation on the workstation order, meaning that the second composite plate f formed by the second combining mechanism 32 can first undergo detection by the second image acquisition apparatus 72 before entering the first combining mechanism 31.

With reference to FIG. 4, the second image acquisition apparatus 72 is disposed between the second combining mechanism 32 and the first combining mechanism 31 for detecting the second composite plate f. Exemplarily, the second image acquisition apparatus 72 may include a camera, a machine vision detector or other structures. Exemplarily, the second image acquisition apparatus 72 may further include other devices such as a control device. The second image acquisition apparatus 72 may obtain corresponding image information (e.g., position, color and shape) of the second composite plate f, and can convert the image information into a digital signal and send it to the control device, so that the control device can determine whether the second composite plate f meets the requirements according to a preset program.

With reference to FIG. 4, since the second image acquisition apparatus 72 is arranged between the second combining mechanism 32 and the first combining mechanism 31, the second image acquisition apparatus 72 can detect the second composite plate f that is combined by the second combining mechanism 32 and has not enter the first combining mechanism 31, so as to discover defects and abnormalities of the second composite plate f in time to facilitate prompt response to issues arising in the second composite plate f, thereby reducing the negative impact on subsequent processes and improving the product quality.

With reference to FIG. 5, for example, the second image acquisition apparatus 72 is configured to detect the relative position between the first separator c and the first electrode plate a in the second composite plate f. Thus, the second image acquisition apparatus 72 can detect the OH of the first separator c extending beyond the first electrode plate a. “The OH of the first separator c extending beyond the first electrode plate a” refers to the size of the edge of the first separator c extends beyond the edge of the active material area of the first electrode plate a in the width direction of the electrode plate. The OH defect means that the size of the exceeding part does not meet the required size range.

Exemplarily, with reference to FIG. 5, when the second combining mechanism 32 is a composite mechanism, the second image acquisition apparatus 72 is disposed downstream of the second combining mechanism 32 and is capable of detecting the composite state of the second composite plate f. For example, composite defects such as folding and breakage of the first electrode plate a are detected.

For example, as shown in FIGS. 5, 8 and 9, the second image acquisition apparatus 72 is disposed on one side of the second composite plate f in the thickness direction F1 to detect information such as defects of the second composite plate f itself. The second image acquisition apparatus 72 can sequentially detect multiple portions along the length direction of the material during movement of the material, or can continuously detect along the length direction of the material.

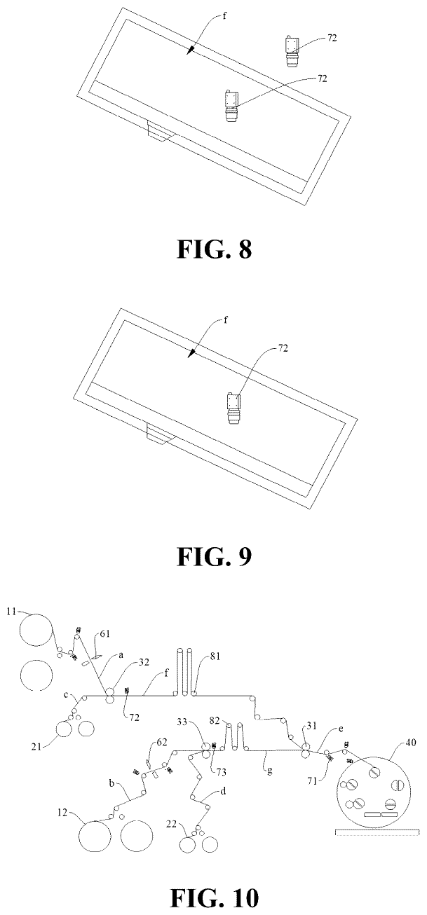

The second image acquisition apparatus 72 may be a photoelectric sensor, an X-ray camera, a CCD (charge coupled device) visual sensor, and the types of different image acquisition apparatuses may be the same or different. For example, the second image acquisition apparatus 72 may include a linear array camera or an area array camera, where the linear array camera has a narrow image acquisition range and high acquisition precision. Therefore, as shown in FIG. 8, the linear array camera can be arranged on either side of the material width direction F2 to improve the detection precision. The area array camera has a wide image acquisition range and low acquisition precision. Therefore, as shown in FIG. 9, the area array camera can be arranged in the middle of the material width direction F2 to reduce costs.

When the first combining mechanism 31 is an edge sealing mechanism and the second combining mechanism 32 is a composite mechanism, the edge sealing state and the composite state are detected respectively by the first image acquisition apparatus 71 and the second image acquisition apparatus 72, so that a more comprehensive detection can be achieved. Here, the second image acquisition apparatus 72 can detect whether the relative position between the first electrode plate a and the first separator c before the edge sealing of the first separator c and the second separator d is accurate, thereby improving the position accuracy of the first separator c and the first electrode plate a. The two sides of the first separator c in the width direction F2 can extend beyond the edge of the first electrode plate a by a sufficient size, thereby providing sufficient space for edge sealing and improving the effect of the first separator c in separating the second electrode plate b and the first electrode plate a. The risk of missed detection during the production of the electrode assembly 200 is reduced. The second electrode plate b and the first electrode plate a in the produced electrode assembly 200 are less prone to overlapping short-circuits, and the second electrode plate b is less prone to overlapping with the housing 3011 of the battery cell 301, thereby avoiding corrosion and electrolyte leakage.

With reference to FIGS. 4 and 5, in some embodiments, when the winding device 100 includes the second combining mechanism 32, the winding device 100 may further include a first temporary storage mechanism 81. The first temporary storage mechanism 81 is disposed between the second combining mechanism 32 and the first combining mechanism 31, and is configured to store the second composite plate f temporarily.

It should be noted that “the first temporary storage mechanism 81 is disposed between the second combining mechanism 32 and the first combining mechanism 31” does not impose spatial position limitations (i.e., in terms of spatial arrangement, the relative positions of the first temporary storage mechanism 81, the first combining mechanism 31, and the second combining mechanism 32 are not restricted). Rather, it imposes a limitation on the workstation order, meaning that the second composite plate f formed by the second combining mechanism 32 can first undergo temporary storage by the first temporary storage mechanism 81 before entering the first combining mechanism 31.

Therefore, the first temporary storage mechanism 81 may play a role in storing the second composite plate f temporarily. When there is a speed difference before and after the first temporary storage mechanism 81, the first temporary storage mechanism 81 can temporarily store and duly release part of the second composite plate f in time, thereby solving the problem of speed reduction or the problem of wrinkles caused by insufficient tension, and improving the production capacity and product quality.

With reference to FIG. 4, the first temporary storage mechanism 81 is arranged between the second combining mechanism 32 and the first combining mechanism 31. The first temporary storage mechanism 81 can store part of the second composite plate f temporarily after the first electrode plate a and the first separator c are combined. The first temporary storage mechanism 81 can store part of the second composite plate f temporarily when the winding needle 42 switches or other tension is reduced, and release the temporarily stored second composite plate f when the tension is normal, so as to reduce the negative impact from switching of the winding needle 42, cutting of the electrode plates or other situations on the feeding of the first feeding mechanism 11 and the third feeding mechanism 21, and reduce the occurrence of slowdown or shutdown of the first feeding mechanism 11 and the third feeding mechanism 21, enabling continuous feeding of the first feeding mechanism 11 and the third feeding mechanism 21 and improving production efficiency.

With reference to FIG. 4, the first temporary storage mechanism 81 is disposed between the second combining mechanism 32 and the first combining mechanism 31, and the first temporary storage mechanism 81 is used for winding the second composite plate f formed from the first electrode plate a and the first separator c. The first temporary storage mechanism 81 refers to a structure in the winding device 100 for temporarily storing electrode plates and separators. The first temporary storage mechanism 81 can also release the temporarily stored electrode plates and separators. The first temporary storage mechanism 81 is disposed between the second combining mechanism 32 and the first combining mechanism 31 for winding the second composite plate f. For example, after the first composite plate e is wound on the winding needle 42, a turret 41 drives the winding needle 42 to move so that the empty winding needle 42 moves to the side of the first combining mechanism 31. During this process, the second composite plate flacks a pulling force provided by the winding needle 42, which is prone to insufficient tension and feed rate. In this case, the first temporary storage mechanism 81 can store part of the second composite plate f temporarily to supplement the tension of the second composite plate f and reduce the occurrence of wrinkles in the second composite plate f.

The first temporary storage mechanism 81 can store the second composite plate f combined by the second combining mechanism 32 by winding, stacking, etc.

With reference to FIG. 4, exemplarily, the first temporary storage mechanism 81 may include one or more rollers, and the second composite plate f can bypass the one or more rollers of the first temporary storage mechanism 81 and then enter the first combining mechanism 31. The first temporary storage mechanism 81 may include one or more movable rollers for the second composite plate f to bypass. In the process of the turret 41 driving the winding needle 42 to move, the first temporary storage mechanism 81 stores the second composite plate f. For example, the rollers move in a direction away from the second combining mechanism 32 and the first combining mechanism 31 to increase the length of the electrode plate and the separator between the second combining mechanism 32 and the first combining mechanism 31, thereby providing tension for the second composite plate f and temporarily storing part of the second composite plate f. After the winding needle 42 is on one side of the first combining mechanism 31 and begins to wind the first composite plate e, the first temporary storage mechanism 81 releases the second composite plate f. For example, the rollers move in a direction close to the second combining mechanism 32 and the first combining mechanism 31, so that the second composite plate f stored in the first temporary storage mechanism 81 can be pulled by the winding needle 42 and wound onto the winding needle 42 after passing through the first combining mechanism 31.

With reference to FIG. 4, exemplarily, the first temporary storage mechanism 81 may include a first fixed roller 811 and a first floating roller 812, where the position of the first fixed roller 811 is fixed relative to the second combining mechanism 32, and the first floating roller 812 can approach or move away from the first fixed roller 811 to change the length of the first electrode plate a and the first separator c wound in the first temporary storage mechanism 81.

With reference to FIG. 4, the first fixed roller 811 refers to the roller body in the first temporary storage mechanism 81 whose position is fixed relative to the second combining mechanism 32, that is, the position of the first fixed roller 811 is also fixed relative to a casing; the first fixed roller 811 may be a cylindrical roller body, or a prismatic roller body or a roller body in other shapes; the material of the first fixed roller 811 may include plastic, metal or other materials; the first fixed roller 811 may be of a rotatable structure or a fixed structure; the first fixed roller 811 may be a driven roller and rotate with the movement of the electrode plate and the separator, and the first fixed roller 811 may also be a driving roller and be driven to rotate by a driving device such as a motor.

With reference to FIG. 4, the first floating roller 812 refers to the roller body in the first temporary storage mechanism 81 that can move relative to the first fixed roller 811, that is, the position of the movable roller can be changed on the casing; the first floating roller 812 may be a cylindrical roller body, or a prismatic roller body or a roller body in other shapes; the material of the first floating roller 812 may include plastic, metal or other materials; the first floating roller 812 may be of a rotatable structure or a fixed structure; the first floating roller 812 may be driven roller and rotate with the movement of the electrode plate and the separator, and the first floating roller 812 may also be a driving roller and be driven to rotate by a driving device such as a motor.

With reference to FIG. 4, the first floating roller 812 can move in a direction close to the first fixed roller 811, and can move in a direction away from the first fixed roller 811. When the first floating roller 812 moves in a direction away from the first fixed roller 811, the first temporary storage mechanism 81 stores the second composite plate f. In this case, the length of the second composite plate f between the second combining mechanism 32 and the first combining mechanism 31 increases, and the movement of the first floating roller 812 can also supplement the missing part of tension on the second composite plate f; when the first floating roller 812 moves in a direction close to the first fixed roller 811, the first temporary storage mechanism 81 releases the second composite plate f.

With reference to FIG. 4, the floating of the first floating roller 812 may be passive floating or active floating. In some embodiments, the floating of the first floating roller 812 is achieved by elastic elements such as springs and rubber strips. In this case, the first floating roller 812 is passive floating; when the winding needle 42 winds the first composite plate e, the tension on the second composite plate f is large and drives the first floating roller 812 to move toward the first fixed roller 811, and the elastic elements are in a deformed state; and in the process of the turret 41 driving the winding needle 42 to move, the tension on the second composite plate f decreases, the elastic elements return to their original state and drive the first floating roller 812 to move away from the first fixed roller 811. In some other embodiments, the floating of the first floating roller 812 is achieved through an active power device such as a pneumatic cylinder or hydraulic cylinder, at which point the first floating roller 812 works as an active floating roller; when the winding needle 42 winds the first composite plate e, the tension on the second composite plate f is relatively large, the power device drives the first floating roller 812 to move toward the first fixed roller 811; and in the process of the turret 41 driving the winding needle 42 to move, the tension on the second composite plate f decreases, the power device then drives the first floating roller 812 to move away from the first fixed roller 811.

With reference to FIG. 4, the number of first fixed rollers 811 may be one, or two or more; the number of floating rollers may be one, or two or more; when the number of first fixed rollers 811 and first floating rollers 812 are both two or more, the first fixed rollers 811 and the first floating rollers 812 may be alternately arranged in sequence.

With reference to FIG. 4, the first floating roller 812 achieves temporary storage and release of the second composite plate f. For example, when the second composite plate f needs to be temporary stored, the first floating roller 812 can move in a direction away from the first fixed roller 811 to increase the length of the second composite plate f in the first temporary storage mechanism 81. When the second composite plate f needs to be released, the first floating roller 812 can move in a direction close to the first fixed roller 811 to reduce the length of the second composite plate f in the first temporary storage mechanism 81.

With reference to FIG. 4, exemplarily, the first electrode plate a is a negative electrode plate, and the first temporary storage mechanism 81 is used for temporary storage of the negative electrode plate and the first separator c combined by the second combining mechanism 32. Affected by the materials, the negative electrode plate and the first separator c can be combined more stably after compositing, so that the negative electrode plate and the first separator c are not easily separated in the process of passing through the first temporary storage mechanism 81.

With reference to FIGS. 4 and 5, in some embodiments, when the winding device 100 includes the first temporary storage mechanism 81, the first cutting mechanism 61 for cutting the first electrode plate a may be disposed between the first feeding mechanism 11 and the second combining mechanism 32.

It should be noted that “the first cutting mechanism 61 is disposed between the first feeding mechanism 11 and the second combining mechanism 32” does not impose spatial position limitations (i.e., in terms of spatial arrangement, the relative positions of the first cutting mechanism 61, the first feeding mechanism 11, and the second combining mechanism 32 are not restricted). Rather, it imposes a limitation on the workstation order, meaning that the first electrode plate a output from the first feeding mechanism 11 may be cut off by the first cutting mechanism 61 before entering the second combining mechanism 32.

Exemplarily, with reference to FIG. 5, the first cutting mechanism 61 may cut off the first electrode plate a and then feed the sections to the second combining mechanism 32, or feed the sections of the first electrode plate a to the second combining mechanism 32 by insertion. For example, the first cutting mechanism 61 may include components such as a feeding roller and a cutter.

During production, the first temporary storage mechanism 81 stores the material temporarily and can continuously transfer the material downstream, so that the winding needle 42 can work without slowdown and will not be affected by the operation of the first cutting mechanism 61 upstream of the first temporary storage mechanism 81. For example, as shown in FIG. 5, the first cutting mechanism 61 has high precision requirements for cutting the first electrode plate a, resulting in a slow operating speed. The first temporary storage mechanism 81 is used for temporary storage of the second composite plate f after the first electrode plate a and the first separator c are combined, and the winding needle 42 runs at a high speed. Through temporary storage of the first temporary storage mechanism 81, the first temporary storage mechanism 81 can still convey the second composite plate f to the first combining mechanism 31 in the process of the first cutting mechanism 61 cutting the first electrode plate a, without reducing the speed of the winding needle 42, thereby improving the winding efficiency and improving the overall production capacity. Moreover, the first cutting mechanism 61 may be arranged spatially away from the winding mechanism 40 to overcome the adverse effect on the quality of the electrode assembly 200 caused by chips formed by cutting falling into the electrode assembly 200 wound on the winding needle 42, thereby facilitating further improvement of the quality of the electrode assembly 200.

When the winding device 100 includes the first temporary storage mechanism 81, the second image acquisition apparatus 72 may be arranged upstream of the first temporary storage mechanism 81 (for example, the embodiment shown in FIG. 4), and the second image acquisition apparatus 72 may also be arranged downstream of the first temporary storage mechanism 81 (for example, the embodiment shown in FIG. 5). As shown in FIG. 5, when the second image acquisition apparatus 72 is disposed downstream of the first temporary storage mechanism 81, the second image acquisition apparatus 72 can detect the second composite plate f released by the first temporary storage mechanism 81. Thus, defects of the second composite plate f generated during the combining process and the temporary storage process can be detected by the second image acquisition apparatus 72, which is conducive to improving the quality of the composite plate for use in producing the electrode assembly 200.

For example, with reference to FIG. 5, when the fourth feeding mechanism 22 is arranged upstream of the first combining mechanism 31 such that the second separator d is also combined in the first composite plate e, the third cutting mechanism 63 may be disposed between the first combining mechanism 31 and the winding mechanism 40. The first cutting mechanism 61 and the second cutting mechanism 62 can cut off the first electrode plate a and the second electrode plate b before the electrode plates enter the first combining mechanism 31, and the third cutting mechanism 63 cuts off the first separator c and the second separator d after the first combining mechanism 31. Accordingly, it is relatively easy to make the length of the separator greater than the length of the electrode plate, thereby meeting the design requirements of the electrode assembly 200. Besides, only one third cutting mechanism 63 needs to be provided, which can simplify the device, reduce costs, and save space.

In addition, in the case of the first temporary storage mechanism 81 is provided, during production, the first temporary storage mechanism 81 stores the material temporarily and can continuously transfer the material downstream, so that the third cutting mechanism 63 can perform cutting without slowdown and will not be affected by the operation of the first cutting mechanism 61 upstream of the first temporary storage mechanism 81. For example, as shown in FIG. 5, the first cutting mechanism 61 has high precision requirements for cutting the first electrode plate a, resulting in a slow operating speed. The first temporary storage mechanism 81 is used for temporary storage of the second composite plate f combined by the first electrode plate a and the first separator c, and the third cutting mechanism 63 is used to cut off the first separator c and the second separator d, where the precision requirement is low and the operating speed is high. Through temporary storage of the first temporary storage mechanism 81, in the process of the first cutting mechanism 61 cutting the first electrode plate a, the first temporary storage mechanism 81 can still convey the second composite plate f to the first combining mechanism 31 without reducing the speed of the first combining mechanism 31, and the third cutting mechanism 63 can cut off the tape-shaped electrode assembly 200 without slowdown, thereby improving the winding efficiency and improving the overall production capacity.

The third cutting mechanism 63 may include a variety of cutting structures, such as a linear cutter that reciprocates along a straight line, a cam cutter that rotates around an axis, and a laser cutting structure.

With reference to FIG. 4, exemplarily, the first cutting mechanism 61 is disposed between the first feeding mechanism 11 and the second combining mechanism 32, and includes a first cutter 611 and a first abutting member 612. The first cutter 611 and the first abutting member 612 are arranged opposite to each other and spaced apart to allow the first electrode plate a to pass through. The first cutter 611 is used to cut off the first electrode plate a on the first abutting member 612.

With reference to FIG. 4, the first cutter 611 and the first abutting member 612 are both part of the electrode cutting assembly 61. The first cutter 611 and the first abutting member 612 are disposed between the first feeding mechanism 11 and the second combining mechanism 32 to cut off the first electrode plate a.

With reference to FIG. 4, the first cutter 611 refers to a structure in the winding device 100 for cutting the electrode plate. Based on the shape of the first cutter 611, the first cutter 611 may be a grooving knife, a cutting knife or other types of cutters. Based on the driving force of the first cutter 611, the first cutter 611 can realize the cutting action through a motor in conjunction with a cam and a rocker arm, and the first cutter 611 may also be driven by a cylinder, a hydraulic cylinder and other devices to realize the reciprocating cutting action. In some embodiments, the first electrode plate a is a negative electrode plate. Because the material of the negative electrode plate usually includes lithium iron phosphate, lithium cobalt oxide or silicon-based materials, vanadate materials, etc., the cut is easy to be rough or has burrs when cutting, so the first cutter 611 is driven by the cylinder to reduce the roughness of the cut and reduce burrs.

With reference to FIG. 4, the first abutting member 612 refers to a structure in the winding device 100 that supports the first cutter 611. The first electrode plate a can pass through the first abutting member 612, and when the first cutter 611 cuts the first electrode plate a, it can press the first electrode plate a onto the first abutting member 612 and cut it off. The material of the first abutting member 612 may include plastic, metal or other materials.

With reference to FIG. 4, the first abutting member 612 may be a rectangular thin-plate structure, a cylindrical structure or other structures; the first abutting member 612 may be a fixed structure or a rotatable structure to reduce a friction force between the first electrode plate a and the first abutting member 612.

With reference to FIG. 4, the first cutter 611 and the first abutting member 612 are arranged opposite to each other, and the first electrode plate a can pass through a gap between the first cutter 611 and the first abutting member 612. When the first cutter 611 is lifted, a distance between the first cutter 611 and the first abutting member 612 needs to be greater than the thickness of the first electrode plate a so as to reduce the negative impact of the first cutter 611 on the first electrode plate a.

With reference to FIG. 4, the first electrode plate a cut by the first cutter 611 and the first abutting member 612 is combined with the first separator c by means of the second combining mechanism 32. In this case, the first separator c can carry the cut first electrode plate a through the first temporary storage mechanism 81 to move to the first combining mechanism 31.

With reference to FIG. 4, the first cutter 611 and the first abutting member 612 are disposed between the first feeding mechanism 11 and the second combining mechanism 32, and the first abutting member 612 supports the first electrode plate a and provides support for the first cutter 611 to cut the first electrode plate a, and the electrode plate a is cut by the first cutter 611 for cutting the electrode plate.

With reference to FIGS. 4 and 5, in some embodiments, when the winding device 100 includes the second combining mechanism 32, the second electrode plate b and the second separator d can be set to be fed separately into the first combining mechanism 31, that is, the second electrode plate b and the second separator d are not combined before entering the first combining mechanism 31. In this way, the structure can be simplified.

For example, with reference to FIGS. 4 and 5, when the second electrode plate b and the second separator d are fed into the first combining mechanism 31 separately, the second cutting mechanism 62 for cutting off the second electrode plate b may be disposed between the second feeding mechanism 12 and the first combining mechanism 31.

It should be noted that “the second cutting mechanism 62 is disposed between the second feeding mechanism 12 and the first combining mechanism 31” does not impose spatial position limitations (i.e., in terms of spatial arrangement, the relative positions of the second cutting mechanism 62, the second feeding mechanism 12, and the first combining mechanism 31 are not restricted). Rather, it imposes a limitation on the workstation order, meaning that the second electrode plate b output from the second feeding mechanism 12 may be cut off by the second cutting mechanism 62 before entering the first combining mechanism 31.

Therefore, the second cutting mechanism 62 may be arranged spatially away from the winding mechanism 40 to overcome the adverse effect on the quality of the electrode assembly 200 caused by chips formed by cutting falling into the electrode assembly 200 wound on the winding needle 42, thereby facilitating further improvement of the quality of the electrode assembly 200.

With reference to FIGS. 4, in some embodiments, the second cutting mechanism 62 includes a cam cutter. Therefore, the second cutting mechanism 62 does not need to track the second electrode plate b, and the second electrode plate b does not need to slow down in response to the cutting, so the second cutting mechanism 62 can cut the second electrode plate b without slowing down, which can improve production capacity. Because the space requirement for tracking is eliminated, it is conducive to reducing space occupancy.

With reference to FIG. 4, exemplarily, the second cutting mechanism 62 includes a first cam cutter 621 and a second abutting member 622, which are arranged opposite to and spaced apart from each other to allow the second electrode plate b to pass through, and the first cam cutter 621 can rotate and cut off the second electrode plate b on the second abutting member 622.

With reference to FIG. 4, the first cam cutter 621 and the second abutting member 622 are both part of the first cutting mechanism 61, and the first cam cutter 621 and the second abutting member 622 are used for cutting the second electrode plate b.

With reference to FIG. 4, the first cam cutter 621 can act intermittently and cut off the second electrode plate b. The length of the cut second electrode plate b can be adjusted by adjusting the time between two adjacent cuts by the first cam cutter 621. The cam cutter has the advantages of higher efficiency, higher precision, more precise intermittent indexing, and more stable rotation, and can more accurately achieve periodic intermittent cutting of the second electrode plate b.

With reference to FIG. 4, the periodic intermittent cutting of the first cam cutter 621 can be achieved through a variety of structures. For example, the first cam cutter 621 may include a driving device, a cam, a rocker arm and a cutter, and the driving device drives the cam to rotate and drives the rocker arm to reciprocate, so that the cutter intermittently cuts the second electrode plate b. In this case, the intermittent time of the cutter=the desired length of the second electrode plate b/the linear velocity of the cam. For another example, the first cam cutter 621 may also include a driving device, a crank-slider mechanism and a cutter, and the driving device drives the crank-slider mechanism to move, thereby driving the cutter to reciprocate through the crank-slider mechanism. In this case, the intermittent time of the cutter=the desired length of the second electrode plate b/the linear velocity output by the driving device. It can be understood that the periodic intermittent cutting action of the first cam cutter 621 may also be achieved through other structures, which is not limited to the above two types.

With reference to FIG. 4, the second abutting member 622 refers to a structure in the winding device 100 that supports the first cam cutter 621. The second electrode plate b can pass through the second abutment member 622. When the first cam cutter 621 cuts the second electrode plate b, it presses the second electrode plate b against the second abutting member 622 and cuts it off. The material of the second abutting member 622 may include plastic, metal, or other materials.

With reference to FIG. 4, the second abutting member 622 may be a rectangular thin-plate structure, a cylindrical structure, or other structures; the second abutting member 622 may be a fixed structure or a rotatable structure to reduce a friction force between the second electrode plate b and the second abutting member 622. In some embodiments, the second abutting member 622 is a roller structure rotatably connected to the casing. When the first cam cutter 621 cuts the second electrode plate b, it can press the second electrode plate b against the roller structure and cuts it off.

With reference to FIG. 4, the first cam cutter 621 and the second abutting member 622 are spaced apart, and the second electrode plate b can pass through a gap between the first cam cutter 621 and the second abutting member 622. When the first cam cutter 621 is lifted, a distance between the first cam cutter 621 and the second stopper 622 needs to be greater than the thickness of the second electrode plate b so as to reduce the negative impact of the first cam cutter 621 on the first electrode plate a.

With reference to FIG. 4, this embodiment provides some specific structures of the first cutting mechanism 61, and the first cam cutter 621 and the second abutting member 622 are disposed between the second feeding mechanism 12 and the first combining mechanism 31. The second abutting member 622 supports the second electrode plate b and provides support for the first cam cutter 621 to cut the second electrode plate b, and the electrode plate a is cut off by the first cam cutter 621 for cutting the electrode plate. The intermittent indexing action of the cam cutter structure has high precision and does not need other structures to control its intermittent position, which is conducive to control and can also simplify the structure of the cutter.

With reference to FIG. 4, exemplarily, the third cutting mechanism 63 may include a second cam cutter 631 and a third abutting member 632 that are spaced apart from each other. The second cam cutter 631 is capable of rotating and cutting off the separator on the third abutting member 632. The second cam cutter 631 refers to a mechanism in the third cutting mechanism 63 for cutting the separator; the second cam cutter 631 can act intermittently and cut the separator, and the length of the cut separator can be adjusted by adjusting the time between two adjacent cuts by the second cam cutter 631. The cam cutter has the advantages of high efficiency, high precision, more precise intermittent indexing, and more stable rotation, and can more accurately achieve periodic intermittent cutting of the separator.

With reference to FIG. 4, the periodic intermittent cutting of the second cam cutter 631 can be achieved through a variety of structures. For example, the second cam cutter 631 may include a driving device, a cam, a rocker arm and a cutter, and the driving device drives the cam to rotate and drives the rocker arm to reciprocate, so that the cutter intermittently cuts the separator. In this case, the intermittent time of the cutter=the desired length of the separator/the linear velocity of the cam. For another example, the second cam cutter 631 may also include a driving device, a crank-slider mechanism and a cutter, and the driving device drives the crank-slider mechanism to move, thereby driving the cutter to reciprocate through the crank-slider mechanism. In this case, the intermittent time of the cutter=the desired length of the separator/the linear velocity output by the driving device. It can be understood that the periodic intermittent cutting action of the second cam cutter 631 may also be achieved through other structures, which is not limited to the above two types.

With reference to FIG. 4, the third abutting member 632 refers to a structure in the third cutting mechanism 63 that supports the second cam cutter 631. The separator can pass through the third abutting member 632. When the second cam cutter 631 cuts the separator, it presses the separator against the third abutting member 632 during the cutting process. The material of the third abutting member 632 may include plastic, metal, or other materials.

With reference to FIG. 4, the third abutting member 632 may be a rectangular thin-plate structure, a cylindrical structure, or other structures; the third abutting member 632 may be a fixed structure or a rotatable structure to reduce a friction force between the separator and the third abutting member 632. In some embodiments, the third abutting member 632 is a roller structure rotatably connected to the casing. When the second cam cutter 631 cuts the separator, it can press the separator against the roller structure and cuts it off.

With reference to FIG. 4, this embodiment provides some specific structures of the third cutting mechanism 63, and the separator is cut off by the second cam cutter 631 and the third abutting member 632. The second cam cutter 631 can perform the cutting action periodically and intermittently. By controlling the intermittent duration of the second cam cutter 631, the length of the separator can be controlled. The intermittent indexing action of the cam cutter has high precision and does not need other structures to control its position during the intermittent period. It is easy to control and can also simplify the structure of the cutter.

In some embodiments, the rotation cycle length of the second cam cutter 631 is equal to a ratio of the length of the first separator c in the electrode assembly 200 to the conveying linear velocity of the first separator c; and/or, the rotation cycle length of the second cam cutter 631 is equal to a ratio of the length of the second separator d in the electrode assembly 200 to the conveying linear velocity of the second separator d.

The rotation cycle length of the second cam cutter 631 is the time taken for the second cam cutter 631 to rotate one circle. The membrane to be cut may be the first separator c and/or the second separator d. By cutting the first separator c and/or the second separator d, it is possible to form the first separator c and/or the second separator d of a predetermined length in the electrode assembly 200. The conveying linear velocity of the separator to be cut refers to the conveying linear velocity of the separator to be cut before it enters the winding mechanism 40.

The first separator c and the second separator d are conveyed toward the winding mechanism 40 at the same time and have the same conveying linear velocity. The lengths of the first separator c and the second separator d in the electrode assembly 200 can be equal or different. For example, the length of the first separator c in the electrode assembly 200 is greater than the length of the second separator d. Then, the rotation cycle length of the second cam cutter 631 is equal to the ratio of the length of the first separator c in the electrode assembly 200 to the conveying linear velocity of the first separator c.

As the above conditions are met, the second cam cutter 631 can rotate continuously. Since the second cam cutter 631 does not need to stop, the time waiting for cutting is saved; the second cam cutter 631 can cut the film to be cut every time it rotates one circle. There is no need to reduce the conveying linear velocity of the film in order to cut the film, and the film can be cut without slowdown, which effectively improves the overall winding speed.

In other embodiments, if the second cam cutter 631 needs to move toward the third abutting member 632 after rotating, the rotation cycle length of the second cam cutter 631 may also be less than the ratio of the length of the film to be cut to the conveying linear velocity of the film to be cut.

In the embodiments of the present application, the second electrode plate b and the second separator d may not be fed into the first combining mechanism 31 separately. For example, with reference to FIG. 10, in some embodiments, the winding device 100 further includes a third combining mechanism 33 located upstream of the first combining mechanism 31 and downstream of the second feeding mechanism 12 and the fourth feeding mechanism 22 and configured to combine the second electrode plate b and the second separator d into a third composite plate g.

In this case, the second electrode plate b and the second separator d may be combined by the third combining mechanism 33 before entering the first combining mechanism 31. That is, the second electrode plate b on the second feeding mechanism 12 and the second separator d on the fourth feeding mechanism 22 can both be conveyed to the third combining mechanism 33 and combined by the third combining mechanism 33. The third combining mechanism 33 is used to combine the second electrode plate b and the second separator d; the combination of the second electrode plate b and the second separator d refers to the second electrode plate b and the second separator d being stacked into a third composite plate g, and the second electrode plate b and the second separator d in the third composite plate g can be only in contact but not connected to each other, or can be both in contact and connected to each other, that is, the second electrode plate b and the second separator d in the third composite plate g are in a connected or non-connected fitting state.

Therefore, by means of the third combining mechanism 33 arranged upstream of the first combining mechanism 31, the second electrode plate b and the second separator d can be combined preferentially. The number of material layers combined here is small, and accordingly the combination quality can be better controlled, the relative positions of the second electrode plate b and the second separator d, as well as the respective states of the second electrode plate b and the second separator d can be better guaranteed, thereby improving the product quality.

With reference to FIG. 10, the type of the third combining mechanism 33 is not limited and can be specifically configured according to whether the second electrode plate b and the second separator d in the third composite plate g need to be connected. For example, the third combining mechanism 33 may be formed as a composite mechanism that is the same as or similar to the second combining mechanism 32. When the third composite mechanism 33 functions as a composite structure, it can be used to fixedly connect the second electrode plate b and the second separator d in the third composite plate g. Thus, the offset of the second electrode plate b relative to the second separator d during winding and use can be reduced, which is conducive to improving the accuracy of the relative positions between the materials, thereby improving the product quality. There is no limitation on the method of fixed connection, for example, the connection can be made by cold pressing, hot pressing, gluing, etc. Furthermore, the location of the fixed connection is not limited and may be the entire surface or a part thereof, such as a part in the center or a part at the edge.

Of course, the present application is not limited to this. In other embodiments of the present application, the third combining mechanism 33 is not limited to being a composite mechanism. For example, the third combining mechanism 33 may also be a mechanism for stacking the second electrode plate b and the second separator d in the third composite plate g together without connecting them.

With reference to FIG. 10, in some embodiments, when the winding device 100 includes the third combining mechanism 33, the winding device 100 may further include a third detection apparatus, the third detection apparatus includes a third image acquisition apparatus 73, the third image acquisition apparatus 73 is located between the third combining mechanism 33 and the first combining mechanism 31, and is configured to detect the third composite plate g. The third image acquisition apparatus 73 may be connected in communication with the processor 702 n, or the third detection apparatus may be separately provided with a processor connected in communication with the third image acquisition apparatus 73.

It should be noted that “the third image acquisition apparatus 73 is located between the third combining mechanism 33 and the first combining mechanism 31” does not impose spatial position limitations (i.e., in terms of spatial arrangement, the relative positions of the third image acquisition apparatus 73, the third combining mechanism 33, and the first combining mechanism 31 are not restricted). Rather, it imposes a limitation on the workstation order, meaning that the third composite plate g formed by the third combining mechanism 33 can first undergo detection by the third image acquisition apparatus 73 before entering the first combining mechanism 31.

With reference to FIG. 10, the third image acquisition apparatus 73 is disposed between the third combining mechanism 33 and the first combining mechanism 31 for detecting the third composite plate g. Exemplarily, the third image acquisition apparatus 73 may include a camera, a machine vision detector or other structures. Exemplarily, the third image acquisition apparatus 73 may further include other devices such as a control device. The third image acquisition apparatus 73 may obtain corresponding image information (e.g., position, color and shape) of the third composite plate g, and can convert the image information into a digital signal and send it to the control device, so that the control device can determine whether the third composite plate g meets the requirements according to a preset program.

With reference to FIG. 10, since the third image acquisition apparatus 73 is arranged between the third combining mechanism 33 and the first combining mechanism 31, the third image acquisition apparatus 73 can detect the third composite plate g that is combined by the third combining mechanism 33 and has not enter the first combining mechanism 31, so as to discover defects and abnormalities of the third composite plate g in time to facilitate prompt response to issues arising in the third composite plate g, thereby reducing the negative impact on subsequent processes and improving the product quality.

With reference to FIG. 10, for example, the third image acquisition apparatus 73 is configured to detect the relative position between the second electrode plate b and the second separator d in the third composite plate g. Thus, the third image acquisition apparatus 73 can detect the OH of the second separator d extending beyond the second electrode plate b. “The OH of the second separator d extending beyond the second electrode plate b” refers to the size of the edge of the second separator d extending beyond the edge of the active material area of the second electrode plate b in the width direction of the electrode plate. The OH defect refers to that the size of the exceeding part does not meet the required size range.

With reference to FIG. 10, when the third combining mechanism 33 is a composite mechanism, the third image acquisition apparatus 73 is disposed downstream of the third combining mechanism 33 and is capable of detecting the composite state of the third composite plate g. For example, composite defects such as folding and breakage of the second electrode plate ab are detected.

For example, the third image acquisition apparatus 73 is disposed on one side of the third composite plate g in the thickness direction F1 to detect information such as defects of the third composite plate g itself. The third image acquisition apparatus 73 can sequentially detect multiple portions along the length direction of the material during movement of the material, or can continuously detect along the length direction of the material.

For example, the third image acquisition apparatus 73 may be a photoelectric sensor, an X-ray camera, a CCD (charge coupled device) visual sensor, and the types of different image acquisition apparatuses may be the same or different. For example, the third image acquisition apparatus 73 may include a linear array camera or an area array camera, where the linear array camera has a narrow image acquisition range and high acquisition precision. Therefore, the linear array camera can be arranged on either side of the material width direction F2 to improve the detection precision. The area array camera has a wide image acquisition range and low acquisition precision. Therefore, the area array camera can be arranged in the middle of the material width direction F2 to reduce costs.

When the first combining mechanism 31 is an edge sealing mechanism and the third combining mechanism 33 is a composite mechanism, the edge sealing state and the composite state are detected respectively by the first image acquisition apparatus 71 and the third image acquisition apparatus 73, so that a more comprehensive detection can be achieved. Here, the third image acquisition apparatus 73 can detect whether the relative position between the second electrode plate b and the second separator d before the edge sealing of the first separator c and the second separator d is accurate, thereby improving the position accuracy of the second separator d and the second electrode plate b. The two sides of the second separator d in the width direction F2 can extend beyond the edge of the second electrode plate b by a sufficient size, thereby providing sufficient space for edge sealing and improving the effect of the first separator c in separating the second electrode plate b and the first electrode plate a. The risk of missed detection during the production of the electrode assembly 200 is reduced. The second electrode plate b and the first electrode plate a in the produced electrode assembly 200 are less prone to overlapping short-circuits, and the second electrode plate b is less prone to overlapping with the housing 3011 of the battery cell 301, thereby avoiding corrosion and electrolyte leakage.

With reference to FIG. 10, when the winding device 100 includes the third combining mechanism 33, in some embodiments, the winding device 100 may further include a second temporary storage mechanism 82. The second temporary storage mechanism 82 is disposed between the third combining mechanism 33 and the first combining mechanism 31, and is configured to store the third composite plate g temporarily.

It should be noted that “the second temporary storage mechanism 82 is disposed between the third combining mechanism 33 and the first combining mechanism 31” does not impose spatial position limitations (i.e., in terms of spatial arrangement, the relative positions of the second temporary storage mechanism 82, the first combining mechanism 31, and the second combining mechanism 33 are not restricted). Rather, it imposes a limitation on the workstation order, meaning that the third composite plate g formed by the third combining mechanism 33 can first undergo temporary storage by the second temporary storage mechanism 82 before entering the first combining mechanism 31.

Therefore, the second temporary storage mechanism 82 may play a role in storing the third composite plate g temporarily. When there is a speed difference before and after the second temporary storage mechanism 82, the second temporary storage mechanism 82 can temporarily store and duly release part of the third composite plate g in time, thereby solving the problem of speed reduction or the problem of wrinkles caused by insufficient tension, and improving the production capacity and product quality.

With reference to FIG. 10, the second temporary storage mechanism 82 is arranged between the third combining mechanism 33 and the first combining mechanism 31. The second temporary storage mechanism 82 can store part of the third composite plate g temporarily after the second electrode plate b and the second separator d are combined. The second temporary storage mechanism 82 can store part of the third composite plate g temporarily when the winding needle 42 switches or other tension is reduced, and release the temporarily stored third composite plate g when the tension is normal, so as to reduce the negative impact from switching of the winding needle 42, cutting of the electrode plates or other situations on the feeding of the second feeding mechanism 12 and the fourth feeding mechanism 22, and reduce the occurrence of slowdown or shutdown of the second feeding mechanism 12 and the fourth feeding mechanism 22, enabling continuous feeding of the second feeding mechanism 12 and the fourth feeding mechanism 22 and improving production efficiency.

With reference to FIG. 10, the second temporary storage mechanism 82 is disposed between the third combining mechanism 33 and the first combining mechanism 31, and the second temporary storage mechanism 82 is used for winding the third composite plate g formed from the second electrode plate b and the second separator d. The second temporary storage mechanism 82 refers to a structure in the winding device 100 for temporarily storing electrode plates and separators. The second temporary storage mechanism 82 can also release the temporarily stored electrode plates and separators. The second temporary storage mechanism 82 is disposed between the third combining mechanism 33 and the first combining mechanism 31 for winding the third composite plate g. For example, after the first composite plate e is wound on the winding needle 42, a turret 41 drives the winding needle 42 to move so that the empty winding needle 42 moves to the side of the first combining mechanism 31. During this process, the third composite plate g lacks a pulling force provided by the winding needle 42, which is prone to insufficient tension and feed rate. In this case, the second temporary storage mechanism 82 can store part of the third composite plate g temporarily to supplement the tension of the third composite plate g and reduce the occurrence of wrinkles in the third composite plate g.

The second temporary storage mechanism 82 can store the third composite plate g combined by the third combining mechanism 33 by winding, stacking, etc. For example, the structure of the second temporary storage mechanism 82 may be the same as or similar to that of the first temporary storage mechanism 81, and will not be described in detail here.

With reference to FIG. 10, in some embodiments, when the winding device 100 includes the second temporary storage mechanism 82, the second cutting mechanism 62 for cutting the second electrode plate b may be disposed between the second feeding mechanism 12 and the third combining mechanism 33.

It should be noted that “the second cutting mechanism 62 is disposed between the second feeding mechanism 12 and the first combining mechanism 33” does not impose spatial position limitations (i.e., in terms of spatial arrangement, the relative positions of the second cutting mechanism 62, the second feeding mechanism 12, and the first combining mechanism 33 are not restricted). Rather, it imposes a limitation on the workstation order, meaning that the second electrode plate b output from the second feeding mechanism 12 may be cut off by the second cutting mechanism 62 before entering the first combining mechanism 33.

Exemplarily, with reference to FIG. 10, the second cutting mechanism 62 may cut off the second electrode plate b and then feed the sections to the third combining mechanism 33, or feed the sections of the second electrode plate b to the third combining mechanism 33 by insertion. For example, the second cutting mechanism 62 may include components such as a feeding roller and a cutter.

During production, the second temporary storage mechanism 82 stores the material temporarily and can continuously transfer the material downstream, so that the winding needle 42 can work without slowdown and will not be affected by the operation of the second cutting mechanism 62 upstream of the second temporary storage mechanism 82. For example, as shown in FIG. 10, the second cutting mechanism 62 has high precision requirements for cutting the second electrode plate b, resulting in a slow operating speed. The second temporary storage mechanism 82 is used for temporary storage of the third composite plate g after the second electrode plate b and the second separator d are combined, and the winding needle 42 runs at a high speed. Through temporary storage of the second temporary storage mechanism 82, the second temporary storage mechanism 82 can still convey the third composite plate g to the third combining mechanism 33 in the process of the second cutting mechanism 62 cutting the second electrode plate b, without reducing the speed of the winding needle 42, thereby improving the winding efficiency and improving the overall production capacity. Furthermore, the second cutting mechanism 62 may be arranged spatially away from the winding mechanism 40 to overcome the adverse effect on the quality of the electrode assembly 200 caused by chips formed by cutting falling into the electrode assembly 200 wound on the winding needle 42, thereby facilitating further improvement of the quality of the electrode assembly 200.

When the winding device 100 includes the second temporary storage mechanism 82, the third image acquisition apparatus 73 may be arranged upstream of the second temporary storage mechanism 82 (for example, the embodiment shown in FIG. 10), and the third image acquisition apparatus 73 may also be arranged downstream of the second temporary storage mechanism 82. When the third image acquisition apparatus 73 is disposed downstream of the second temporary storage mechanism 82, the third image acquisition apparatus 73 can detect the third composite plate g released by the second temporary storage mechanism 82. Thus, defects of the third composite plate g generated during the combining process and the temporary storage process can be detected by the third image acquisition apparatus 73, which is conducive to improving the quality of the composite plate for use in producing the electrode assembly 200.

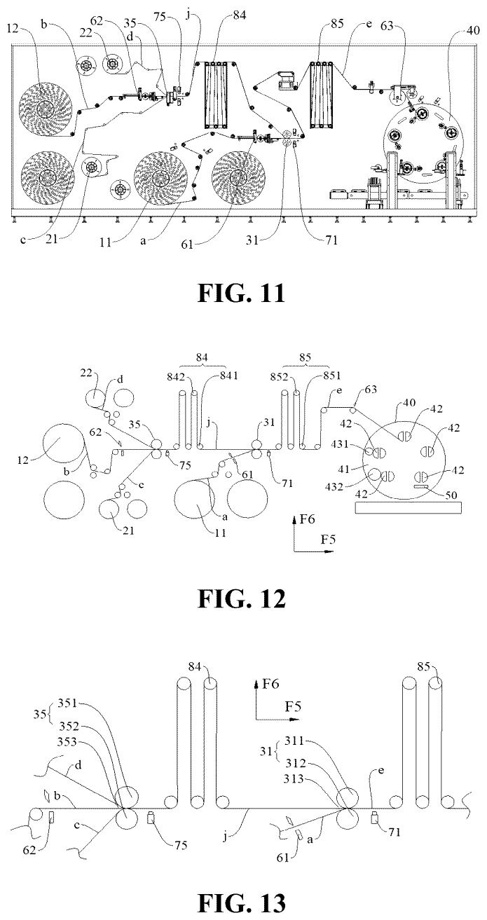

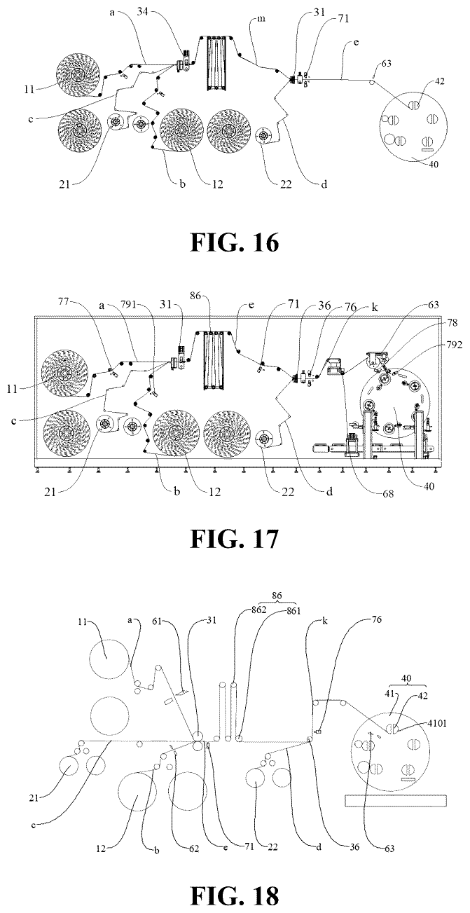

When the fourth feeding mechanism 22 is arranged upstream of the first combining mechanism 31, it is also possible to skip the combination of an electrode plate and a separator. For example, the first separator c, the second electrode plate b and the second separator d may be combined first (e.g., see FIGS. 11 to 15); or the first electrode plate a, the first separator c and the second electrode plate b may be combined first (e.g., see FIG. 16).

With reference to FIGS. 11 to 15, in some embodiments, when the fourth feeding mechanism 22 is arranged upstream of the first combining mechanism 31, the winding device 100 may further include a fifth combining mechanism 35 located upstream of the first combining mechanism 31 and downstream of the third feeding mechanism 21, the second feeding mechanism 12, and the fourth feeding mechanism 22 and configured to combine the first separator c, the second electrode plate b, and the second separator d into a fifth composite plate j.

In the fifth composite plate j, the second electrode plate b is stacked between the first separator c and the second separator d, but the connection state of the first separator c, the second electrode plate b and the second separator d is not limited. For example, the second electrode plate b and the second separator d in the fifth composite plate j may be in contact but not connected to each other, or may be in contact and connected to each other, that is, the second electrode plate b and the second separator d in the fifth composite plate j may be in a connected or non-connected fitting state. The second electrode plate b and the first separator c in the fifth composite plate j may be in contact but not connected to each other, or may be in contact and connected to each other, that is, the second electrode plate b and the first separator c in the fifth composite plate j may be in a connected or non-connected fitting state. The edge of the second separator d and the edge of the first separator c in the fifth composite plate j may be in contact but not connected to each other, or may be in contact and connected by edge sealing.

With reference to FIGS. 11 and 12, the second electrode plate b can be pulled from the second feeding mechanism 12 to the fifth combining mechanism 35, the second separator d can be pulled from the fourth feeding mechanism 22 to the fifth combining mechanism 35, the first separator c can be pulled from the third feeding mechanism 21 to the fifth combining mechanism 35, and the first electrode plate a can be pulled from the first feeding mechanism 11 to the first combining mechanism 31. The fifth combining mechanism 35 is used to stack and combine the second separator d, the second electrode plate b, and the first separator c in sequence to form a fifth composite plate j. The first combining mechanism 31 is used to stack and combine the first electrode plate a and the fifth composite plate j to form a first composite plate e. The first composite plate e is pulled from the first combining mechanism 31 to the winding mechanism 40 and is wound by the winding mechanism 40 to form an electrode assembly 20.

Thus, by means of the fifth combining mechanism 35 and the first combining mechanism 31, the second separator d, the second electrode plate b, the first separator c and the first electrode plate a are formed into the first composite plate e through two steps in succession. In this way, the operation of forming the first composite plate e from the second separator d, the second electrode plate b, the first separator c and the first electrode plate a can be more strictly controlled, which helps to improve the quality of the first composite plate e and further helps to improve the quality of the electrode assembly 200. According to the above technical solution, the fifth composite plate j including the second electrode plate b can be formed by the fifth combining mechanism 35 first, and then the first composite plate e including the first electrode plate a can be formed by the first combining mechanism 31. The second electrode plate b and the first electrode plate a are combined successively. In this way, the combination quality of the second electrode plate b and the first electrode plate a can be controlled separately, which can help to improve the quality of the first composite plate e and thus improve the quality of the electrode assembly 200.

In addition, by means of the fifth combining mechanism 35 and the first combining mechanism 31, the second separator d, the second electrode plate b, the first separator c and the first electrode plate a are combined into the first composite plate e through two combining steps in succession. Moreover, there may be a large space between the fifth combining mechanism 35 and the first combining mechanism 31, which can improve the layout rationality of the winding device 100, for example, it is conducive to the layout of the fifth image acquisition apparatus 75, the fourth temporary storage mechanism 84, the fifth temporary storage mechanism 85, etc. as described later.

According to the connection relationship between the first separator c, the second electrode plate b and the second separator d in the fifth composite plate j, the form of the fifth combining mechanism 35 can be designed accordingly.

Exemplarily, the fifth combining mechanism 35 is an edge sealing mechanism, and is configured to seal and connect at least one of two side edges of the first separator c and the second separator d in the width direction. Therefore, since the edge sealing mechanism can connect edges of the first separator c and the second separator d together to achieve edge sealing, the first separator c and the second separator d will not separate upon removal of the external force, preventing exposure of the second electrode plate b; gaps are less prone to folding during winding of the electrode assembly 200, and the electrolyte filling process is less susceptible to hole disturbance, thereby effectively lowering the risk of the second electrode plate b overlapping with the first electrode plate a or with a housing 3011 of a battery cell 301 and alleviating the problem of lithium plating. For example, the edge sealing mechanism may include two edge sealing rollers arranged opposite to each other. The two edge sealing rollers can heat edges of both sides of the first separator c and the second separator d and apply a predetermined pressure in the thickness direction F1 to achieve an edge-sealing connection of the first separator c and the second separator d.

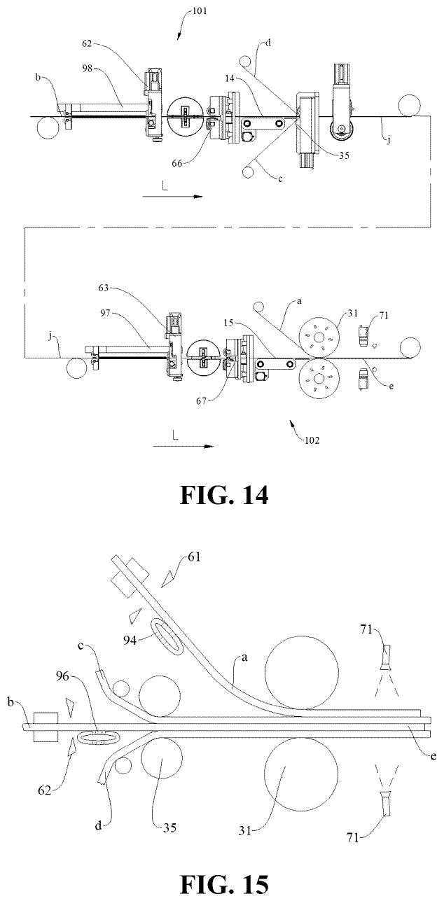

With reference to FIG. 14, when the fifth combining mechanism 35 is a sealing mechanism, the fifth composite plate j is formed as a plate body formed by the second electrode plate b being sealed and covered with the first separator c and the second separator d on both sides of the thickness direction F1, so that the second electrode plate b, the first separator c and the second separator d have stable relative positions and can be synchronously transferred to the first combining mechanism 31 without causing issues such as displacement, folding of the first separator c, folding of the second separator d, or exposure of the second electrode plate b. This is conducive to improving the position accuracy of the second electrode plate b during transfer and subsequent processes, and reducing the risk of overlapping between the second electrode plate b and the first electrode plate a.

Exemplarily, the fifth combining mechanism 35 is a composite mechanism, and is configured to fixedly connect the second electrode plate b, the first separator c and the second separator d in the fifth composite plate j, respectively. Thus, the offset of the first electrode plate a relative to the first separator c and the second separator d during winding and use can be reduced, which is conducive to improving the accuracy of the relative positions between the materials, thereby improving the product quality. There is no limitation on the method of fixed connection, for example, the connection can be made by cold pressing, hot pressing, gluing, etc. Furthermore, the location of the fixed connection is not limited and may be the entire surface or a part thereof, such as a part in the center or a part at the edge.

For example, when the fifth combining structure 35 is a composite structure, the second electrode plate b can be fit between the first separator c and the second separator d by pressure, or the second electrode plate b can be adhered to the first separator c and the second separator d by gluing or other means. For example, the fifth combining mechanism 35 may include two rollers arranged relatively spaced apart, or may include one roller and a support arranged relatively spaced apart from the roller, or may include a plurality of rollers or other structures; the roller in the fifth combining mechanism 35 may be a rotatable structure, a fixed structure, or a floating structure; the roller in the fifth combining mechanism 35 may also be a driving roller or a driven roller.

In some embodiments, with reference to FIG. 12 and FIG. 13, the fifth combining mechanism 35 includes a first composite roller 351 of the fifth mechanism and a second composite roller 352 of the fifth mechanism, and the rotation directions of the first composite roller 351 of the fifth mechanism and the second composite roller 352 of the fifth mechanism are opposite. The first composite roller 351 of the fifth mechanism and the second composite roller 352 of the fifth mechanism cooperate in rolling to combine the second separator d, the second electrode plate b, and the first separator c.

With reference to FIGS. 12 and 13, the first composite roller 351 of the fifth mechanism and the second composite roller 352 of the fifth mechanism are both roller-shaped structures. The first composite roller 351 of the fifth mechanism and the second composite roller 352 of the fifth mechanism are arranged in parallel. Specifically, the central axis of the first composite roller 351 of the fifth mechanism and the central axis of the second composite roller 352 of the fifth mechanism are arranged in parallel, and the rotation direction of the first composite roller 351 of the fifth mechanism and the rotation direction of the second composite roller 352 of the fifth mechanism are opposite. The first composite roller 351 of the fifth mechanism and the second composite roller 352 of the fifth mechanism are spaced apart to form a fifth composite gap 353.

With reference to FIGS. 12 and 13, the first composite roller 351 of the fifth mechanism and the second composite roller 352 of the fifth mechanism are spaced apart along a second direction F6 to form the fifth composite gap 353.

Based on the above structure, the second separator d, the second electrode plate b, and the first separator c can pass through the fifth composite gap 353 and can be rolled by the first composite roller 351 of the fifth mechanism and the second composite roller 352 of the fifth mechanism, so as to be combined into the fifth composite plate j. With such configuration, the composite effect of the fifth combining mechanism 35 can be achieved.

Here, according to the connection relationship between the first separator c, the second electrode plate b and the second separator d in the fifth composite plate j, the rolling position and rolling pressure of the first composite roller 351 of the fifth mechanism and the second composite roller 352 of the fifth mechanism can be specifically designed to meet the requirements of only stacking without connection, or composite fixed connection, or edge sealing connection.

In some embodiments, with reference to FIGS. 12 and 13, when the winding device 100 includes the fifth combining mechanism 35, the type of the first combining mechanism 31 is not limited. For example, the first combining mechanism 31 may be a composite mechanism and is configured to fixedly connect the fifth composite plate j and the first electrode plate a. Alternatively, the first combining mechanism 31 may also be a mechanism for allowing the fifth composite plate j and the first electrode plate a to be merely stacked together without being connected.

Here, when the first combining mechanism 31 is a composite mechanism and is configured to fixedly connect the fifth composite plate j and the first electrode plate a, the offset of the first electrode plate a relative to the fifth composite plate j during winding and use can be reduced, which is conducive to improving the accuracy of the relative positions between the materials, thereby improving the product quality. There is no limitation on the method of fixed connection, for example, the connection can be made by cold pressing, hot pressing, gluing, etc. Furthermore, the location of the fixed connection is not limited and may be the entire surface or a part thereof, such as a part in the center or a part at the edge.

In some embodiments, with reference to FIG. 12 and FIG. 13, the first combining mechanism 31 includes a first composite roller 311 of the first mechanism and a second composite roller 312 of the first mechanism, and the rotation directions of the first composite roller 311 of the first mechanism and the second composite roller 312 of the first mechanism are opposite. The first composite roller 311 of the first mechanism and the second composite roller 312 of the first mechanism cooperate in rolling to combine the first separator d and the fifth composite plate j. The first composite roller 311 of the first mechanism and the second composite roller 312 of the first mechanism are both roller-shaped structures.

The first composite roller 311 of the first mechanism and the second composite roller 312 of the first mechanism are arranged in parallel. Specifically, the central axis of the first composite roller 311 of the first mechanism and the central axis of the second composite roller 312 of the first mechanism are arranged in parallel, and the rotation direction of the first composite roller 311 of the first mechanism and the rotation direction of the second composite roller 312 of the first mechanism are opposite. The first composite roller 311 of the first mechanism and the second composite roller 312 of the first mechanism are spaced apart to form a first composite gap 313.

The first composite roller 311 of the first mechanism and the second composite roller 312 of the first mechanism are spaced apart in the second direction F6 to form the first composite gap 313 mentioned above by spacing.

Based on the above structure, the first electrode plate a and the fifth composite plate j can pass through the first composite gap 313 and can be rolled by the first composite roller 311 of the first mechanism and the second composite roller 312 of the first mechanism, so as to be combined into the first composite plate e. With such configuration, the composite effect of the first combining mechanism 31 can be achieved.

Here, according to the connection relationship between the first electrode plate a in the first composite plate e and the fifth composite plate j, the rolling position and rolling pressure of the first composite roller 311 of the first mechanism and the second composite roller 312 of the first mechanism can be specifically designed to meet the requirements of only stacking without connection, or composite fixed connection, or the like.

With reference to FIGS. 11 and 12, in some embodiments, when the winding device 100 includes the fifth combining mechanism 35, the winding device 100 may further include a fifth detection apparatus, the fifth detection apparatus includes a fifth image acquisition apparatus 75, the fifth image acquisition apparatus 75 is located between the fifth combining mechanism 35 and the first combining mechanism 31, and is configured to detect the fifth composite plate j. The fifth image acquisition apparatus 75 may be connected in communication with the processor 702 n, or the fifth detection apparatus may be separately provided with a processor connected in communication with the fifth image acquisition apparatus 75.

It should be noted that “the fifth image acquisition apparatus 75 is located between the fifth combining mechanism 35 and the first combining mechanism 31” does not impose spatial position limitations (i.e., in terms of spatial arrangement, the relative positions of the fifth image acquisition apparatus 75, the fifth combining mechanism 35, and the first combining mechanism 31 are not restricted). Rather, it imposes a limitation on the workstation order, meaning that the fifth composite plate j formed by the fifth combining mechanism 35 can first undergo detection by the fifth image acquisition apparatus 75 before entering the first combining mechanism 31.

The fifth image acquisition apparatus 75 may be, but is not limited to, a CCD (charge coupled device) camera. Exemplarily, the fifth image acquisition apparatus 75 may include a camera, a machine vision detector or other structures. Exemplarily, the fifth image acquisition apparatus 75 may further include other devices such as a control device. The fifth image acquisition apparatus 75 may obtain corresponding image information (e.g., position, color and shape) of the fifth composite plate j, and can convert the image information into a digital signal and send it to the control device, so that the control device can determine whether the fifth composite plate j meets the requirements according to a preset program.

With reference to FIGS. 11 and 12, since the fifth image acquisition apparatus 75 is arranged between the fifth combining mechanism 35 and the first combining mechanism 31, the fifth composite plate j can be inspected, thereby obtaining the quality of the fifth composite plate j.

Here, the fifth image acquisition apparatus 75 can detect the fifth composite plate j to obtain the combination state of the first separator a, the second electrode plate b, and the second separator c, so as to strictly control the quality of the fifth composite plate j, which can help to improve the quality of the electrode assembly 200.

For example, with reference to FIG. 11 and FIG. 12, the fifth image acquisition apparatus 75 may be used to detect the relative position between the first separator c and the second electrode plate b in the fifth composite plate j. Thus, the fifth image acquisition apparatus 75 can detect the OH of the first separator c extending beyond the second electrode plate b. “The OH of the first separator c extending beyond the second electrode plate b” refers to the size of the edge of the first separator c extending beyond the edge of the active material area of the second electrode plate b in the width direction of the electrode plate. The OH defect refers to that the size of the exceeding part does not meet the required size range. Thus, the first separator c can play a more reliable insulating role between the second electrode plate b and the first electrode plate a.

Exemplarily, the fifth image acquisition apparatus 75 is disposed on one side or both sides of the fifth composite plate j in the thickness direction F1 to detect information such as defects of the fifth composite plate j. The fifth image acquisition apparatus 75 can sequentially detect multiple portions along the length direction of the material during movement of the material, or can continuously detect along the length direction of the material.

Exemplarily, with reference to FIGS. 11 and 12, when the fifth combining mechanism 35 is a composite mechanism, the fifth image acquisition apparatus 75 is disposed downstream of the fifth combining mechanism 35 and is capable of detecting the composite state of the fifth composite plate j. For example, composite defects such as folding and breakage of the second electrode plate ab are detected.

Exemplarily, with reference to FIGS. 11 and 12, when the fifth combining mechanism 35 is an edge sealing mechanism, the fifth image acquisition apparatus 75 can be used to detect the edge sealing state of the fifth composite plate j. The fifth composite plate j can be conveyed to the fifth image acquisition apparatus 75 after edge sealing, and thus the fifth image acquisition apparatus 75 detects the state of the formed edge sealing. For example, edge sealing defects such as folding of the second electrode plate b, wrinkling of the first separator c and the second separator d, edge sealing failure, edge sealing misalignment, edge sealing size and grayscale difference can be detected. For example, the width and position of the edge sealing in the width direction F2 of the first separator c and the second separator d can be detected, so that the first separator c, the second separator d and the edge sealing mechanism can be adjusted according to the detection results. As the width of the formed edge sealing is 0.5-1 mm, and the edge sealing is roughly in the middle of the portion of the first separator c and the second separator d that extends beyond the edge of the second electrode plate b, the reliability of the edge sealing is improved, and the first separator c and the second separator d can reliably limit and protect the second electrode plate b.

When the fifth combining mechanism 35 is an edge sealing mechanism, the fifth image acquisition apparatus 75 is used to detect the relative positions of the first separator c, the second separator d and the second electrode plate b. For example, the fifth image acquisition apparatus 75 can also detect the OH of the first separator c and the second separator d extending beyond the second electrode plate b. “The OH of the first separator c and the second separator d extending beyond the second electrode plate b” refers to, in the width direction of the electrode plate, the size of the edge of the first separator c extending beyond the edge of the active material area of the second electrode plate b, and the size of the edge of the second separator d extending beyond the edge of the active material area of the second electrode plate b.

Thus, the fifth image acquisition apparatus 75 can detect whether the relative positions of the second electrode plate b and the first separator c and the second separator d are accurate, thereby improving the position accuracy of the first separator c, the second separator d and the second electrode plate b. The two sides of the first separator c and the second separator d in the width direction F2 can extend beyond the edge of the second electrode plate b by a sufficient size, thereby improving the edge sealing effect and reducing the risk of overlapping between the second electrode plate b and the first electrode plate a.

Exemplarily, when the fifth combining mechanism 35 is an edge sealing mechanism and the first combining mechanism 31 is a composite mechanism, the edge sealing mechanism is disposed upstream of the composite mechanism. The edge sealing mechanism is used to seal edges of the second electrode plate b, the first separator c and the second separator d to form a fifth composite plate j. After the fifth composite plate j is transferred to the composite mechanism, the composite mechanism can attach the first electrode plate a to one side of the fifth composite plate j and combine them to form an unwound electrode assembly 200.

In this case, the first image acquisition apparatus 71 is also used to detect the relative position between the second electrode plate b and the first electrode plate a. After the fifth composite plate j and the first electrode plate a are stacked and combined, the relative position between the second electrode plate b and the first electrode plate a of the obtained electrode assembly 200 is accurate, for example, meeting the requirement that the two widthwise sides of the second electrode plate b extend beyond the edge of the first electrode plate a by a certain distance, reducing the risk of missed detection of OH, and better solving the problem of lithium plating.

For example, the fifth image acquisition apparatus 75 may be a photoelectric sensor, an X-ray camera, a CCD (charge coupled device) visual sensor, and the types of different image acquisition apparatuses may be the same or different. For example, the fifth image acquisition apparatus 75 may include a CCD. The CCD can obtain optical images of the material to achieve detection. Furthermore, the CCD can also convert optical images into digital signals so that the optical images can be analyzed, processed and stored. For example, the fifth image acquisition apparatus 75 may include an X-ray camera, which can penetrate the first separator c and the second separator d to detect the position of the second electrode plate b on the inner layer. The X-ray camera has a high resolution and can penetrate objects for detection, thereby improving detection precision.

In some embodiments, with reference to FIGS. 11 and 12, when the winding device 100 includes the fifth combining mechanism 35, the winding device 100 may further include a fourth temporary storage mechanism 84. The fourth temporary storage mechanism 84 is disposed between the fifth combining mechanism 35 and the first combining mechanism 31, and is configured to store the fifth composite plate j temporarily.

In some embodiments, with reference to FIG. 12, the fourth temporary storage mechanism 84 is disposed between the fifth combining mechanism 35 and the first combining mechanism 31 and is used for temporary storage of the fifth composite plate j. The fourth temporary storage mechanism 84 is disposed between the fifth combining mechanism 35 and the first combining mechanism 31 and is used for temporary storage of the fifth composite plate j, so that the fourth temporary storage mechanism 84 can temporarily store the fifth composite plate j located between the fifth combining mechanism 35 and the first combining mechanism 31.

Therefore, the fourth temporary storage mechanism 84 may play a role in storing the fifth composite plate j temporarily. When there is a speed difference before and after the fourth temporary storage mechanism 84, the fourth temporary storage mechanism 84 can temporarily store and duly release part of the fifth composite plate j in time, thereby solving the problem of speed reduction or the problem of wrinkles caused by insufficient tension, and improving the production capacity and product quality.

In some embodiments, with reference to FIGS. 11 and 12, when the winding device 100 includes the fourth temporary storage mechanism 84, the second cutting mechanism 62 for cutting the second electrode plate b may be disposed between the second feeding mechanism 12 and the fifth combining mechanism 35.

It should be noted that “the second cutting mechanism 62 is disposed between the second feeding mechanism 12 and the fifth combining mechanism 35” does not impose spatial position limitations (i.e., in terms of spatial arrangement, the relative positions of the second cutting mechanism 62, the second feeding mechanism 12, and the fifth combining mechanism 35 are not restricted). Rather, it imposes a limitation on the workstation order, meaning that the second electrode plate b output from the second feeding mechanism 12 may be cut off by the second cutting mechanism 62 before entering the fifth combining mechanism 35.

In this way, when the second cutting mechanism 62 needs to slow down to cut off the second electrode plate b, the fourth temporary storage mechanism 84 can release the temporarily stored fifth composite plate j to supply it to the first combining mechanism 31, so that the first combining mechanism 31 can continuously and uninterruptedly combine the fifth composite plate j and the first electrode plate a to form the first composite plate e without stopping, and the winding mechanism 40 can continuously and uninterruptedly wind the first composite plate e without stopping. In this way, the winding efficiency of the winding device 100 can be improved, thereby improving the production efficiency of the electrode assembly.

Furthermore, the second cutting mechanism 62 may be arranged spatially away from the winding mechanism 40 to overcome the adverse effect on the quality of the electrode assembly 200 caused by chips formed by cutting falling into the electrode assembly 200 wound on the winding needle 42, thereby facilitating further improvement of the quality of the electrode assembly 200.

For example, the feeding of the second electrode plate b can be stopped, that is, the first feeding mechanism 11 can stop the winding and unwinding operation for the second electrode plate b and cut off the second electrode plate b, thereby ensuring the cutting operation for the second electrode plate b to a certain extent. Moreover, in the process of the second electrode plate b stopping feeding and performing the cutting operation, since the fourth temporary storage mechanism 84 temporarily stores the fifth composite plate j located between the fifth combining mechanism 35 and the first combining mechanism 31, the first combining mechanism 31 can continuously and uninterruptedly combine the fifth composite plate j and the first electrode plate a to form the first composite plate e without stopping, thereby enabling the winding mechanism 40 to continuously and uninterruptedly wind the first composite plate e without stopping. In this way, the winding efficiency of the winding device 100 can be improved, thereby improving the production efficiency of the electrode assembly.

In some embodiments, with reference to FIG. 12, the fourth temporary storage mechanism 84 may include a fourth floating roller 842 and a plurality of fourth fixed rollers 841. The fourth floating roller 842 and the fourth fixed roller 841 are used to alternately bypass the fifth composite plate j, and the fourth floating roller 842 can move relative to the fourth fixed rollers 841 for temporary storage of the fifth composite plate j. The fourth fixed rollers 841 are pulleys that are rotatable and fixed in position. The fourth floating roller 842 refers to a pulley that is rotatable and is not fixed in position. The number of the fourth floating roller 842 may be at least one.

The fourth floating roller 842 and the fourth fixed rollers 841 are used to alternately bypass the fifth composite plate j, which means that the fifth composite plate j can alternately bypass the fourth floating roller 842 and the fourth fixed rollers 841. Taking the example that there are two fourth fixed rollers 841 and one fourth floating roller 842, the fifth composite plate j can bypass one of the fourth fixed rollers 841, the fourth floating roller 842 and the other fourth fixed roller 841 in sequence. Taking the example that there are three fourth fixed rollers 841 and two fourth floating rollers 842, as shown in FIGS. 2 and 3, the fifth composite plate j can bypass a first fourth fixed roller 841, a first fourth floating roller 842, a second fourth fixed roller 841, a second fourth floating roller 842 and a third fourth fixed roller 841 in sequence.

The plurality of fourth fixing rollers 841 are distributed at intervals along a first direction F5. In the first direction F5, one fourth floating roller 842 is disposed between two adjacent fourth fixed rollers 841. Furthermore, the fourth fixed rollers 841 and the fourth floating rollers 842 are also spaced apart along a second direction F6. The fifth composite plate j alternately bypasses the fourth fixed rollers 841 and the fourth floating rollers 842 and is pulled to the first combining mechanism 31. When the second electrode plate b stops moving for performing the cutting operation, the fourth floating roller 842 can move along the second direction F6 toward the fourth fixed roller 841 to shorten a distance between the fourth fixed roller 841 and the fourth floating roller 842, so that the first combining mechanism 31 can continuously and uninterruptedly combine the fifth composite plate j to form the first composite plate e, and accordingly, the winding mechanism 40 can continuously and uninterruptedly perform winding operation on the first composite plate e.

By providing the fourth fixed rollers 841 and the fourth floating rollers 842 that can move relative to the fourth fixed rollers 841, and the fourth fixed rollers 841 and the fourth floating rollers 842 can alternately bypass the fifth composite plate j, the fifth composite plate j can be stored temporarily.

It should be noted that the length of the fifth composite plate j that can be temporarily stored by the fourth temporary storage mechanism 84 can be adjusted by adjusting the number of the fourth floating rollers 842 and the fourth fixed rollers 841 and the distance between the fourth floating rollers 842 and the fourth fixed rollers 841.

When the winding device 100 includes the fourth temporary storage mechanism 84, the fifth image acquisition apparatus 75 can be disposed between the fifth combining mechanism 35 and the fourth temporary storage mechanism 84; alternatively, the fifth image acquisition apparatus 75 can also be disposed between the fourth temporary storage mechanism 84 and the first combining mechanism 31. Here, when the fifth image acquisition apparatus 75 is disposed between the fourth temporary storage mechanism 84 and the first combining mechanism 31, the defects of the fifth composite plate j generated during the combining process and the temporary storage process can be detected by the fifth image acquisition apparatus 75, which is conducive to improving the quality of the composite plate for use in producing the electrode assembly 200.

With reference to FIGS. 11 and 12, in some embodiments, when the winding device 100 includes the fifth combining mechanism 35, the winding device 100 may further include a fifth temporary storage mechanism 85. The fifth temporary storage mechanism 85 is disposed between the first combining mechanism 31 and the first combining mechanism 40, and is configured to store the first composite plate e temporarily.

In this way, the fifth temporary storage mechanism 85 can store the first composite plate e between the first combining mechanism 31 and the winding mechanism 40 temporarily. When there is a speed difference before and after the fifth temporary storage mechanism 85, the fifth temporary storage mechanism 85 can temporarily store and duly release part of the first composite plate e in time, thereby solving the problem of speed reduction or the problem of wrinkles caused by insufficient tension, and improving the production capacity and product quality.

With reference to FIGS. 11 and 12, in some embodiments, when the winding device 100 includes the fifth temporary storage mechanism 85, the first cutting mechanism 61 for cutting the first electrode plate a may be disposed between the first feeding mechanism 11 and the first combining mechanism 31.

It should be noted that “the first cutting mechanism 61 is disposed between the first feeding mechanism 11 and the first combining mechanism 31” does not impose spatial position limitations (i.e., in terms of spatial arrangement, the relative positions of the first cutting mechanism 61, the first feeding mechanism 11, and the first combining mechanism 31 are not restricted). Rather, it imposes a limitation on the workstation order, meaning that the first electrode plate a output from the first feeding mechanism 11 may be cut off by the first cutting mechanism 61 before entering the first combining mechanism 31.

Thus, when the first cutting mechanism 61 needs to slow down to cut off the first electrode plate a, the fifth temporary storage mechanism 85 can release the temporarily stored first composite plate e to the winding mechanism 40, so that the winding mechanism 40 can continuously and uninterruptedly wind the first composite plate e without stopping. In this way, the winding efficiency of the winding device 100 can be improved, thereby improving the production efficiency of the electrode assembly. Moreover, the first cutting mechanism 61 may be arranged spatially away from the winding mechanism 40 to overcome the adverse effect on the quality of the electrode assembly 200 caused by chips formed by cutting falling into the electrode assembly 200 wound on the winding needle 42, thereby facilitating further improvement of the quality of the electrode assembly 200.

For example, the feeding of the second electrode plate b and the first electrode plate a can be stopped, that is, the first feeding mechanism 11 and the third feeding mechanism 21 can respectively stop the winding and unwinding operations for the first electrode plate a and the second electrode plate b, and cut off the first electrode plate a and the second electrode plate b respectively, thereby ensuring the cutting operation for the second electrode plate b and the first electrode plate a to a certain extent. Moreover, in the process of the second electrode plate b and the first electrode plate a stopping and performing the cutting operation, since the fifth temporary storage mechanism 85 temporary storages the first composite plate e located between the first combining mechanism 31 and the winding mechanism 40, the winding mechanism 40 can continue to wind the first composite plate e without stopping. In this way, the winding mechanism 40 may perform the winding operation without stopping, so that the winding efficiency of the winding device 100 can be improved, improving the production efficiency of the electrode assembly.

In some embodiments, with reference to FIG. 12, the fifth temporary storage mechanism 85 may include a fifth floating roller 852 and a plurality of fifth fixed rollers 851. The fifth floating roller 852 and the fifth fixed roller 851 are used to alternately bypass the first composite plate e, and the fifth floating roller 852 can move relative to the fifth fixed rollers 851 for temporary storage of the first composite plate e.

The fifth fixed rollers 851 are pulleys that are rotatable and fixed in position. The fifth floating roller 852 refers to a pulley that is rotatable and is not fixed in position. The number of the fifth floating roller 852 may be at least one.

The fifth floating roller 852 and the fifth fixed rollers 851 are used to alternately bypass the first composite plate e, which means that the first composite plate e can alternately bypass the fifth floating roller 852 and the fifth fixed rollers 851. Taking the example that there are two fifth fixed rollers 851 and one fifth floating roller 852, the first composite plate e can bypass one of the fifth fixed rollers 851, the fifth floating roller 852 and the other fifth fixed roller 851 in sequence.

Taking the example that there are three fifth fixed rollers 851 and two fifth floating rollers 852, the first composite plate e can bypass a first fifth fixed roller 851, a first fifth floating roller 852, a second fifth fixed roller 851, a second fifth floating roller 852 and a third fifth fixed roller 851 in sequence.

The plurality of fifth fixing rollers 851 are distributed at intervals along a first direction F5. In the first direction F5, one fifth floating roller 852 is disposed between two adjacent fifth fixed rollers 851. Furthermore, the fifth fixed rollers 851 and the fifth floating rollers 852 are also spaced apart along a second direction F6. The first composite plate e alternately bypasses the fifth fixed rollers 851 and the fifth floating rollers 852 and is pulled to the first combining mechanism 40. When at least one of the second electrode plate b and the first electrode plate a stops moving for the cutting operation, the fifth floating roller 852 can move along the second direction F6 toward the fifth fixed roller 851 to shorten a distance between the fifth fixed roller 851 and the fifth floating roller 852, so that the winding mechanism 40 can continuously and uninterruptedly perform winding operation on the first composite plate e. The first direction F5 is perpendicular to the second direction F6.

By providing the fifth fixed rollers 851 and the fifth floating rollers 852 that can move relative to the fifth fixed rollers 851, and the fifth fixed rollers 851 and the fifth floating rollers 852 can alternately bypass the first composite plate e, the first composite plate e can be stored temporarily.

It should be noted that the length of the first composite plate e that can be temporarily stored by the fifth temporary storage mechanism 85 can be adjusted by adjusting the number of the fifth floating rollers 852 and the fifth fixed rollers 851 and the distance between the fifth floating rollers 852 and the fifth fixed rollers 851.

When the winding device 100 includes the fifth temporary storage mechanism 85, the first image acquisition apparatus 71 can be disposed between the fifth combining mechanism 85 and the first combining mechanism 31; alternatively, the first image acquisition apparatus 71 can also be disposed between the fifth temporary storage mechanism 85 and the winding mechanism 40. Here, when the first image acquisition apparatus 71 is disposed between the fifth temporary storage mechanism 85 and the winding mechanism 40, the defects of the first composite plate e generated during the combining process and the temporary storage process can be detected by the first image acquisition apparatus 71, which is conducive to improving the quality of the composite plate for use in producing the electrode assembly 200.

Exemplarily, with reference to FIGS. 12 and 13, when the fourth feeding mechanism 22 is arranged upstream of the first combining mechanism 31 such that the second separator d is also combined in the first composite plate e, and when the winding device 100 includes the fifth combining mechanism 35, the third cutting mechanism 63 can be arranged between the first combining mechanism 31 and the winding mechanism 40, and used to cut the second separator d and the first separator c. Thus, the length of the separator can be made longer than the length of the electrode plate easily, thereby meeting the design requirements of the electrode assembly 200; and only one third cutting mechanism 63 needs to be disposed, which can simplify the device, reduce costs and save space. Exemplarily, with reference to FIGS. 12 and 13, when the winding device 100 includes the fifth temporary storage mechanism 85, the third cutting mechanism 63 is specifically arranged between the fifth temporary storage mechanism 85 and the winding mechanism 40.

With reference to FIG. 16, in some embodiments, when the fourth feeding mechanism 22 is arranged upstream of the first combining mechanism 31, the winding device 100 may further include a fourth combining mechanism 34. The fourth combining mechanism 34 is located upstream of the first combining mechanism 31 and downstream of the third feeding mechanism 21, the second feeding mechanism 12, and the first feeding mechanism 11. The fourth combining mechanism 34 is configured to combine the first electrode plate a, the first separator c, and the second electrode plate b into a seventh composite plate m. The seventh composite plate m and the second separator d are combined into a first composite plate e by means of the first combining mechanism 31. The first image acquisition apparatus 71 is disposed downstream of the first combining mechanism 31 and is used to detect the first composite plate e.

In this case, the first image acquisition apparatus 71 may also be used to detect the relative position between the second electrode plate b and the first electrode plate a. For example, the requirement that the two widthwise sides of the second electrode plate b extend beyond the edge of the first electrode plate a by a certain distance is met, thereby reducing the risk of missed detection of OH, and better solving the problem of lithium plating. Alternatively, the first image acquisition apparatus 71 may also be used to detect OH of the separator covering the electrode plate, and the like.

When the winding device 100 includes the fourth combining mechanism 34, the first combining mechanism 31 may be an edge sealing mechanism for sealing and connecting at least one of the two side edges of the first separator c and the second separator d in the width direction. In this case, the first image acquisition apparatus 71 may detect the edge sealing state. Alternatively, the first combining mechanism 31 may also be a composite mechanism, etc.

Of course, the present application is not limited to this. In other embodiments of the present application, the first composite plate e may not include the second separator d. For example, with reference to FIG. 17, in some embodiments, the assembly position of the second separator d and the first composite plate e is located downstream of the first image acquisition apparatus 71.

The fourth feeding mechanism 22 is no longer arranged upstream of the first combining mechanism 31, so that the second separator d released by the fourth feeding mechanism 22 cannot be conveyed to the first combining mechanism 31. For example, the fourth feeding mechanism 22 can convey the second separator d between the first combining mechanism 31 and the winding mechanism 40; alternatively, for another example, the fourth feeding mechanism 22 can also convey the second separator d directly to the winding mechanism 40.

Here, the first combining mechanism 31 can combine the first electrode plate a, the first separator c and the second electrode plate b at one time, or the first combining mechanism 31 can also combine the first electrode plate a, the first separator c and the second electrode plate b in batches. For example, other combining mechanisms can be arranged upstream of the first combining mechanism 31 to first combine the first electrode plate a and the first separator c, and then combine the second electrode plate b and a composite plate by means of the first combining mechanism 31 so as to form a first composite plate e.

In the first composite plate e, the first electrode plate a, the first separator c and the second electrode plate b are stacked in sequence. After the first composite plate e is formed, the first image acquisition apparatus 71 can be used to detect the first composite plate e. The detection items may include: whether the first separator c can cover the first electrode plate a and the second electrode plate b, whether the first composite plate e has the problems of head shake or tail shake, etc.

For example, with reference to FIG. 17, the first image acquisition apparatus 71 can be used to detect the state of the first electrode plate a in the first composite plate e. The state of the first electrode plate a includes but is not limited to the width of the active material layer of the first electrode plate a, known defective electrode plates (e.g., defective products with yellow labels), electrode plate breakage, etc.

For example, with reference to FIG. 17, the first image acquisition apparatus 71 can be used to detect the state of the first separator c in the first composite plate e. The state of the first separator c includes but is not limited to separator folding, breakage, etc. The state of the second electrode plate b and the first separator c is also detected.

For example, with reference to FIG. 17, the first image acquisition apparatus 71 can be used to detect the state of the second electrode plate b in the first composite plate e. The state of the second electrode plate b includes but is not limited to the width of the active material layer of the second electrode plate b, known defective electrode plates (e.g., defective products with yellow labels), electrode plate breakage, etc.

For example, with reference to FIG. 17, the first image acquisition apparatus 71 can be used to detect the relative position relationship between the first electrode plate a and the first separator c in the first composite plate e, including but not limited to the OH of the first separator c covering the first electrode plate a, i.e., the size of the edge of the first separator c extending beyond the edge of the first electrode plate a in at least one direction of a width direction F2 and a length direction F3. The OH defect means that the size of the exceeding part does not meet the required size range.

For example, with reference to FIG. 17, the first image acquisition apparatus 71 can be used to detect the relative position relationship between the second electrode plate b and the first separator c in the first composite plate e, including but not limited to the OH of the first separator c covering the second electrode plate b, i.e., the size of the edge of the first separator c extending beyond the edge of the second electrode plate b in at least one direction of the width direction F2 and the length direction F3. The OH defect means that the size of the exceeding part does not meet the required size range.

Therefore, with reference to FIG. 17, the first image acquisition apparatus 71 can be used to detect whether the width of the active material layer of the first electrode plate a and the second electrode plate b in the first composite plate e meets a set range, and whether the first electrode plate a, the second electrode plate b and the first separator c have composite defects such as crushing so as to discover the defects and reject the defects in time. The first image acquisition apparatus 71 can also detect whether the relative position between the second electrode plate b and the first separator c is accurate, and whether the relative position between the first electrode plate a and the first separator c is accurate, so as to facilitate subsequent processing and reduce the risk of overlapping between the second electrode plate b and the first electrode plate a.

For example, the first image acquisition apparatus 71 may include a camera, a machine vision detector or other structures. The camera is, for example, a CCD camera. The first image acquisition apparatus 71 may also include other components such as a controller. The first image acquisition apparatus 71 can obtain corresponding image information (such as position, color and shape) of the electrode plate, the separator, and the first composite plate e, and can convert the image information into a digital signal and send it to the controller, so that the controller can determine whether the electrode plate, the separator, and the first composite plate e meet the requirements according to a preset program. For example, the first composite plate e can be conveyed in a straight line, and the first image acquisition apparatus 71 can more comprehensively detect the state of the entire first composite plate e passing through, with high-precision detection result.

In the related technologies, the winding device winds the electrode plate and the separator at the winding needle, which makes it difficult for the heads and tails of the electrode plate and the separator entering the winding needle to be detected by the detection apparatus. In this embodiment, the winding device 100 includes the first image acquisition apparatus 71 arranged between the first combining mechanism 31 and the winding mechanism 40. The first image acquisition apparatus 71 is arranged upstream of the winding mechanism 40, which can more comprehensively detect the first composite plate e of stacking of three layers of the first electrode plate a, the first separator c and the second electrode plate b, thereby reducing the detection blind spots and improving the detection accuracy. Moreover, since the first composite plate e is a three-in-one stacking form in which the first electrode plate a, the first separator c and the second electrode plate b are stacked in sequence, it is conducive to early and accurate detection.

Exemplarily, with reference to FIG. 17, the winding device 100 includes the first combining mechanism 31, the fourth feeding mechanism 22 and the winding mechanism 40. The first combining mechanism 31 is used for press-fit of the first electrode plate a, the first separator c and the second electrode plate b to form a first composite plate e. The fourth feeding mechanism 22 is used to unwind the second separator d. The winding mechanism 40 is used to wind the first composite plate e and the second separator d to form an electrode assembly 200. The first combining mechanism 31 first combines the first electrode plate a, the first separator c and the second electrode plate b into a first composite plate e, and then winds the first composite plate e and the second separator d on the winding mechanism 40. The first combining mechanism 31 and the winding mechanism 40 of the winding device 100 can be arranged at intervals, and each can obtain a large space. Moreover, the winding device 100 does not need to feed the negative electrode plate, the positive electrode plate and the separator to the winding mechanism 40 separately, which solves the problem of crowded space above the winding mechanism 40, optimizes the layout of the winding device 100, and facilitates flexible arrangement of various components. In addition, since the first combining mechanism 31 presses the first electrode plate a, the first separator c and the second electrode plate b to form the first composite plate e, the first composite plate e can be comprehensively detected before entering the winding mechanism 40, thereby solving the problem of blind spots in the detection of the wound electrode assembly 200 at the winding mechanism 40.

In addition, both sides of the first composite plate e are electrode plates. In the process of conveying the first composite plate e, friction forces on both sides of the first composite plate e along its thickness direction are consistent. When the first composite plate passes through transfer rollers, it is not easy for the electrode plate to detach from the rollers.

When the first composite plate e does not include the second separator d, the first electrode plate a and the first separator c in the first composite plate e may be in contact but not connected to each other, or may be in contact and connected to each other, so that the first electrode plate a and the first separator c are in a connected or unconnected fitting state. Similarly, the second electrode plate b and the first separator c may be in contact but not connected to each other, or in contact and connected to each other, that is, the second electrode plate b and the first separator c are in a connected or non-connected fitting state.

With reference to FIG. 17, when the first composite plate e does not include the second separator d, the unwinding of the second separator d is not affected by processes such as cutting and defect removal of the first composite plate e disposed upstream. As needed, the second separator d can be continuously unwound (i.e., uninterrupted unwinding) so that the second separator d can extend beyond the head and tail of the electrode plate of each electrode assembly 200 (for example, on both sides of the electrode plate in a length direction F3), thereby improving the effect of the second separator d in separating the first electrode plate a and the second electrode plate b during the winding process of the electrode assembly 200, which is conducive to reducing the risk of short circuit caused by overlapping between the second electrode plate b and the first electrode plate a. Besides, as the second separators d of a plurality of electrode assemblies 200 can be connected during conveying, the conveying stability is improved while the offset of the electrode assembly 200 during production is reduced. In addition, with the continuous unwinding of the second separator d, the continuous unwinding of the first separator c can be omitted. Only by unwinding the second separator d, it is possible to extend beyond the head and tail of the electrode plate and connect the plurality of electrode assemblies 200, which is conducive to saving materials and has better economy.

For example, with reference to FIG. 17, the first combining mechanism 31 is a composite mechanism, and is configured to fixedly connect the first electrode plate a and the second electrode plate b in the first composite plate e. Thus, the offset of the first electrode plate a relative to the first separator c, the offset of the second electrode plate b relative to the first separator c, and the offset of the first electrode plate a relative to the second electrode plate b can be reduced during winding and use, which is conducive to improving the accuracy of the relative positions between the materials, thereby improving the product quality. There is no limitation on the method of fixed connection, for example, the connection can be made by cold pressing, hot pressing, gluing, etc. Furthermore, the location of the fixed connection is not limited and may be the entire surface or a part thereof, such as a part in the center or a part at the edge.

Exemplarily, when the first combining mechanism 31 is a composite mechanism, the first combining mechanism 31 can press the first electrode plate a and the second electrode plate b onto the first separator c by pressure, or can also adhere the first electrode plate a and the second electrode plate b to the first separator c by gluing or other means. For example, the first combining mechanism 31 may include two rollers arranged relatively spaced apart, or may include one roller and a support arranged relatively spaced apart from the roller, or may include a plurality of rollers or other structures; the roller in the first combining mechanism 31 may be a rotatable structure, a fixed structure, or a floating structure; the roller in the first combining mechanism 31 may also be a driving roller or a driven roller.

Exemplarily, with reference to FIG. 17, when the first combining mechanism 31 is a composite mechanism, the first combining mechanism 31 is used to combine the first electrode plate a, the first separator c and the second electrode plate b to form a first composite plate e, where the first separator c is located between the second electrode plate b and the first electrode plate a. The first combining mechanism 31 is disposed downstream of the first feeding mechanism 11, the third feeding mechanism 21 and the second feeding mechanism 12, so that the first electrode plate a, the first separator c and the second electrode plate b can be conveyed to the first combining mechanism 31 to be combined into a first composite plate e. The first combining mechanism 31 can combine the first electrode plate a with the side of the first separator c facing away from the second electrode plate b, and combine the second electrode plate b with the side of the first separator c facing away from the first electrode plate a. The first separator c is located between the second electrode plate b and the first electrode plate a. That is, the first electrode plate a, the first separator c and the second electrode plate b are connected together. This ensures that the relative positions of the first electrode plate a, the first separator c and the second electrode plate b are fixed, and the first electrode plate a, the first separator c and the second electrode plate b can be conveyed synchronously without causing offset, which is conducive to improving the position accuracy of the first electrode plate a and the second electrode plate b during production.

For example, with reference to FIG. 17, when the first combining mechanism 31 is a composite structure, the first electrode plate a, the first separator c and the second electrode plate b can be connected by heating, pressurizing, etc., and the viscosity of the first separator c can be improved by using the first separator c with a high PVDF (polyvinylidene fluoride) content (e.g., the content of 1 mg, 1.5 mg, 2 mg). For example, the PVDF content in the first separator c is higher than the PVDF content in the second separator d, so as to improve the connection tightness between the first separator c and the first electrode plate a and the second electrode plate b respectively, and reduce the offset of the first electrode plate a relative to the first separator c and the offset of the second electrode plate b relative to the first separator c during conveying, winding and use, which is conducive to improving the accuracy of the relative positions between the materials.

For example, with reference to FIG. 17, when the first combining mechanism 31 is a composite mechanism, the first combining mechanism 31 may include two composite rollers arranged opposite to each other, and the two composite rollers can heat the first electrode plate a, the first separator c and the second electrode plate b and apply a predetermined pressure along the thickness direction F1 to make the first electrode plate a, the first separator c and the second electrode plate b bonded together, thereby achieving a composite connection of the first electrode plate a, the first separator c and the second electrode plate b.

Exemplarily, with reference to FIG. 18, when the first combining mechanism 31 is a composite mechanism, the first combining mechanism 31 includes two composite rollers arranged opposite to each other. When the first electrode plate a, the first separator c and the second electrode plate b are conveyed between the two composite rollers, the two composite rollers perform press fit on the first electrode plate a, the first separator c and the second electrode plate b, that is, the two composite rollers cooperate with each other to apply a certain pressure to the first electrode plate a, the first separator c and the second electrode plate b, so that the first electrode plate a, the first separator c and the second electrode plate b are combined into a first composite plate e. Both sides of the first separator c are sticky, and the first electrode plate a and the second electrode plate b are fixed together by an adhesive on the first separator c, so that the first electrode plate a, the first separator c and the second electrode plate b are adhered in sequence, and the relative positions of the first electrode plate a, the first separator c and the second electrode plate b are fixed and are not easy to move relative to each other.

Exemplarily, with reference to FIG. 17, when the first combining mechanism 31 is a composite mechanism, the first image acquisition apparatus 71 is disposed downstream of the first combining mechanism 31, and the first image acquisition apparatus 71 can be used to detect the composite state of the first composite plate e. That is, when the first combining mechanism 31 is a composite mechanism, the first image acquisition apparatus 71 is arranged downstream of the first combining mechanism 31, so that the first electrode plate a, the first separator c and the second electrode plate b can be transferred to the first image acquisition apparatus 71 after being combined into the first composite plate e, so that the composite state can be detected by using the first image acquisition apparatus 71. For example, composite defects such as folding, breakage, crushing, and wrinkling of electrode plates and separators are detected.

For example, as shown in FIG. 17, the first image acquisition apparatus 71 may be a photoelectric sensor, an X-ray camera, a CCD (charge coupled device) visual sensor, and the types of different image acquisition apparatuses may be the same or different. For example, the image acquisition apparatus may include a CCD. The CCD can obtain optical images of the material to achieve detection. Furthermore, the CCD can also convert optical images into digital signals so that the optical images can be analyzed, processed and stored. For example, the image acquisition apparatus may include an X-ray camera. The X-ray camera has a high resolution and can penetrate objects for detection, thereby improving detection precision.

In addition, with reference to FIG. 17, the first image acquisition apparatus 71 can be arranged on one side or both sides of the material thickness direction F1 according to actual needs. For example, the first image acquisition apparatus 71 is disposed on either side of the first composite plate e in the thickness direction F1 to detect the relative position between the first electrode plate a and the second electrode plate b, and detect information such as defects of the second electrode plate b and the first electrode plate a. The first image acquisition apparatus 71 can sequentially detect multiple portions along the length direction F3 of the material during movement of the material, or can continuously detect along the length direction F3 of the material.

Of course, the present application is not limited to this. In other embodiments of the present application, the first combining mechanism 31 is not limited to being a composite mechanism. For example, the first combining mechanism 31 may also be a mechanism for stacking the first electrode plate a, the second electrode plate b and the first separator c in the first composite plate e together without connecting them.

In some embodiments, with reference to FIG. 17, since the first separator c needs to be arranged between the first electrode plate a and the second electrode plate b, the third feeding mechanism 21 may be spatially located between the first feeding mechanism 11 and the second feeding mechanism 12, enabling reasonable spatial layout of the first combining mechanism 31. It can be understood that the respective feeding mechanisms and combining mechanisms can be flexibly arranged and are not limited to the above-mentioned arrangements. Exemplarily, in a height direction of the winding device 100, the first feeding mechanism 11, the third feeding mechanism 21, and the second feeding mechanism 12 are arranged in sequence from top to bottom, so that the first electrode plate a, the first separator c, and the second electrode plate b are stacked from top to bottom.

With reference to FIG. 17, when the first composite plate e does not include the second separator d, in some embodiments, the winding device 100 may further include a sixth combining mechanism 36. The sixth combining mechanism 36 is located between the first combining mechanism 31 and the winding mechanism 40, where the fourth feeding mechanism 22 is located upstream of the sixth combining mechanism 36 and the sixth combining mechanism 36 is configured to combine the first composite plate e and the second separator d into a sixth composite plate k.

It should be noted that “the sixth combining mechanism 36 is located between the first combining mechanism 31 and the winding mechanism 40” does not impose spatial position limitations (i.e., in terms of spatial arrangement, the relative positions of the sixth combining mechanism 36, the first combining mechanism 31, and the winding mechanism 40 are not restricted). Rather, it imposes a limitation on the workstation order. That is, the first composite plate e formed by the first combining mechanism 31 needs to be conveyed to the sixth combining mechanism 36 for assembling before entering the winding mechanism 40.

The fourth feeding mechanism 22 is arranged upstream of the sixth combining mechanism 36, so that the second separator d released by the fourth feeding mechanism 22 can be conveyed to the sixth combining mechanism 36, and the second separator d can serve as the incoming material for the sixth combining mechanism 36. Thus, the sixth combining mechanism can combine the first composite plate e conveyed by the first combining mechanism 31 and the second separator d conveyed by the fourth feeding mechanism 22 into the sixth composite plate k.

Thus, the sixth combining mechanism 36 is arranged downstream of the first combining mechanism 31, the second separator d provided by the sixth combining mechanism 36 can be first combined with the first composite plate e and then fed into the winding mechanism 40 together, so that the relative position between the second separator d and the sixth composite plate k is more reliable and not easy to misalign, which is conducive to improving the reliability of the second separator d insulating the first electrode plate a from the second electrode plate b in the electrode assembly 200 after winding. Furthermore, by spacing the sixth combining mechanism 36 from the winding mechanism 40, the problem of crowded space around (e.g., above) the winding mechanism 40 can be avoided. In addition, in the winding device 100, unwinding mechanisms are separated from the winding mechanisms 40, making the layout flexible and convenient.

When the winding device 100 includes the sixth combining mechanism 36, in some embodiments, with reference to FIG. 17, the sixth combining mechanism 36 is an edge sealing mechanism for sealing and connecting two side edges of the first separator c and the second separator d in the width direction.

With reference to FIG. 17, when the sixth combining mechanism 36 is an edge sealing mechanism, the sixth combining mechanism 36 is disposed downstream of the first combining mechanism 31 and the fourth feeding mechanism 22, and is used to seal and connect edges of the second separator d and the first separator c of the first composite plate e to obtain a sixth composite plate k. For example, the second separator d and the first separator c in the first composite plate e can be connected by heating, pressurizing, gluing, etc. The winding mechanism 40 is disposed downstream of the sixth combining mechanism 36 and is used to wind the sixth composite plate k. This is conducive to reducing the risk of short circuit caused by overlapping of the second electrode plate b and the first electrode plate a, and reducing the risk of corrosion and electrolyte leakage caused by overlapping of the second electrode plate b and the housing 3011 of the battery cell 301.

In some embodiments, with reference to FIG. 17, when the sixth combining mechanism 36 is an edge sealing mechanism, the sixth combining mechanism 36 includes four edge sealing rollers arranged opposite to each other. The four edge sealing rollers can heat the four side edges of the separators and apply a predetermined pressure along the thickness direction F1 to achieve edge sealing connection of the two layers of separators.

In the process of edge sealing connection, referring to FIG. 17, when the sixth combining mechanism 36 is an edge sealing mechanism, the portions where the two layers of separators are connected are sealed edges. According to actual needs, the sealed edges of the two layers of separators in the width direction F2 may extend continuously or discontinuously along the material conveying direction, which falls within the protection scope of the present application.

In some related technologies, the electrode plate and the separator are tightly fitted by a doubling roller before winding. Here, no connection, but only a fitting contact relationship, is formed between the materials and the film. After the external force is removed, it is easy to separate the materials and the film from each other, and there is a risk of overlapping of the positive electrode plate and the negative electrode.

In some embodiments of the present application, with reference to FIG. 17, when the first combining mechanism 31 is a composite mechanism and the sixth combining mechanism 36 is an edge sealing mechanism, the first combining mechanism 31 is used to combine the first electrode plate a, the first separator c and the second electrode plate b to form a tightly connected first composite plate e, and the sixth combining mechanism 36 is used to connect the edges of the first separator c and the second separator d together to achieve edge sealing. Even if the external force is removed, the first electrode plate a, the first separator c and the second electrode plate b are not easy to separate from each other, and the first separator c and the second separator d will not separate, preventing exposure of the second electrode plate b; the separator is not easy to fold during the winding process of the electrode assembly 200, the electrolyte filling process is less susceptible to hole disturbance, thereby effectively lowering the risk of the second electrode plate b overlapping with the first electrode plate a or with the housing 3011 of the battery cell 301 and alleviating the problem of lithium plating.

In addition, when the sixth combining mechanism 36 is an edge sealing mechanism, the first image acquisition apparatus 71 detects the first composite plate e, which is conducive to ensuring that the first separator c has sufficient edge to be sealed with the second separator d, thereby improving the edge sealing quality.

Of course, the present application is not limited to this. The sixth combining mechanism 36 may not be an edge sealing mechanism. For example, with reference to FIG. 18, the sixth combining mechanism 36 may also be just a transfer roller. The fourth feeding mechanism 22 is used to unwind the second separator d, and the sixth combining mechanism 36 is used to allow the second separator d to overlay with the first composite plate e to form a stacked plate, and the stacked plate is conveyed to the winding mechanism 40. The sixth combining mechanism 36 is used for combination of the first composite plate e and the second separator d so that the first composite plate e and the second separator d can be stacked into a stacked plate, and then the stacked plate is transferred to the winding mechanism 40 for winding. In this way, the mechanism can be simplified.

With reference to FIGS. 17 and 18, in some embodiments, when the winding device 100 includes the sixth combining mechanism 36, in some embodiments, the winding device 100 may further include a sixth detection apparatus, the sixth detection apparatus includes a sixth image acquisition apparatus 76, the sixth image acquisition apparatus 76 is located between the sixth combining mechanism 36 and the wining mechanism 40, and is configured to detect the sixth composite plate k. The sixth image acquisition apparatus 76 may be connected in communication with the processor 702 n, or the sixth detection apparatus may be separately provided with a processor connected in communication with the sixth image acquisition apparatus 76.

It should be noted that “the sixth image acquisition apparatus 76 is located between the sixth combining mechanism 36 and the winding mechanism 40” does not impose spatial position limitations (i.e., in terms of spatial arrangement, the relative positions of the sixth image acquisition apparatus 76, the sixth combining mechanism 36, and the winding mechanism 40 are not restricted). Rather, it imposes a limitation on the workstation order. That is, the sixth composite plate k formed by the sixth combining mechanism 36 can be detected by the sixth image acquisition apparatus 76 before entering the winding mechanism 40.

For example, the sixth image acquisition apparatus 76 may include a camera, a machine vision detector or other structures. The camera may be a CCD camera. The sixth image acquisition apparatus 76 may further include other components such as a controller. The sixth image acquisition apparatus 76 can obtain image information (such as position, color and shape) of the sixth composite plate k, and can convert the image information into a digital signal and send it to the controller, so that the controller can determine whether the sixth composite plate k meets the requirements according to a preset program, such as judging whether the second separator d is misaligned, and whether the second separator d covers the first electrode plate a and the second electrode plate b. With the above technical solution, the sixth image acquisition apparatus 76 is disposed between the sixth combining mechanism 36 and the winding mechanism 40, and can comprehensively detect the state of the sixth composite plate k, with a high-accuracy detection result.

The sixth image acquisition apparatus 76 may include a linear array camera or an area array camera, where the image acquisition range of the linear array camera is larger, for example, a linear array camera may be arranged in the center on either side of the material thickness direction F1; the image acquisition range of the area array camera is small, for example, an area array camera may be arranged at either end of the electrode plate on one side of the material thickness direction F1.

Exemplarily, the sixth image acquisition apparatus 76 can be used to detect the relative position between the second separator d and the second electrode plate b, such as detecting the OH of the second separator d covering the second electrode plate b, i.e., the size of the edge of the second separator d extending beyond the edge of the first electrode plate a in the width direction F2 and the length direction F3. The OH defect means that the size of the exceeding part does not meet the required size range. In addition, in some embodiments, the sixth image acquisition apparatus 76 can also be used to detect the relative position between the first electrode plate a and the second electrode plate b, the relative position between the first separator c and the first electrode plate a, etc.

As shown in FIG. 17, exemplarily, when the sixth combining mechanism 36 is an edge sealing mechanism, the sixth image acquisition apparatus 76 can be used to detect the edge sealing state of the sixth composite plate k. For example, edge sealing defects such as electrode plate folding, wrinkling at the head and tail, and separator misalignment can be detected. For example, the relative position of the sealed edge formed by the first separator c and the second separator d and the second electrode plate b can be detected, so that the separator and the sixth combining mechanism 36 can be adjusted according to the detection results, the width and position of the formed sealed edge meet the requirements of the separator covering the second electrode plate b, thereby improving the reliability of the edge sealing and enabling the separator to reliably limit and protect the second electrode plate b. Therefore, the sixth image acquisition apparatus 76 is used to detect the edge sealing state after the first electrode plate a, the first separator c, the second electrode plate b and the second separator d are stacked and the edges of the separators are sealed to form the electrode assembly 200, which can achieve more comprehensive detection, improve the reliability of the edge sealing connection, and reduce the risk of missed detection of defects during the production process of the electrode assembly 200. The position accuracy of the first electrode plate a, the first separator c, the second electrode plate b and the second separator d can also be improved.

In some embodiments, with reference to FIG. 17, when the winding device 100 includes the sixth temporary storage mechanism 36, the third cutting mechanism 63 may be disposed between the sixth feeding mechanism 36 and the winding mechanism 40. That is, the third cutting mechanism 63 cuts off the first separator c and the second separator d after the sixth combining mechanism 36 combines the first composite plate e and the second separator d into the sixth composite plate k. Thus, the length of the separator can be made longer than the length of the electrode plate easily, thereby meeting the design requirements of the electrode assembly 200; and only one third cutting mechanism 63 needs to be disposed, which can simplify the device, reduce costs and save space. Furthermore, the winding device 100 can cut the separator before or after the sixth composite plate k is wound, without wasting specific time to cut the separator, thereby improving the overall winding efficiency.

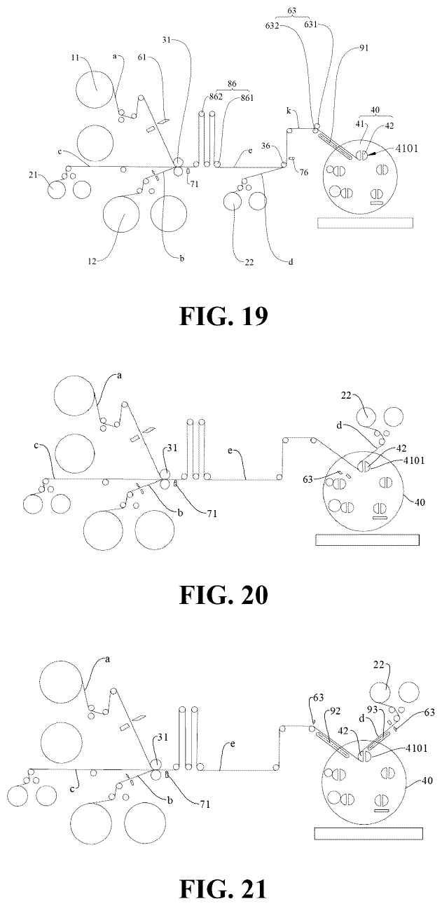

With reference to FIG. 19, when the third cutting mechanism 63 is disposed between the sixth combining mechanism 36 and the winding mechanism 40, the winding device 100 further includes a first conveying member 91 disposed between the third cutting mechanism 63 and the winding mechanism 40, and the first conveying member 91 is used to transfer the sixth composite plate k to the winding mechanism 40.

With reference to FIG. 19, the sixth combining mechanism 36 is used for combining the second separator d and the first composite plate e into the sixth composite plate k. The third cutting mechanism 63 is located upstream of the winding mechanism 40. The third cutting mechanism 63 can cut the first separator c and the second separator d before the sixth composite plate k is wound. The third cutting mechanism 63 may include a variety of cutting structures, such as a linear cutter that reciprocates along a straight line, a cam cutter 81 that rotates around an axis, and a laser cutting structure. The first conveying member 91 conveys the sixth composite plate k from the third cutting mechanism 63 to the winding needle 42. The first conveying member 91 may include various conveying structures, such as clamping jaws and a conveying belt.

With reference to FIG. 19, after the current winding needle 42 winds the electrode assembly 200, the third cutting mechanism 63 cuts off the first separator c and the second separator d, and the first conveying member 91 conveys the head of the next electrode assembly 200 to the empty winding needle 42 so that the winding needle 42 can wind the next electrode assembly 200.

With reference to FIG. 19, the third cutting mechanism 63 provided in the embodiment of the present application is arranged on a feed side of the winding mechanism 40, and uses the first conveying member 91 to convey the separator or plate to the winding mechanism 40, so that the winding mechanism 40 can wind the electrode assembly 200. According to the above technical solution, the third cutting mechanism 63 does not need to avoid the winding needle 42, which is conducive to simplifying the structure of the device; the winding device 100 can transfer the separator while cutting the separator, which significantly improves the winding efficiency compared to the method of cutting the separator first and then transferring the separator.

With reference to FIG. 18, in other embodiments, the first conveying member 91 may be omitted. For example, the third cutting mechanism 63 is adjacent to a winding station 4101, and the cut film can be directly fixed and wound by the winding needle 42.

With reference to FIG. 19, in some embodiments, the first conveying member 91 is a vacuum adsorption o conveying belt.

The vacuum adsorption conveying belt refers to a conveying belt with the function of vacuum adsorption of the film. The vacuum adsorption conveying belt is connected to a vacuum pumping device. The surface of the conveying belt is provided with vacuum adsorption holes. Under the suction action of the vacuum pumping device, the vacuum adsorption holes adsorb the film to prevent the film from warping or shifting during the conveying process. In addition to adsorb the film, the vacuum adsorption conveying belt can also adsorb impurities such as debris and dust, reducing the negative impact that impurities may have on the film and the processing environment.

During operation, after the third cutting mechanism 63 cuts off the separator, the first conveying member 91 transfers the head separator of the electrode assembly 200 to the winding needle 42. For example, the head of the separator falls vertically and enters the accommodating gap. The winding needle 42 can clamp the head separator through the accommodating gap and then start winding. The first conveying member 91 can also transfer the tail separator of the electrode assembly 200 to the winding needle 42, and then the tail separator can be wound up by the finishing roller.

The first conveying member 91 of the embodiment of the present application is a vacuum adsorption conveying belt, which can improve the stability in conveying the film and reduce the probability of the film being warped or deviated during the conveying process.

In some embodiments, with reference to FIG. 19, the conveying speed of the vacuum adsorption conveying belt is equal to the winding speed of the winding needle 42 at the winding station 4101. The winding speed of the winding needle 42 refers to the winding speed of the electrode assembly 200 wound by the winding needle 42 at the winding station 4101, i.e., the ratio of the length of the electrode assembly 200 to the time used for winding, which indicates the length of the separator wound by the winding needle 42 per unit time. The conveying speed of the vacuum adsorption conveying belt is the length of the separator conveyed per unit time. Since the conveying speed of the vacuum adsorption conveying belt is equal to the winding speed of the winding needle 42, the tension of the separator may be zero, reducing the probability of separator deformation due to excessive tension. In addition, the vacuum adsorption conveying belt has high conveying speed and high conveying efficiency. It can be understood that the conveying speed of the vacuum adsorption conveying belt and the winding speed of the winding needle 42 may also be different, as long as the two are adapted to keep the tension of the separator within a certain range.

With reference to FIGS. 17 and 18, in some embodiments, when the first composite plate e does not include the second separator d, the winding device 100 further includes a sixth temporary storage mechanism 86, which is disposed between the first combining mechanism 31 and the winding mechanism 40 and is used to store the first composite plate e temporarily.

With reference to FIGS. 17 and 18, the sixth temporary storage mechanism 86 refers to a structure in the winding device 100 for temporary storage of the first composite plate e. The sixth temporary storage mechanism 86 can also release the temporarily stored first composite plate e; the sixth temporary storage mechanism 86 is arranged between the first combining mechanism 31 and the winding mechanism 40 for the first composite plate e to be wound.

According to the above technical solution, the sixth temporary storage mechanism 86 can achieve temporary storage and release of the first composite plate e, so that the winding mechanism 40 can be fed with the material continuously, improving the winding efficiency. For example, the sixth temporary storage mechanism 86 can store the first composite plate e between the first combining mechanism 31 and the winding mechanism 40 temporarily. When there is a speed difference before and after the sixth temporary storage mechanism 86, the sixth temporary storage mechanism 86 can temporarily store and duly release part of the first composite plate e in time, thereby solving the problem of speed reduction or the problem of wrinkles caused by insufficient tension, and improving the production capacity and product quality.

Exemplarily, with reference to FIG. 17 and FIG. 18, the sixth temporary storage mechanism 86 may include one or more rollers, and the first composite plate e may enter the winding mechanism 40 after bypassing the one or more rollers of the sixth temporary storage mechanism 86. The length of the first composite plate e temporarily stored in the sixth temporary storage mechanism 86 can be flexibly adjusted. Exemplarily, the sixth temporary storage mechanism 86 may store the first composite plate e by winding, stacking, or the like.

Exemplarily, with reference to FIG. 18, the sixth temporary storage mechanism 86 includes a sixth fixed roller 861 and a sixth floating roller 862 arranged at intervals, the sixth fixed roller 861 is fixed relative to the first combining mechanism 31, and the sixth floating roller 862 can approach or move away from the sixth fixed roller 861 to change the length of the first composite plate e temporarily stored by the sixth temporary storage mechanism 86, where a movement direction of the sixth floating roller 862 intersects with the conveying direction of the first combining mechanism 31.

The first fixed roller 861 refers to the roller body in the sixth temporary storage mechanism 86 whose position is fixed relative to the first combining mechanism 31, that is, the position of the sixth fixed roller 861 is also fixed relative to the casing; the sixth fixed roller 861 may be a cylindrical roller body, or a prismatic roller body or a roller body in other shapes; the material of the sixth fixed roller 861 may include plastic, metal or other materials; the sixth fixed roller 861 may be rotatable or fixed relative to a frame; the sixth fixed roller 861 may be a driven roller that rotates along with the movement of the first composite plate e, and the sixth fixed roller 861 may also be a driving roller and be driven to rotate by a driving device such as a motor.

The sixth floating roller 862 refers to the roller body in the sixth temporary storage mechanism 86 that can move relative to the sixth fixed roller 861, that is, the position of the movable roller can be changed on the casing; the sixth floating roller 862 may be a cylindrical roller body, or a prismatic roller body or a roller body in other shapes; the material of the sixth floating roller 862 may include plastic, metal or other materials; the sixth floating roller 862 may be rotatable or fixed relative to the frame; the sixth floating roller 862 may be a driven roller that rotates with the movement of the electrode plate and the separator, and the sixth floating roller 862 may also be a driving roller and be driven to rotate by a driving device such as a motor.

The sixth floating roller 862 is capable of moving in directions close to or away from the sixth fixed roller 861. When the sixth floating roller 862 moves in a direction away from the sixth fixed roller 861, the length of the first composite plate e stored in the sixth temporary storage mechanism 86 increases; when the sixth floating roller 862 moves in a direction close to the sixth fixed roller 861, the length of the first composite plate e stored in the sixth temporary storage mechanism 86 decreases, releasing part of the first composite plate e.

The floating of the sixth floating roller 862 may be either passive floating or active floating. In some embodiments, the floating of the sixth floating roller 862 is achieved by elastic elements such as springs and rubber strips. In this case, the sixth floating roller 862 is passively floating. In other embodiments, the floating of the sixth floating roller 862 is achieved by an active power device such as a cylinder and a hydraulic cylinder. In this case, the sixth floating roller 862 is actively floating.

The number of sixth fixed rollers 861 may be one, two, or more; the number of floating rollers may be one, two, or more. When both the sixth fixed rollers 861 and sixth floating rollers 862 are two or more in number, the sixth fixed rollers 861 and sixth floating rollers 862 may be alternately arranged along the conveying path of the first composite plate e.

This embodiment provides some specific structures of the sixth temporary storage mechanism 86, which realizes the temporary storage and release effect of the first composite plate e through the movement of the sixth floating rollers 862. The sixth temporary storage mechanism 86 can adjust the length of the temporarily stored first composite plate e to adapt to the winding speed of the winding mechanism 40 and the speed of cutting the electrode plate.

During production, the sixth temporary storage mechanism 86 stores the material temporarily and can continuously transfer the material downstream, so that the second cutting mechanism 63 can work without slowdown and will not be affected by the combining operation performed upstream of the sixth temporary storage mechanism 86. For example, as shown in FIG. 17, the composite precision requirement is relatively high, resulting in a low operating speed. The sixth temporary storage mechanism 86 is used for temporary storage of the first composite plate e after the first electrode plate a, the first separator c and the second electrode plate b are combined. The third cutting mechanism 63 is used to cut the second separator d connected between adjacent electrode assemblies 200, where the precision requirement is low and the operating speed is high. Through temporary storage of the sixth temporary storage mechanism 86, the combining speed of the first combining mechanism 31 is reduced. The sixth temporary storage mechanism 86 can stably and continuously transfer the first composite plate e to the sixth combining mechanism 36 without reducing the edge sealing rate, and then the third cutting mechanism 63 can cut the tape-shaped electrode assembly 200 without slowdown, thereby improving the winding efficiency and improving the overall production capacity.

In some embodiments, with reference to FIG. 18, when the winding device 100 includes the sixth temporary storage mechanism 86, the first cutting mechanism 61 may be disposed between the first feeding mechanism 11 and the first combining mechanism 31, and the second cutting mechanism 62 may be disposed between the second feeding mechanism 12 and the first combining mechanism 31.

Thus, when the first electrode plate a and the second electrode plate b are cut in advance before they enter the first combining mechanism 31, the sixth temporary storage mechanism 86 can temporarily store and release the first composite plate e, ensuring that the winding mechanism 40 can wind the electrode plates without interruption during cutting, and significantly improving winding efficiency.

Furthermore, both the first cutting mechanism 61 and the second cutting mechanism 62 may be arranged spatially away from the winding mechanism 40 to solve the adverse effect on the quality of the electrode assembly 200 caused by chips formed by cutting falling into the electrode assembly 200 wound on the winding needle 42, thereby facilitating further improvement of the quality of the electrode assembly 200.

In some embodiments, with reference to FIG. 18, when the first composite plate e does not include the second separator d, for example, in some embodiments, with reference to FIG. 20, the first electrode plate a, the first separator c, and the second electrode plate b can be separately fed into the first combining mechanism 31. That is, before feeding into the first combining mechanism 31, the first separator c is not pre-stacked with either the first electrode plate a or the second electrode plate b, thereby simplifying the mechanism and eliminating the need for providing a combining mechanism upstream of the first combining mechanism 31, and saving space

When the winding device 100 includes the sixth temporary storage mechanism 86, the first image acquisition apparatus 71 can be disposed between the first combining mechanism 31 and the sixth temporary storage mechanism 86; alternatively, the first image acquisition apparatus 71 can also be disposed between the sixth temporary storage mechanism 86 and the sixth combining mechanism 36. Here, when the first image acquisition apparatus 71 is disposed between the sixth temporary storage mechanism 86 and the sixth combing mechanism 36, the defects of the first composite plate e generated during the combining process and the temporary storage process can be detected by the first image acquisition apparatus 71, which is conducive to improving the quality of the composite plate for use in producing the electrode assembly 200.

Of course, when the first composite plate e does not include the second separator d, the first electrode plate a, the first separator c and the second electrode plate b may not be fed separately into the first combining mechanism 31. For example, a seventh combining mechanism may be arranged upstream of the first combining mechanism 31 to preferentially combine the first electrode plate a and the first separator c. Alternatively, an eighth combining mechanism may be arranged upstream of the first combining mechanism 31 to preferentially combine the first separator c and the second electrode plate b. These will not be elaborated here.

The winding device 100 may also not include the sixth combining mechanism 36. For example, with reference to FIG. 20 and FIG. 21, in some embodiments, the fourth feeding mechanism 22 and the first composite plate e are combined at the winding mechanism 40. In this case, the fourth feeding mechanism 22 is not arranged downstream of the first combining mechanism 31, but is arranged on one side of the winding mechanism 40.

With reference to FIGS. 20 and 21, the fourth feeding mechanism 22 is disposed on one side of the winding mechanism 40, and the fourth feeding mechanism 22 is used to transfer the second separator d to the winding needle 42 located at the winding station 4101, and the first composite plate e and the second separator d are gathered on the winding needle 42 of the winding station 301.

With reference to FIGS. 20 and 21, the fourth feeding mechanism 22 directly transfers the second separator d to the winding mechanism 40, so that the first composite plate e transferred by the first combining mechanism 31 and the second separator d transferred by the fourth feeding mechanism 22 are wound together. In this way, the fourth feeding mechanism 22 can directly transfer the second separator d to the winding device 100, and the winding needle 42 located at the winding station 4101 can wind the first composite plate e and the second separator d together to form the electrode assembly 200. Therefore, the mechanism can be simplified, the need to provide another combining mechanism downstream of the first combining mechanism 31 is omitted, thereby saving space.

With reference to FIG. 21, there may be two third cutting mechanisms 63, one third cutting mechanism 63 is disposed between the first combining mechanism 31 and the winding mechanism 40 and is used to cut the first separator c, and the other third cutting mechanism 63 is disposed between the fourth feeding mechanism 22 and the winding mechanism 40 and is used to cut the second separator d. With reference to FIG. 21, the winding device 100 may further include a second conveying member 92 and a third conveying member 93. The second conveying member 92 and the third conveying member 93 are respectively arranged between the two third cutting mechanisms 63 and the winding mechanism 40. The second conveying member 92 is used to convey the first composite plate e, and the third conveying member 93 is used to convey the second separator d. The third cutting mechanism 63 may include a cam cutter, or a cutter that reciprocates along a straight line, a laser cutter, or the like. According to the above technical solution, the first separator c and the second separator d are cut before being wound, the third cutting mechanism 63 does not occupy the space of the winding mechanism 40, and there is no need to avoid the winding needle 42 rotating with the turret 41.

The following describes, with reference to FIG. 4, the winding device 100 according to some specific embodiments of the present application.

With reference to FIG. 4, the winding device 100 mainly includes a feeding mechanism, a cutting mechanism, a combining mechanism, a detection assembly, a temporary storage mechanism, a winding mechanism, and the like.

With reference to FIG. 4, the feeding mechanism includes an electrode plate feeding mechanism and a separator feeding mechanism. The electrode plate feeding mechanism includes the first feeding mechanism 11 (which may be a electrode plate roller, for example) and the second feeding mechanism 12 (which may be an electrode plate roller, for example); the separator feeding mechanism includes the third feeding mechanism 21 (which may be a separator roller, for example) and the fourth feeding mechanism 22 (which may be a separator roller, for example).

The first feeding mechanism 11 is used to wind the first electrode plate a and release the first electrode a; the second feeding mechanism 12 is used to wind the second electrode plate b and release the second electrode plate b; the third feeding mechanism 21 is used to wind the first separator c and release the first separator c; and the fourth feeding mechanism 22 is used to wind the second separator d and release the second separator d.

With reference to FIG. 4, the combining mechanism may include the first combining mechanism 31 and the second combining mechanism 32, and the winding mechanism 40 may include the turret 41 and five winding needles 42 provided on the turret 41, and the winding needles 42 are used to wind the stacked electrode plates and separators. The winding mechanism 40 further includes a finishing assembly 43, which includes a finishing roller 431 and a gluing roller 432. A blanking mechanism 50 is also disposed next to the turret 41. The blanking mechanism 50 may include a clamping jaw 51 and a platform 52, or may also include a robot or other structure; the clamping jaw 51 is used to remove the wound electrode assembly 200 from the winding needles 42, and the platform 52 is used to carry and convey the electrode assembly 200 removed by the clamping jaw 51, so as to facilitate subsequent processes to obtain the wound electrode assembly 200 from the platform 52.

With reference to FIG. 4, the finishing roller 431 is used to press the electrode plate and the separator together. The finishing roller 431 refers to a structure in the finishing assembly 43 that presses the first composite plate e wound on the winding needles 42. Because the tail of the electrode plate and the tail of the separator are easy to separate and upwarp after the first composite plate e is wound on the winding needles 42, the main function of the finishing roller 431 is to press the tail of the first composite plate e to reduce the separation of the electrode plate and the separator at the tail of the first composite plate e and improve the bonding stability of the electrode plate and the separator in the first composite plate e. The finishing assembly 43 of this embodiment includes the finishing roller 431, which presses the electrode plate and the separator onto the winding needle 42 through the finishing roller 431, and presses the electrode plate and the separator together through the pressure of the finishing roller 431 to reduce the occurrence of separation between the electrode plate and the separator.

With reference to FIG. 4, the gluing roller 432 is used to fix the separator to the electrode plate. The gluing roller 432 refers to the structure in the finishing assembly 43 used to glue on the electrode plate. The gluing roller 432 can stick adhesive paper, tape or other fixing structures on the tail of the first composite plate e to fix the tail of the first composite plate e, thereby further reducing the situation of the tail of the first composite plate e being lifted up, and can also further reduce the situation of the electrode plate and the separator being separated at the tail of the first composite plate e. The finishing assembly 43 of this embodiment also includes a gluing roller 432. After the finishing roller 431 presses the electrode plate and the separator together, the gluing roller 432 is used to apply glue to the tail of the first composite plate e to further fix the electrode plate and the separator and obtain a first composite plate e with a relatively stable connection that is not easy to fall apart, thereby reducing the occurrence of separation between the electrode plate and the separator.

With reference to FIG. 4, the cutting mechanism includes the first cutting mechanism 61, the second cutting mechanism 62, and the third cutting mechanism 63. The first cutting mechanism 61 and the second cutting mechanism 62 are both electrode cutting mechanisms. The first cutting mechanism 61 refers to a mechanism in the winding device 100 for cutting the first electrode plate a. The first cutting mechanism 61 is disposed between the first feeding mechanism 11 and the first combining mechanism 31. The second cutting mechanism 62 refers to the mechanism in the winding device 100 for cutting the second electrode plate b. The second cutting mechanism 62 is disposed between the second feeding mechanism 12 and the first combining mechanism 31. The third cutting mechanism 63 is a separator cutting mechanism for cutting the separator in the winding device 100. The third cutting mechanism 63 is disposed upstream of the winding mechanism 40.

The electrode cutting mechanism may include a variety of cutting mechanisms, such as a linear cutter that reciprocates along a straight line, and a cam cutter that rotates around an axis; the electrode cutting mechanism can choose to use a cutting mechanism for cutting the negative electrode plate or a cutting mechanism for cutting the positive electrode plate as needed. The separator cutting mechanism may include various cutting mechanisms, such as a linear cutter that reciprocates along a straight path or a cam cutter that rotates around an axis.

According to the structure of the electrode assembly 200, the electrode assembly 200 generally includes a first separator c and a second separator d. In this case, the third cutting mechanism 63 may only include a cutting mechanism for cutting off the first separator c, or only include a cutting mechanism for cutting off the second separator d, or may include a cutting mechanism for cutting off the first separator c and a cutting mechanism for cutting off the second separator d at the same time, or may be a cutting mechanism that can cut off the first separator c and the second separator d at the same time. The third cutting mechanism 63 is arranged upstream of the winding mechanism 40, so that the third cutting mechanism 63 can cut off the separator before the separator enters the winding mechanism 40. The third cutting mechanism 63 can be arranged downstream of the first combining mechanism 31 or upstream of the first combining mechanism 31 as needed.

With reference to FIG. 4, the electrode cutting mechanism is located upstream of the first combining mechanism 31, and the separator cutting mechanism is disposed between the first combining mechanism 31 and the winding mechanism 40. The electrode cutting mechanism can cut off the electrode plate before the electrode plate and the separator are combined, and the separator cutting mechanism can cut off the separator after the electrode plate and the separator are combined. Such configuration can more easily make the length of the separator greater than the length of the electrode plate, thereby meeting the design requirements of the electrode assembly 200.

With reference to FIG. 4, the first cutting mechanism 61 includes the first cutter 611 and the first abutting member 612 that are spaced apart from each other. The second cutting mechanism 62 includes the second cam cutter 621 and the second abutting member 622 that are arranged opposite to each other. The third cutting mechanism 63 includes the second cam cutter 631 and the third abutting member 632 that are arranged at an interval.

With reference to FIG. 4, the first electrode plate a and the first separator c wound on the first feeding mechanism 11 and the third feeding mechanism 21 are combined at the second combining mechanism 32 to form a second composite plate f. The first combining mechanism 31 is used to combine the second composite plate f, the second separator d, and the second electrode plate b into a first composite plate e. After the first electrode plate a and the first separator c are combined by the second combining mechanism 32, they are combined with the second electrode plate b and the second separator d at the first combining mechanism 31 through the first temporary storage mechanism 81 to form the first composite plate e. In the first composite plate e, the first electrode plate a, the first separator c, the second electrode plate b, and the second separator d are stacked in sequence; the second cam cutter 631 arranged between the first combining mechanism 31 and the winding mechanism 40 cooperates with the third abutting member 632 to cut off the first separator c and the second separator d in the first composite plate e, to form a separate complete first composite plate e.

With reference to FIG. 4, the first composite plate e cut by the second cam cutter 631 and the third abutting member 632 is wound by the winding needle 42. When the winding needle 42 finishes winding, the winding needle 42 passes through the finishing roller 431, the gluing roller 432, the blanking mechanism 50 and an empty station in sequence. The blanking mechanism 50 removes the electrode assembly 200 on the winding needle 42 and allows the empty winding needle 42. The empty winding needle 42 can move through the vacancy position to the winding station 4101 to wind the first composite plate e again.

With reference to FIG. 4, the detection assembly is disposed upstream of the winding mechanism 40. The detection assembly includes the first image acquisition apparatus 71 and the second image acquisition apparatus 72. The first image acquisition apparatus 71 is disposed between the first combining mechanism 31 and the winding mechanism 40, and the second image acquisition apparatus 72 is disposed between the second combining mechanism 32 and the first temporary storage mechanism 81. The detection assembly may include a camera, a machine vision detector or other structures. The detection assembly may further include other devices such as a control device. The detection assembly can obtain image information (such as position, color and shape) and convert the image information into a digital signal and send it to the control device, so that the control device can determine whether the electrode plate, the separator or the composite plate meets the requirements according to a preset program.

The detection assembly disposed between the combining mechanism and the winding mechanism 40 can more comprehensively detect the state of the entire first composite plate e passing through. Because the first composite plate e will enter the winding needle 42 for winding, it is not easy to detect the head of the first composite plate e after entering the winding needle 42, and because the positions of the electrode plate and the separator in the first composite plate e after combining are relatively stable, the occurrence of displacement or misalignment is minimized. Therefore, the state of the first composite plate e detected by the detection assembly located between the combining mechanism and the winding mechanism 40 is small or the same as the state of the electrode assembly 200 after winding, where the detection result of the detection assembly can have a high accuracy.

Exemplarily, the first electrode plate a is a negative electrode plate, the second electrode plate b is a positive electrode plate; and in the first composite plate e, the second electrode plate b is stacked between the first separator c and the second separator d; the second combining mechanism 32 and the first combining mechanism 31 are both provided with image acquisition apparatuses (i.e., the second image acquisition apparatus 72 and the first image acquisition apparatus 71), so that full OH detection for the electrode plate during winding and finishing can be achieved. This solves the problem of missed detection in related technologies where the OH at the head and tail cannot be detected when the positive and negative electrode plates are wound up for detection at the winding needle.

In some embodiments, referring to FIG. 4, the winding device 100 may further include a conveying member. For example, the conveying member may include a fourth conveying member 94, a fifth conveying member 95, and a sixth conveying member 96. The fourth conveying member 94 is disposed between the first cutting mechanism 61 and the second combining mechanism 32 and is used to convey the first electrode plate a. The fifth conveying member 95 is disposed between the second feeding mechanism 12 and the second cutting mechanism 62, and the sixth conveying member 96 is disposed between the second cutting mechanism 62 and the first combining mechanism 31, and is used to convey the second electrode plate b. For example, the conveying member may be a vacuum conveying belt, a reciprocating conveying trolley, an insert feeding mechanism or other structures.

After the first cutting mechanism 61 cuts off the first electrode plate a, the tail of the first electrode plate a is difficult to fix. As the cut first electrode plate a is conveyed through the fourth conveying member 94, the first electrode plate a can be fixed, thereby reducing the movement of the tail of the first electrode plate a. After the second cutting mechanism 62 cuts off the second electrode plate b, the tail of the second electrode plate b is not easy to fix. As the cut second electrode plate b is conveyed through the fifth conveying member 95 and the sixth conveying member 96, the second electrode plate b can be fixed, thereby reducing the movement of the tail of the second electrode plate b.

For example, the conveying member is a vacuum adsorption conveying belt. The principle of the vacuum adsorption conveying belt is to use vacuum adsorption to adsorb the material on the conveying belt, and convey the material to the desired position through the conveying belt; the conveying member is a vacuum adsorption conveying belt, so that in addition to being able to convey the first electrode plate a and the second electrode plate b, the conveying member can also adsorb metal debris, dust and other impurities that may be generated in the process of cutting the first electrode plate a and the second electrode plate b, thereby reducing the possible negative impact on the electrode plate, the separator and the processing environment. In this embodiment, the second electrode plate b and the first electrode plate a are conveyed by the conveying member to increase the conveying stability and reduce the occurrence of situations such as loss of conveying power after the electrode plates are cut off.

The following describes, with reference to FIG. 5, the winding device 100 according to some specific embodiments of the present application.

With reference to FIG. 5, the winding device 100 includes the second feeding mechanism 12, the first feeding mechanism 11, the third feeding mechanism 21, the fourth feeding mechanism 22, the first combining mechanism 31, the second combining mechanism 32, the second image acquisition apparatus 72, the first image acquisition apparatus 71, the first temporary storage mechanism 81, the first cutting mechanism 61, the second cutting mechanism 62, the third cutting mechanism 63, the winding mechanism 40, and transfer rollers provided between the mechanisms, the transfer rollers being used to convey materials. The first combining mechanism 31 is an edge sealing mechanism, and the second combining mechanism 32 is a composite mechanism.

Referring to FIG. 5, the first combining mechanism 31 is an edge sealing mechanism for sealing and connecting edges of the first separator c and the second separator d on both sides of the second electrode plate b in the width direction F2 to obtain a first composite plate e. The second combining mechanism 32 is used to combine the first electrode plate a (e.g., negative electrode plate) and the first separator c to obtain a second composite plate f. The first image acquisition apparatus 71 is disposed downstream of the first combining mechanism 31 and is capable of detecting the edge sealing state of the first composite plate e. The second image acquisition apparatus 72 is disposed downstream of the second combining mechanism 32 and is capable of detecting the composite state of the second composite plate f.

Referring to FIG. 5, the composite mechanism is arranged upstream of the edge sealing mechanism. The composite mechanism is used to combine the first electrode plate a and the first separator c to form a second composite plate f. After the second composite plate f is transferred to the edge sealing mechanism, the edge sealing mechanism is used to seal edges of the second electrode plate b, the second composite plate f and the second separator d to form a first composite plate e.

Referring to FIG. 5, the second composite plate f is a plate obtained by connecting the first electrode plate a and the first separator c through the composite mechanism, so that the relative position between the first electrode plate a and the first separator c is fixed, the electrode plates can be synchronously transferred to the edge sealing mechanism without causing offset, which is conducive to improving the position accuracy of the first electrode plate a during the transfer and edge sealing process.

Referring to FIG. 5, the first electrode plate a and the first separator c are firstly combined by the second combining mechanism 32 to obtain the second composite plate f, and then the second composite plate f, the second electrode plate b and the second separator d are sealed by the first combining mechanism 31 to obtain an unwound electrode assembly 200, and finally the electrode assembly 200 is wound by the winding mechanism 40.

The second image acquisition apparatus 72 is installed behind the first temporary storage mechanism 81 and in front of the first combining mechanism 31, and is used to detect the composite conditions such as the OH of the first separator c extending beyond the first electrode plate a in the second composite plate f, the folding of the first electrode plate a, and the electrode plate breakage. The first image acquisition apparatus 71 is installed behind the first combining mechanism 31, and is used to detect the double-sided OH of the positive electrode plate and the negative electrode plate (that is, the size of the two side edges of the active material area of the positive electrode plate extending beyond the two side edges of the active material area of the negative electrode plate in the width direction), folding of the electrode plate, wrinkling of the first separator c, the second separator d and other edge sealing conditions. In this way, comprehensive detection of the electrode assembly 200 produced by the composite edge-sealing and winding method can be achieved, thereby alleviating the problem of the missed detection in composite sealing, such as missed detection of OH of the electrode plate, wrinkling of the head, and crushing of the electrode plate.

Exemplarily, the first electrode plate a is a negative electrode plate, the second electrode plate b is a positive electrode plate; and in the first composite plate e, the second electrode plate b is stacked between the first separator c and the second separator d; the second combining mechanism 32 and the first combining mechanism 31 are both provided with image acquisition apparatuses (i.e., the second image acquisition apparatus 72 and the first image acquisition apparatus 71). The second image acquisition apparatus 72 is installed behind the first temporary storage mechanism 81 and in front of the first combining mechanism 31, and can detect composite defects such as OH of the separator extending beyond the negative electrode, folding of the negative electrode, breakage of the electrode plate. The first image acquisition apparatus 71 is installed behind the first combining mechanism 31 and before the serpentine rectification, and can detect edge sealing defects such as the double-sided OH of the positive electrode plate covering the negative electrode plate in the first composite plate e, folding of the electrode plate, wrinkling of the separator, and other edge sealing defects. In addition, the winding device 100 may further include a seventh detection apparatus and an eighth detection apparatus. The seventh detection apparatus includes a seventh image acquisition apparatus 77, and the eighth detection apparatus includes an eighth image acquisition apparatus 78. The sixth image acquisition apparatus 77 may be connected in communication with the processor 702 n, or the sixth detection apparatus may be separately provided with a processor connected in communication with the sixth image acquisition apparatus 77. The eighth image acquisition apparatus 78 may be connected in communication with the processor 702; alternatively, the eighth detection apparatus may be separately provided with a processor connected in communication with the eighth image acquisition apparatus 78.

The seventh image acquisition apparatus 77 is installed after the negative electrode is unwound and in front of the first cutting mechanism 61, and can detect the AT11 width of the front and back of the negative electrode, defective products (e.g., defective products with yellow labels), breakage of the electrode plate, and other defects. The eighth image acquisition apparatus 78 is installed behind the third cutting mechanism 63 and in front of the winding needle 42, and is used to detect the double-sided OH of the positive electrode covering the negative electrode of two adjacent circles of first composite plate e on the winding mechanism 40, thereby avoiding missed detection of OH.

The following describes, with reference to FIG. 11, the winding device 100 according to some specific embodiments of the present application.

With reference to FIG. 11, the winding device 100 includes the second feeding mechanism 12, the first feeding mechanism 11, the third feeding mechanism 21, the fourth feeding mechanism 22, the first combining mechanism 31, the fifth combining mechanism 35, the first image acquisition apparatus 71, the fifth image acquisition apparatus 75, the first cutting mechanism 61, the first cutting mechanism 62, the third cutting mechanism 63, the fifth temporary storage mechanism 85, the fourth temporary storage mechanism 84, the winding mechanism 40, and transfer rollers provided between the mechanisms, the transfer rollers being used to convey materials. The first combining mechanism 31 is a composite mechanism, and the fifth combining mechanism 35 is an edge sealing mechanism.

The first separator c and the second separator d compositely cover the second electrode plate b, and the edges of the portions of the first separator c and the second separator d extending beyond the second electrode plate b are sealed to obtain a fifth composite plate j. The fifth composite plate j is then combined with the first electrode plate a to form a first composite plate e.

The fifth image acquisition apparatus 75 is installed behind the fifth combining mechanism 35 and in front of the fourth temporary storage mechanism 84, and is used to detect the OH of the first separator c and the second separator d covering the second electrode plate b, the edge sealing effect, and edge sealing states such as wrinkling of the electrode plate, the first separator c and the second separator d. The first image acquisition apparatus 71 is installed behind the first combining mechanism 31 and in front of the fifth temporary storage mechanism 85, and is used to detect the double-sided OH of the positive electrode plate and the negative electrode plate (i.e., the size of the two side edges of the active material area of the positive electrode plate extending beyond the two side edges of the active material area of the negative electrode plate in the width direction), folding of the electrode plate, wrinkling of the first separator c, the second separator d and other conditions. In this way, comprehensive detection of the electrode assembly 200 produced by the composite edge-sealing and winding method can be achieved, thereby avoiding the problem of the missed detection in composite sealing, such as missed detection of OH of the electrode plate, wrinkling of the head, and crushing of the electrode plate.

Exemplarily, the first electrode plate a is a negative electrode plate, the second electrode plate b is a positive electrode plate; and in the first composite plate e, the second electrode plate b is stacked between the first separator c and the second separator d; the fifth combining mechanism 35 and the first combining mechanism 31 are both provided with image acquisition apparatuses (i.e., the fifth image acquisition apparatus 75 and the first image acquisition apparatus 71), so that full OH detection for the electrode plate during winding and finishing can be achieved. This solves the problem of missed detection in related technologies where the OH at the head and tail cannot be detected when the positive and negative electrode plates are wound up for detection at the winding needle.

The following describes, with reference to FIGS. 12 and 13, the winding device 100 according to some specific embodiments of the present application.

With reference to FIGS. 12 and 13, the winding device 100 includes a first combining mechanism 31, a fifth combining mechanism 35, a winding mechanism 40, a fifth temporary storage mechanism 85, a fourth temporary storage mechanism 84, a fifth image acquisition apparatus 75, and a first image acquisition apparatus 71. The fifth combining mechanism 35 is used to sequentially stack and combine the second separator d, the second electrode plate b, and the first separator c to form a fifth composite plate j. The first combining mechanism 31 is used to stack and combine the fifth composite plate j and the first electrode plate a to form a first composite plate e. The winding mechanism 40 is used to wind the first composite plate e to form an electrode assembly 200. The fifth temporary storage mechanism 85 is disposed between the first combining mechanism 31 and the winding mechanism 40, and the first image acquisition apparatus 71 is disposed between the first combining mechanism 31 and the fifth temporary storage mechanism 85. The fourth temporary storage mechanism 84 is arranged between the fifth combining mechanism 35 and the first combining mechanism 31. The fifth image acquisition apparatus 75 is arranged between the fifth combining mechanism 35 and the fourth temporary storage mechanism 84.

The fifth image acquisition apparatus 75 can detect the fifth composite plate j, so as to obtain the composite state of at least two in the fifth composite plate j. The first image acquisition apparatus 71 can detect the first composite plate e, so as to obtain the composite state of the first electrode plate a and the fifth composite plate j. That is, the fifth image acquisition apparatus 75 can detect the composite state of the second electrode plate b, the second separator d and the first separator c, and the first image acquisition apparatus 71 can detect the composite state of the fifth composite plate j and the first electrode plate a. In this way, the quality of the first composite plate e can be strictly controlled, which can help to improve the quality of the electrode assembly 200.

The first image acquisition apparatus 71 and the fifth image acquisition apparatus 75 may be, but are not limited to, CCD (charge coupled device) cameras.

The following describes, with reference to FIG. 14, the winding device 100 according to some specific embodiments of the present application.

With reference to FIG. 14, the winding device 100 includes two production devices, namely a first device 101 and a second device 102. The first device 101 and the second device 102 are arranged in parallel. In the first device 101, the second electrode plate b, the first separator c and the second separator d are pressed together to form a fifth composite plate j. In the second device 102, the first electrode plate a and the fifth composite plate j are pressed together to form a first composite plate e.

With reference to FIG. 14, in the first device 101, the first separator c and the second separator d are tightly fitted to the two opposite surfaces of the second electrode plate b in the thickness direction, the first separator c, the second electrode plate b and the second separator d are pressed together to form the fifth composite plate j, and the fifth composite plate j is kept flattened and transferred to the second device 102. The fifth composite plate j being in a flattened state refers to a state in which the fifth composite plate j is not rolled up and can extend along a straight line. The fifth composite plate j enters the second device 102 and is pressed together with the first electrode plate a to form a first composite plate e. The first composite plate e is flattened and transferred to the winding mechanism 40 and is wound in the winding mechanism 40.

With reference to FIG. 14, in this way, a fifth composite plate j consisting of a first separator c, a second electrode plate b and a second separator d by stacking can be made through the first device 101, and the fifth composite plate j and the first electrode plate a are stacked and pressed together through the second device 102, so that the fifth composite plate j and the first electrode plate a are tightly fitted in sequence to form a first composite plate e, improving the structural stability and flatness of the first composite plate e.

With reference to FIG. 14, the first image acquisition apparatus 71 is used to detect the relative position between the second electrode plate b and the first electrode plate a in the first composite plate e. The first image acquisition apparatus 71 may be arranged along a conveying direction L on one side of the first combining mechanism 31. The first image acquisition apparatus 71 can be a laser sensor, an X-ray camera, a CCD (charge coupled device) visual sensor, etc. to accurately detect the relative position between the second electrode plate b and the first electrode plate a, thereby ensuring the fifth composite plate j and the first electrode plate being pressed together in the correct position. The fifth composite plate j and the first electrode plate a are pressed together by the first combining mechanism 31 to form a first composite plate e.

With reference to FIG. 14, in this way, the first image acquisition apparatus 71 confirms that the relative position of the second electrode plate b and the first electrode plate a is correct, avoiding problems after the first composite plate e is wound due to the poor relative position of the second electrode plate b and the first electrode plate a.

Before the second cutting mechanism 62 cuts off the second electrode plate b, the second electrode plate b extends along the conveying direction L, and a second insert feeding mechanism 98, a first conveying belt 14 and an adsorption plate sequentially adsorb the tail and head of the second electrode plate b along the conveying direction L. After the second electrode plate b is cut, the second insert feeding mechanism 98 and a first rectification apparatus 66 correct the positions of the head and tail of the second electrode plate b, the first conveying belt 14 and the adsorption plate adsorb the second electrode plate b. The second electrode plate b, the first separator c and the second separator d are stacked and combined by the fifth combining mechanism 35 to form a three-layer fifth composite plate j.

The fifth composite plate j enters the second device 102 through the transfer roller, and the third cutting mechanism 63 of the second device 102 cuts the first separator c and the second separator d in the fifth composite plate j, so that the sizes of the first separator c and the second separator d match that of the second electrode plate b. Before the first separator c and the second separator d are cut, a first insert feeding mechanism 97, a second conveying belt 15 and an adsorption plate sequentially adsorb the tail and the head of the fifth composite plate j along the conveying direction L. After the first separator c and the second separator d are cut, the first insert feeding mechanism 97 adsorbs a next fifth composite plate j, a second rectification apparatus 67 corrects the positions of the head and tail of the fifth composite plate j, and the second conveying belt 15 and the adsorption plate adsorb a previous fifth composite plate j. The first combining mechanism 31 in the second device 102 presses the fifth composite plate j and the first electrode plate a together to form a first composite plate e. The positions of the head and tail of the electrode component are detected and corrected by the first image acquisition apparatus 71.

The following describes, with reference to FIG. 15, the winding device 100 according to some specific embodiments of the present application.

Referring to FIG. 15, the winding device 100 includes a fifth combining mechanism 35, a first combining mechanism 31 and a first image acquisition apparatus 71. The fifth combining mechanism 35 is used for pressing the second electrode plate b and the separator, and the first combining mechanism 31 is used for pressing the second electrode plate b, the first electrode plate a and the separator.

Before the second electrode plate b and the separator are pressed together, a sixth conveying member 96 is provided. The sixth conveying member 96 can transfer the second electrode plate b. There is a negative pressure in adsorption holes formed on the sixth conveying member 96. The second electrode plate b can move stably to the area of the fifth combining mechanism 35 under the action of the sixth conveying member 96.

Before the second electrode plate b, the first electrode plate a and the separator are pressed together, a fourth conveying member 94 is provided. The fourth conveying member 94 can transfer the first electrode plate a. There is a negative pressure in adsorption holes formed on the fourth conveying member 94. The first electrode plate a can move stably to the area of the first combining mechanism 31 under the action of the fourth conveying member 94, so that the second electrode plate b, the first electrode plate a and the separator form a first composite plate e.

The first image acquisition apparatus 71 uses an X-ray camera to accurately detect the relative position of the second electrode plate b and the first electrode plate a, ensuring that the relative position of the second electrode plate b and the first electrode plate a is correct. Then, the first composite plate e is further conveyed to the area where the winding mechanism 40 is located, completing the winding of the electrode assembly 200.

The first image acquisition apparatus 71 is used to sequentially detect the relative positions of multiple portions in the length direction of the second electrode plate b and the first electrode plate a during the movement of the first composite plate e.

Specifically, the first image acquisition apparatus 71 can detect the positions of the head, tail and multiple points in the middle of the second electrode plate b in the length direction, and can detect the positions of the head, tail and multiple points in the middle of the first electrode plate a in the length direction. Based on the positions of multiple portions of the second electrode plate b and the first electrode plate a, it is possible to determine the relative positions of multiple portions of the second electrode plate b and the first electrode plate a in the length direction. For example, the relative position of the head of the second electrode plate b in the length direction and the head of the first electrode plate a in the length direction can be determined.

In this way, the first image acquisition apparatus 71 can detect the relative positions of multiple portions of the second electrode plate b and the first electrode plate a in the length direction, thereby improving the detection precision to ensure that the second electrode plate b and the first electrode plate a are in the correct position.

The first image acquisition apparatus 71 includes an X-ray camera. Specifically, the X-ray camera can detect the relative positions of multiple portions of the second electrode plate b and the first electrode plate a in the length direction, and the X-ray camera can penetrate the separator to detect the positions of multiple portions of the second electrode plate b located on the inner layer.

It can be understood that the X-ray camera has high resolution and can penetrate objects to detect multiple portions, thereby improving the relative position detection precision of multiple portions of the second electrode plate b and the first electrode plate a in the length direction.

The following describes, with reference to FIGS. 17, 23-28, the winding device 100 according to some specific embodiments of the present application.

Referring to FIG. 17, the first electrode plate a, the second electrode plate b and the first separator c are unwound. The first electrode plate a and the second electrode plate b cover the first separator c in the middle and are combined together through the first combining mechanism 31 to form a first composite plate e. Then, the first composite plate e passes through the sixth temporary storage mechanism 86 and is sealed with the second separator d through the sixth combining mechanism 36 to form a sixth composite plate k. The winding device 100 further includes a first image acquisition apparatus 71, a sixth image acquisition apparatus 76, a seventh image acquisition apparatus 77, an eighth image acquisition apparatus 78, a ninth image acquisition apparatus 791, and a tenth image acquisition apparatus 792.

Exemplarily, the first electrode plate a is a negative electrode plate, the second electrode plate b is a positive electrode plate; and in the first composite plate e, the second electrode plate b is stacked between the first separator c and the second separator d.

The seventh image acquisition apparatus 77 is installed after the negative electrode is unwound, and is used to detect the AT11 width of the back of the negative electrode, the electrode film width, and yellow-labeled defective products, metal leakage/breakage of the electrode plate, and other incoming material defects.

The ninth image acquisition apparatus 791 is installed after the positive electrode plate is unwound and is used to detect breakage of the positive electrode, electrode plate film width, yellow-labeled defective products, cracking/metal leak of the electrode plate and other incoming material defects. The ninth image acquisition apparatus 791 may belong to the ninth detection apparatus, where the ninth image acquisition apparatus 791 may be connected in communication with the processor 702, or the ninth detection apparatus may also be separately provided with a processor connected in communication with the ninth image acquisition apparatus 791.

The first image acquisition apparatus 71 is installed behind the sixth temporary storage mechanism 86 and in front of the sixth combining mechanism 36, and is used to detect composite defects such as breakage, crushing, and wrinkling of the positive electrode after combining.

The sixth image acquisition apparatus 76 is installed behind the sixth combining mechanism 36 and before the serpentine rectification. An upper sixth image acquisition apparatus 76 is used to detect the AT11 width of the front of the negative electrode, OH of the positive and negative electrodes, OH of the separator and the negative electrode, the separator misalignment, the folding and breakage of the negative electrode and other composite edge sealing defects. A lower sixth image acquisition apparatus 76 is used to detect crushing of the positive electrode, wrinkling of the separator, peeling of edge sealing and other edge sealing defects.

The eighth image acquisition apparatus 78 is installed behind the third cutting mechanism 63 and in front of the winding needle 42, and is used to detect the double-sided OH of the positive electrode covering the negative electrode of two adjacent circles of first composite plate e on the winding mechanism 40, thereby avoiding missed detection of OH.

The tenth image acquisition apparatus 792 is installed behind the third cutting mechanism 63 and in front of the winding needle 42, and is used to detect the double-sided OH of the positive electrode covering the negative electrode of the same circle of electrode assembly 200 on the winding mechanism 40, thereby avoiding missed detection of OH due to offset of the electrode plate or the overall composite material tape during winding. The tenth image acquisition apparatus 792 may belong to the tenth detection apparatus, where the tenth image acquisition apparatus 792 may be connected in communication with the processor 702, or the tenth detection apparatus may also be separately provided with a processor connected in communication with the tenth image acquisition apparatus 792.

With reference to FIG. 17, the first combining mechanism 31 may include two composite rollers arranged opposite to each other, and the two composite rollers can heat the first electrode plate a, the first separator c and the second electrode plate b and apply a predetermined pressure along the thickness direction F1 to make the first electrode plate a, the first separator c and the second electrode plate b bonded together, thereby achieving a composite connection of the first electrode plate a, the first separator c and the second electrode plate b.

Referring to FIG. 17, the sixth combining mechanism 36 is disposed downstream of the first combining mechanism 31 and the fourth feeding mechanism 22, so that the first composite plate e formed by the first combining mechanism 31 and the second separator d unwound by the fourth feeding mechanism 22 can be conveyed to the sixth combining mechanism 36 for edge sealing to obtain a sixth composite plate k, i.e., the unwound electrode assembly 200. That is, the second separator d and the first separator c in the first composite plate e are connected together. For example, the separators can be connected by methods such as heating, pressuring, or gluing.

The sixth combining mechanism 36 is used to seal the portion of the separator that extends beyond the edge of the second electrode plate b in the width direction F2 and the length direction F3, that is, the four side edges of the separator are sealed, so that the second electrode plate bis covered with the separators more tightly, and the effect of preventing the second electrode plate b from overlapping with the first electrode plate a and the second electrode plate b from overlapping with the shell 320 is better, which is conducive to reducing the risk of short circuit caused by the overlapping of the second electrode plate b and the first electrode plate a.

The sixth combining mechanism 36 may include four edge sealing rollers arranged opposite to each other. The four edge sealing rollers can heat the four side edges of the separators and apply a predetermined pressure along the thickness direction F1 to achieve edge sealing connection of the two layers of separators.

In the process of edge sealing connection, the portions where the two layers of separators are connected are sealed edges. According to actual needs, the sealed edges of the two layers of separators in the width direction F2 may extend continuously or discontinuously along the material conveying direction.

Referring to FIG. 17, the first image acquisition apparatus 71 is disposed downstream of the first combining mechanism 31 and is used for at least detecting the composite state of the first composite plate e.

The first image acquisition apparatus 71 can be arranged on one side or both sides of the material thickness direction F1 according to actual needs. For example, the first image acquisition apparatus 71 is arranged on either side of the first electrode plate a in the thickness direction F1 to detect parameters and other information of the active material layer on either side of the first electrode plate a (e.g., the negative electrode plate). For example, the first image acquisition apparatus 71 is arranged on either side of the material thickness direction F1 to detect information such as the relative position of the second electrode plate b and the first electrode plate a. For example, the first image acquisition apparatus 71 is arranged on one side of the first electrode plate a in the thickness direction F1 to detect information such as defects of the first electrode plate a itself. The first image acquisition apparatus 71 can sequentially detect multiple portions along the length direction F3 of the material during movement of the material, or can continuously detect along the length direction F3 of the material.

The first image acquisition apparatus 71 is arranged downstream of the first combining mechanism 31, so that the first electrode plate a, the first separator c and the second electrode plate b can be transferred to the first image acquisition apparatus 71 after being combined into the first composite plate e, so that the composite state of the first composite plate e can be detected by using the first image acquisition apparatus 71. For example, composite defects such as folding, breakage, crushing, and wrinkling of electrode plates and separators are detected.

In some related technologies, the detection on the electrode plate by the detector is poor in accuracy, which is prone to missed detection of OH (overhang, the exceeding part), and missed detection of defects such as corner folding and crushing of the electrode plate. According to the present application, the first image acquisition apparatus 71 detects the composite state, which can achieve more comprehensive detection and avoid defects being blocked and unable to be accurately detected after the first electrode plate a, the first separator c, the second electrode plate b and the second separator d are stacked to form the electrode assembly 200, thereby improving the detection precision and reducing the risk of missed detection during the production process of the electrode assembly 200.

The composite state of the first composite plate e includes states of the second electrode plate b (e.g., the positive electrode plate) and the first separator c. The state of the second electrode plate b includes, but is not limited to, the width of the active material layer of the second electrode plate b, known defective electrode plates (such as defective products with yellow labels), electrode plate breakage, etc. The state of the first separator c includes, but is not limited to, separator corner folding, breakage, etc. The states of the second electrode plate b and the first separator c include, but are not limited to, the OH of the first separator c covering the second electrode plate b, i.e., the size of the edge of the first separator c extending beyond the edge of the second electrode plate b in at least one direction of the width direction F2 and the length direction F3. The OH defect means that the size of the exceeding part does not meet the required size range.

Therefore, the first image acquisition apparatus 71 can be used to detect whether the width of the active material layer of the second electrode plate b meets a set range after combining and before edge sealing, and whether the second electrode plate b and the first separator c have composite defects such as crushing so as to discover the defects and reject the defects in time. The first image acquisition apparatus 71 can also detect whether the relative position of the second electrode plate b and the first separator c is accurate, such as detecting whether both sides of the first separator c in the width direction F2 and the length direction F3 can extend beyond the edge of the second electrode plate b by a sufficient size, thereby facilitating the subsequent edge sealing processing and reducing the risk of overlapping between the second electrode plate b and the first electrode plate a.

Referring to FIG. 17, the sixth image acquisition apparatus 76 is disposed downstream of the sixth combining mechanism 36 and is used for at least detecting the composite state of the sixth composite plate k.

The sixth image acquisition apparatus 76 is disposed downstream of the sixth combining mechanism 36, so that the first composite plate e and the second separator d can be conveyed to the first image acquisition apparatus 76 after edge sealing, and thus the first image acquisition apparatus 76 detects the state of the formed edge sealing. For example, edge sealing defects such as electrode plate corner folding, wrinkling at the head and tail, and separator misalignment can be detected. For example, the relative position of the sealed edge formed by the first separator c and the second separator d and the second electrode plate b can be detected, so that the separator and the sixth combining mechanism 36 can be adjusted according to the detection results, the width and position of the formed sealed edge meet the requirements of the separator covering the second electrode plate b, thereby improving the reliability of the edge sealing and enabling the separator to reliably limit and protect the second electrode plate b.

The sixth image acquisition apparatus 76 is used to detect the edge sealing state after the first electrode plate a, the first separator c, the second electrode plate b and the second separator d are stacked and the edges of the separators are sealed to form the electrode assembly 200, which can achieve more comprehensive detection, improve the reliability of the edge sealing connection, and reduce the risk of missed detection of defects during the production process of the electrode assembly 200.

Exemplarily, the sixth image acquisition apparatus 76 can also be used to detect the relative position of the first electrode plate a and the second electrode plate b, the relative position of the first separator c and the first electrode plate a, and the relative position of the second separator d and the second electrode plate b.

After the sixth image acquisition apparatus 76 detects the relative position of the first electrode plate a and the second electrode plate b and the first electrode plate a, the first separator c, the second electrode plate b and the second separator d are stacked and combined to obtain an electrode assembly 200, the relative position of the second electrode plate b and the first electrode plate a of the obtained electrode assembly 200 is accurate, for example, meeting the requirement that the two sides, in the width direction F2, of the second electrode plate b extend beyond the edge of the first electrode plate a by a certain distance, reducing the risk of missed detection of OH, and better solving the problem of lithium plating.

The sixth image acquisition apparatus 76 is also used to detect the relative position of the first separator c and the first electrode plate a, and the relative position of the second separator d and the second electrode plate b. The relative position of the first separator c and the first electrode plate a can be understood as the OH of the first separator c covering the first electrode plate a; the relative position of the second separator d and the second electrode plate b can be understood as the OH of the second separator d covering the second electrode plate b. “The OH of the first separator c covering the first electrode plate a” refers to the size by which the edge of the first separator c extends beyond the edge of the first electrode plate a in the width direction F2 and length direction F3. The OH defect means that the size of the exceeding part does not meet the required size range. The same principle applies to “the OH of the second separator d covering the second electrode plate b.”

Therefore, the sixth image acquisition apparatus 76 can detect whether the relative position of the first electrode plate a and the first separator c is accurate, and whether the relative position of the second electrode plate b and the second separator d is accurate after edges of the separators are sealed, thereby improving the position accuracy of the first electrode plate a, the first separator c, the second electrode plate b and the second separator d. The sixth image acquisition apparatus 76 can also detect whether both sides of the separator in the width direction F2 and the length direction F3 can extend beyond the edge of the electrode plate by a sufficient size, providing sufficient space for edge sealing and improving the effect of the separator in separating the second electrode plate b and the first electrode plate a.

Referring to FIG. 17, the seventh image acquisition apparatus 77 is located downstream of the first feeding mechanism 11 and upstream of the first combining mechanism 31. It can detect a single unobstructed first electrode plate a that has not been subjected to operations such as combining, and can detect the state of the first electrode plate a more accurately.

The state of the first electrode plate a includes, but is not limited to, the width of the active material layer on the surface of at least one side of the first electrode plate a in the thickness direction F1, known defective electrode plates (e.g., defective products with yellow labels), electrode plate breakage, etc. Since the state of the first electrode plate a is detected by the seventh image acquisition apparatus 77 before the first combining mechanism 31 performs combining, defective parts of the first electrode plate a can be discovered and rejected in time, thereby improving the quality of the first electrode plate a used in the electrode assembly 200.

The seventh image acquisition apparatus 77 may include one or more detectors. For example, in some embodiments, the seventh image acquisition apparatus 77 includes two detectors, and the two detectors are respectively arranged on both sides of the first electrode plate a in the thickness direction F1. The two detectors can detect the electrode plate state on the surfaces of both sides of the first electrode plate a in the thickness direction F1, achieving a higher detection precision for the state of the first electrode plate a.

Referring to FIG. 17, the seventh image acquisition apparatus 77 is disposed on the side of the first electrode plate a facing toward the first separator c and is used to detect the state of the first electrode plate a facing toward the first separator c. The sixth image acquisition apparatus 76 is used to detect the state of the first electrode plate a facing away from the first separator c.

The first electrode plate a is combined with the first separator c and the second electrode plate b through the first combining mechanism 31. The side of the first electrode plate a facing toward the first separator c is blocked by the first separator c and the second electrode plate b and is difficult to be detected. However, the present application uses the seventh image acquisition apparatus 77 disposed between the first feeding mechanism 11 and the first combining mechanism 31 to detect the electrode state of the first electrode plate a facing toward the first separator c before the first electrode plate a is combined, avoiding the defect of the first electrode plate a facing toward the first separator c being blocked and unable to be accurately detected after combining. Besides, the sixth image acquisition apparatus 76 disposed downstream of the first combining mechanism 31 is used to detect the state of the side of the first electrode plate a facing away from the first separator c, the state of both sides of the thickness direction F1 of the first electrode plate a is detected, thereby improving the detection precision and reducing the risk of missed detection of defects during the production process of the electrode assembly 200.

The seventh image acquisition apparatus 77 can detect the state of the electrode plate on the surface of one side of the first electrode plate a in the thickness direction F1, and the sixth image acquisition apparatus 76 can detect the state of the electrode plate on the surface of the other side of the first electrode plate a in the thickness direction F1. This is conducive to realizing the detection of the electrode plate states on both sides of the thickness direction F1 of the first electrode plate a while eliminating one detector at the seventh image acquisition apparatus 77, which is more economical.

With reference to FIG. 23, the active material layer of the first electrode plate a includes a first film region a1 and a second film region a2. The second film region a2 is located on a side of the first film region a1 close to a tab of the first electrode plate a. The state of the first electrode plate a includes: the width of the first film region a1, as well as the width of the second film region a2, on a side of the first separator a facing toward the first separator c, and defects of the first electrode plate a.

The second film region a2 may be made of an AT11 material, and the first film region a1 may be made of a material such as lithium cobalt oxide, lithium iron phosphate, ternary lithium or lithium manganate. The second film region a2 is provided to prevent burrs from forming on the first electrode plate a in the process of cutting the tab. The OH of the second electrode plate b covering the first electrode plate a refers to the active material layer of the second electrode plate b and the first film region a1 of the first electrode plate a, excluding the second film region a2 of the first electrode plate a.

The state of the first electrode plate a includes but is not limited to the width of the first film region a1 as well as the width of the second film region a2, on the side of the first electrode plate a facing toward the first separator c, known defective electrode plates (e.g., defective plates with yellow labels), electrode plate breakage, etc. The seventh image acquisition apparatus 77 can be used to detect whether the widths of the first film region a1 and the second film region a2 meet the set range, so that the first electrode plate a has the first film region a1 and the second film region a2 of appropriate widths. Through detection by the seventh image acquisition apparatus 77, the defective parts of the first electrode plate a can be discovered and rejected in time, thereby improving the quality of the first electrode plate a used for the electrode assembly 200.

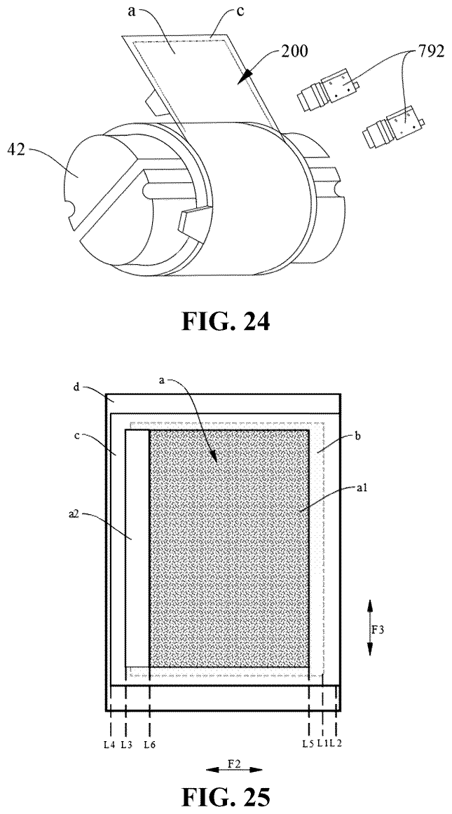

With reference to FIGS. 17 and 24, the tenth image acquisition apparatus 792 is disposed on one side of the winding mechanism 40 and is used to detect the relative position of the second electrode plate b and the first electrode plate a of the same circle of electrode assembly 200 on the winding mechanism 40.

The tenth image acquisition apparatus 792 is used to detect the relative position of the second electrode plate b and the first electrode plate a of the same circle of electrode assembly 200 after winding, such as detecting whether the second electrode plate b extends beyond the edge of the first electrode plate a on one side or both sides in the width direction F2, so that the second electrode plate b and the first electrode plate a of the electrode assembly 200 after winding are better resistant to lithium plating, further reducing the risk of missed detection of OH and improving the quality of the electrode assembly 200. Furthermore, the tenth image acquisition apparatus 792 can accurately detect the relative position of the second electrode plate b and the first electrode plate a of the same circle of electrode assembly 200 when the electrode assembly 200 on the winding mechanism 40 is tightened. For example, when the separator in the electrode assembly 200 is tightened, the tenth image acquisition apparatus 792 can penetrate the separator more easily to detect the position of the electrode plate, achieving higher detection precision.

The active material layer of the first electrode plate a includes a first film region a1 and a second film region a2. The second film region a2 is located on a side of the first film region a1 close to a tab of the first electrode plate a. The tenth image acquisition apparatus 792 is used to detect a distance between an edge of one side of the second electrode plate b away from the second film region a2 and an edge of the corresponding side of the first separator c, a distance between an edge of one side of the first film region a1 away from the second film region a2 and an edge of the corresponding side of the second electrode plate b, and a distance between an edge of one side of the second film region a2 away from the first film region a1 and an edge of the corresponding side of the first separator c. The sixth image acquisition apparatus 76 is used to detect the distance between an edge of one side of the first film region a1 close to the second film region a2 and an edge of the corresponding side of the second electrode plate b.

When the unwound electrode assembly 200 is wound by the winding mechanism 40, the second film region a2 of the first electrode plate a may or may not extend beyond the edge of the second electrode plate b in the width direction F2. When the second film region a2 of the first electrode plate a does not extend beyond the edge of the second electrode plate b, the OH of both sides of the second electrode plate b covering the first electrode plate a can be detected by the tenth image acquisition apparatus 792. When the second film region a2 of the first electrode plate a extends beyond the edge of the second electrode plate b, the edge of one side of the second electrode plate b close to the second film region a2 is blocked by the first electrode plate a, and the tenth image acquisition apparatus 792 can only detect the OH of one side of the second electrode plate b covering the first electrode plate a. However, in conjunction with the sixth image acquisition apparatus 76, the sixth image acquisition apparatus 76 can detect the OH of the other side of the second electrode plate b covering the first electrode plate a, so as to obtain the OH of both sides of the second electrode plate b covering the first electrode plate a. Therefore, the tenth image acquisition apparatus 792 and the sixth image acquisition apparatus 76 can cooperate to detect the OH of the first separator c covering the second electrode plate b, the OH of the second electrode plate b covering the first electrode plate a, and the OH of the first separator c covering the first electrode plate a after combining and edge sealing.

Referring to FIG. 25, the distance between a dotted line L1 and a dotted line L2 in the figure represents the distance between the edge of one side of the second electrode plate b away from the second film region a2 and the edge of the corresponding side of the first separator c, that is, the OH of one side, in the width direction F2, of the first separator c covering the second electrode plate b; the distance between a dotted line L3 and a dotted line L4 in the figure represents the distance between the edge of one side of the second film region a2 away from the first film region a1 and the edge of the corresponding side of the first separator c, that is, the OH of the other side, in the width direction F2, of the first separator c covering the first electrode plate a. The tenth image acquisition apparatus 792 is used to detect the OH of one side, in the width direction F2, of the first separator c covering the second electrode plate b and the OH of the other side, in the width direction F2, of the first separator c covering the first electrode plate a, which is conducive to ensuring the effect of the first separator c separating the first electrode plate a and the second electrode plate b, and reducing the risk of short circuit caused by overlapping of the second electrode plate b and the first electrode plate a.

The distance between a dotted line L5 and a dotted line L1 in FIG. 25 represents the distance between the edge of one side of the first film region a1 away from the second film region a2 and the edge of the corresponding side of the second electrode plate b, i.e., the OH of one side (the side away from the tab of the first electrode plate a), in the width direction F2, of the second electrode plate b covering the first film region a1 of the first electrode plate a. The OH of one side, in the width direction F2, of the second electrode plate b covering the first film region a1 of the first electrode plate a is detected by the tenth image acquisition apparatus 792, which is conducive to meeting the requirement that one side of the second electrode plate in the width direction F2 extends beyond the first film region a1 of the first electrode plate a by a certain distance, and reducing the risk of missed detection of OH.

Moreover, since the sixth image acquisition apparatus 76 is provided, the sixth image acquisition apparatus 76 can detect the distance between the edge of one side of the first film region a1 close to the second film region a2 and the edge of the corresponding side of the second electrode plate b after combining and edge sealing, i.e., the OH of the other side, in the width direction F2, of the second electrode plate b covering the second film region a2 of the first electrode plate a, which is conducive to meeting the requirement that the other side of the second electrode plate b in the width direction F2 extends beyond the first film region a1 of the first electrode plate a by a certain distance, thereby further reducing the risk of missed detection of OH.

Therefore, the tenth image acquisition apparatus 792 and the sixth image acquisition apparatus 76 can cooperate to detect the OH of the first separator c covering the second electrode plate b, the OH of the second electrode plate b covering the first electrode plate a, and the OH of the first separator c covering the first electrode plate a after combining and edge sealing, thereby reducing the risk of missed detection of OH.

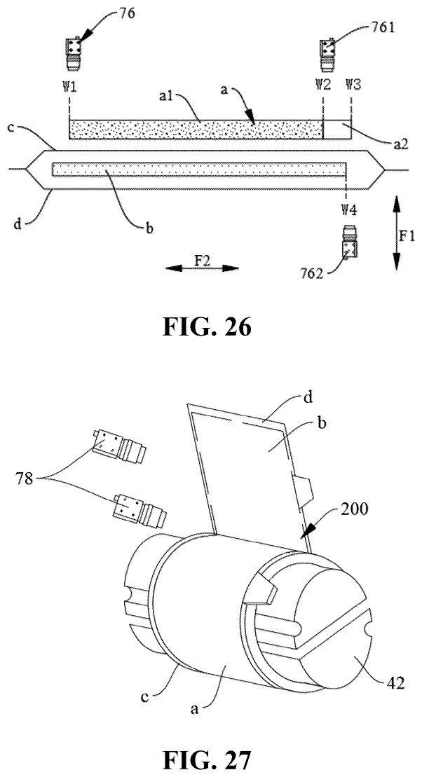

As shown in FIG. 17 and FIG. 26, the sixth image acquisition apparatus 76 includes a first detector 761 and a second detector 762. The first detector 761 is arranged on a side of the first electrode plate a facing away from the first separator c. The first detector 761 is at least used to detect the edge position of the first film region a1 away from the second film region a2, the edge position of the first film region a1 close to the second film region a2, and the edge position of the second film region a2 away from the first film region a1. The second detector 762 is disposed on aside of the second separator d facing away from the second electrode plate b. The second detector 762 is at least used to detect the position of the edge of the second electrode plate b on the side corresponding to the second film region a2.

Referring to FIG. 26, the first detector 761 and the second detector 762 are arranged on both sides of the unwound electrode assembly 200 in the thickness direction F1. The first detector 761 can detect the edges of the first film region a1 and the second film region a2 on the first electrode plate a in the width direction F2. The second detector 762 can detect the edge of the second electrode plate b close to the second film region a2. This is conducive to detecting whether the relative position of the second electrode plate b and the first electrode plate a is accurate after combining and edge sealing, such as detecting whether the requirement that one side of the second electrode plate b in the width direction F2 extends beyond the edge of the first electrode plate a by a certain distance is met.

Referring to FIG. 26, the edge position of the first film region a1 away from the second film region a2 is shown as a dotted line W1 in the figure, the edge position of the first film region a1 close to the second film region a2 is shown as the dotted line W2 in the figure, the edge position of the second film region a2 away from the first film region a1 is shown as the dotted line W3 in the figure, and the position of the edge of the second electrode plate b on the side corresponding to the second film region a2 is shown as a dotted line W4 in the figure. The distance between the dotted line W2 and the dotted line W4 in the figure represents the OH of one side, in the width direction F2, of the second electrode plate b extending beyond the second film region a2.

Therefore, the first detector 761 and the second detector 762 cooperate to detect whether the relative position of the second electrode plate b and the first electrode plate a after combining and edge sealing is accurate, such as whether the requirement that one side of the second electrode plate b in the width direction F2 extends beyond the edge of the first electrode plate a by a certain distance is met, thereby reducing the risk of missed detection of OH and solving the problem of lithium plating more effectively.

The detection mechanism may include a linear array camera or an area array camera, where the image acquisition range of the linear array camera is large, so as shown in FIG. 5, a linear array camera can be arranged in the center on either side of the material thickness direction F1; the image acquisition range of the area array camera is small, so as shown in FIG. 26, an area array camera can be arranged at either end of the electrode plate on one side of the material thickness direction F1, and an area array camera can be arranged at the corresponding part of the second film region a2 on the other side of the material thickness direction F1. OH of the edge of one side of the second electrode plate b corresponding to the second film region a2 extending beyond the first film region a1 can be detected, and there is a wide range of selection for detection mechanism types.

It should be noted that after combining and edge sealing, the first electrode plate a, the first separator c, the second electrode plate b and the second separator d are stacked together, where the first electrode plate a, the first separator c and the second electrode plate b are combined and connected together. In order to clearly show the relative positions of the materials, the first electrode plate a, the first separator c and the second electrode plate b are spaced by a certain gap, as shown in FIG. 26.

Refer to FIGS. 17 and 27. The eighth image acquisition apparatus 78 is disposed on one side of the winding mechanism 40 and is used to detect the relative position of the second electrode plate b and the first electrode plate a of two adjacent circles of electrode assembly 200 on the winding mechanism 40.

The eighth image acquisition apparatus 78 is used to detect the relative position of the second electrode plate b and the first electrode plate a of the two adjacent circles of electrode assembly 200 after winding, so that the second electrode plate b and the first electrode plate a of the electrode assembly 200 after winding are better resistant to lithium plating, further reducing the risk of missed detection of OH and improving the quality of the electrode assembly 200.

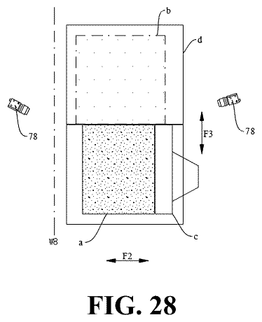

In some embodiments, as shown in FIGS. 27 and 28, the eighth image acquisition apparatus 78 is disposed toward the electrode assembly 200 in front of the winding mechanism 40 and a junction 250 of the electrode assembly 200 on the winding mechanism 40. Here, the eighth image acquisition apparatus 78 is used to detect the position of the second electrode plate b of the electrode assembly 200 in front of the winding mechanism 40 and the position of the first electrode plate a of the electrode assembly 200 on the winding mechanism 40. Alternatively, the eighth image acquisition apparatus 78 is used to detect the position of the first electrode plate a of the electrode assembly 200 in front of the winding mechanism 40 and the position of the second electrode plate b of the electrode assembly 200 on the winding mechanism 40.

The front electrode assembly 200 in front of the winding mechanism 40 refers to the part that is about to be wound onto the winding mechanism 40, i.e., the electrode assembly 200 of the outer circle in the two adjacent circles of electrode assembly 200; the electrode assembly 200 on the winding mechanism 40 refers to the part that has just been wound onto the winding mechanism 40, i.e., the electrode assembly 200 of the inner circle in the two adjacent circles of electrode assembly 200. Therefore, the eighth image acquisition apparatus 78 can detect the relative position of the second electrode plate b and the first electrode plate a of any two adjacent circles in multiple circles of the electrode assembly 200 during the winding process, thereby achieving comprehensive detection of the entire wound electrode assembly 200 and better reducing missed detection of OH.

The eighth image acquisition apparatus 78 is arranged toward the junction between the electrode assembly 200 in front of the winding mechanism 40 and the electrode assembly 200 on the winding mechanism 40, which means that the detection area of the eighth image acquisition apparatus 78 is toward the junction, and can simultaneously detect the electrode assembly 200 in front of the winding mechanism 40 and the electrode assembly 200 on the winding mechanism 40, without having to provide detectors for the electrode assembly 200 in front of the winding mechanism 40 and the electrode assembly 200 on the winding mechanism 40 respectively, which is conducive to saving one detector and has better economy.

The eighth image acquisition apparatus 78 is used to detect the position of the second electrode plate b of the electrode assembly 200 in front of the winding mechanism 40 and the position of the first electrode plate a of the electrode assembly 200 on the winding mechanism 40, or the eighth image acquisition apparatus 78 is used to detect the position of the second electrode plate b of the electrode assembly 200 in front of the winding mechanism 40 and the position of the first electrode plate a of the electrode assembly 200 on the winding mechanism 40. That is, the stacking order of the second electrode plate b and the first electrode plate a in the electrode assembly 200 can be flexibly set, and the eighth image acquisition apparatus 78 has strong adaptability to electrode assemblies 200 with different stacking orders.

For example, as shown in FIGS. 27 and 28, in each circle of the electrode assembly 200, from the outside to the inside along a radial direction of the winding mechanism 40 are the first electrode plate a, the first separator c, the second electrode plate b and the second separator d. In this case, the second electrode plate b on the radial inner side of the electrode assembly 200 in front of the winding mechanism 40 is easy to detect and the first electrode plate a on the radial outer side of the electrode assembly 200 on the winding mechanism 40 is easy to detect. Therefore, the eighth image acquisition apparatus 78 is used to detect the position of the second electrode plate b of the electrode assembly 200 in front of the winding mechanism 40 and the position of the first electrode plate a of the electrode assembly 200 on the winding mechanism 40, which is conducive to improving the detection accuracy.

For example, in each circle of the electrode assembly 200, from the outside to the inside along a radial direction of the winding mechanism 40 are the second separator d, the second electrode plate b, the first separator c and the first electrode plate a. In this case, the first electrode plate a on the radial inner side of the electrode assembly 200 in front of the winding mechanism 40 is easy to detect and the second electrode plate b on the radial outer side of the electrode assembly 200 on the winding mechanism 40 is easy to detect. Therefore, the eighth image acquisition apparatus 78 is used to detect the position of the first electrode plate a of the electrode assembly 200 in front of the winding mechanism 40 and the position of the second electrode plate b of the electrode assembly 200 on the winding mechanism 40, which is conducive to improving the detection accuracy.

Referring to FIG. 17, the ninth image acquisition apparatus 791 is disposed between the second feeding mechanism 12 and the first combining mechanism 31, and is used to detect the state of the second electrode plate b (e.g., the positive electrode plate).

The second feeding mechanism 12 can carry and release the second electrode plate b. The ninth image acquisition apparatus 791 is arranged between the second feeding mechanism 12 and the first combining mechanism 31, that is, the ninth image acquisition apparatus 791 is arranged downstream of the second feeding mechanism 12 and upstream of the first combining mechanism 31, and can detect the unobstructed second electrode plate b that has not undergone operations such as combining, and can detect the state of the second electrode plate b more accurately.

The state of the second electrode plate b includes, but is not limited to, the width of the active material layer of the second electrode plate b, known defective electrode plates (such as defective products with yellow labels), electrode plate breakage, etc. Through detection by the ninth image acquisition apparatus 791, defective parts of the second electrode plate b can be discovered and rejected in a timely manner, thereby improving the quality of the second electrode plate b used for the electrode assembly 200 and reducing material waste during subsequent rejection. For example, if a defective part of the second electrode plate b is detected before combining, only the part of the second electrode plate b needs to be removed. If a defective part of the second electrode plate b is detected in the first composite plate e after combining, the first electrode plate a and the first separator c combined with the second electrode plate b need to be rejected together. Therefore, by detecting the state of the second electrode plate b before combining through the ninth image acquisition apparatus 791, the waste of the first electrode plate a and the first separator c can be at least reduced, and the subsequent continuous unwinding of the second separator d can be facilitated and the connection between a plurality of unwound electrode assemblies 200 can be achieved through the second separator d.

In some embodiments, a mechanism for cutting off the material may be arranged downstream of the first image acquisition apparatus 71, the seventh image acquisition apparatus 77, and the ninth image acquisition apparatus 791, so as to promptly reject defective parts of the material according to the detection results of the detection mechanism, thereby improving the quality of the material.

Referring to FIG. 17, the winding device 100 may further include a third rectification apparatus 68, which is disposed between the sixth combining mechanism 36 and the winding mechanism 40. When the eighth image acquisition apparatus 78 detects that the second electrode plate b and the first electrode plate a of two adjacent circles of electrode assembly 200 are offset, the third rectification apparatus 68 can be used to correct the conveying position of the tape-shaped electrode assembly 200 to correct the relative position of the two circles of electrode assembly 200 after winding, thereby reducing missed detection of OH caused by electrode plate offset of the electrode plates or the overall offset of the composite electrode assembly 200.

Referring to FIG. 17, the winding device 100 further includes a third cutting mechanism 63 and a sixth temporary storage mechanism 86. The third cutting mechanism 63 is disposed between the sixth combining mechanism 36 and the winding mechanism 40 and is used to cut off the electrode assembly 200. The sixth temporary storage mechanism 86 is disposed between the first combining mechanism 31 and the sixth combining mechanism 36 and is used for temporary storage of the first composite plate e.

The third cutting mechanism 63 may include cutting rollers, cutting knives and other components, which only need to be able to cut off the electrode assembly 200. The third cutting mechanism 63 is arranged between the sixth combining mechanism 36 and the winding mechanism 40, and can cut the unwound tape-shaped electrode assembly 200 into multiple independent electrode assemblies 200. The sixth temporary storage mechanism 86 can store the first composite plate e formed by the first combining mechanism 31 through winding, stacking, or similar methods.

During production, the sixth temporary storage mechanism 86 stores the material temporarily and can continuously transfer the material downstream, so that the second cutting mechanism 63 can work without slowdown and will not be affected by the combining operation performed upstream of the sixth temporary storage mechanism 86. The composite precision requirement is relatively high, resulting in a low operating speed. The sixth temporary storage mechanism 86 is used for temporary storage of the first composite plate e after the first electrode plate a, the first separator c and the second electrode plate b are combined. The third cutting mechanism 63 is used to cut the second separator d connected between adjacent electrode assemblies 200, where the precision requirement is low and the operating speed is high. Through temporary storage of the sixth temporary storage mechanism 86, the combining speed of the first combining mechanism 31 is reduced. The sixth temporary storage mechanism 86 can stably and continuously transfer the first composite plate e to the sixth combining mechanism 36 without reducing the edge sealing rate, and then the third cutting mechanism 63 can cut the tape-shaped electrode assembly 200 without slowdown, thereby improving the winding efficiency and improving the overall production capacity.

Referring to FIG. 17, the winding device 100 further includes a detection mechanism and a calibration mechanism. The detection apparatus includes at least one of the group of the first image acquisition apparatus 71, the sixth image acquisition apparatus 76, the seventh image acquisition apparatus 77, the tenth image acquisition apparatus 792, the eighth image acquisition apparatus 78, and the ninth image acquisition apparatus 791. The calibration mechanism is arranged on one side of the detection mechanism and is used to detect the position of the detection mechanism and issue a prompt message when the position of the detection mechanism is offset. The calibration mechanism is also used to provide a reference line (e.g., as shown by a dotted line W8 in FIG. 28). The detection mechanism detects the positions of the second electrode plate b, the first electrode plate a, the first separator c and the second separator d based on the reference line.

The detection mechanism may include one or more of the group of the first image acquisition apparatus 71, the sixth image acquisition apparatus 76, the seventh image acquisition apparatus 77, the tenth image acquisition apparatus 792, the eighth image acquisition apparatus 78 and the ninth image acquisition apparatus 791. The detection mechanism may also include other detection mechanisms in addition to the first image acquisition apparatus 71, the sixth image acquisition apparatus 76, the seventh image acquisition apparatus 77, the tenth image acquisition apparatus 792, the eighth image acquisition apparatus 78 and the ninth image acquisition apparatus 791. The calibration mechanism is arranged corresponding to at least one of the detection mechanisms.

In some related technologies, the detection mechanism is installed by means of a cantilever bracket. During long-term use, the cantilever bracket may be deformed, loosened, worn, and other problems may occur, resulting in distortion of the data collected by the detection mechanism, such as variation in the resolution of the detection mechanism. According to the present application, the calibration mechanism is provided, and can detect the position of the detection mechanism during its use, and issue a prompt message and stop the detection mechanism when the position of the detection mechanism is offset, prompting the staff to make adjustments, which is conducive to reducing the risk of distortion of data collected by the detection mechanism and improving the detection precision of the detection mechanism.

The calibration mechanism is also used to provide a reference line so that the detection mechanism can determine the material position based on the reference line and the data of the edge of the material such as the second electrode plate b, the first electrode plate a, the first separator c and the second separator d. For example, the data of the reference line and the edge of the second electrode plate b are detected and the data are theoretically calculated to obtain the distance between the reference line and the edge of the second electrode plate b to determine the position of the second electrode plate b. Moreover, the reference line will not shift due to the position offset of the detection mechanism, the material offset, etc., so that the material position obtained through the reference line is more accurate, the detection precision of the detection mechanism is improved, and it is beneficial to calibrate the position of the detection mechanism through the reference line to determine whether the detection mechanism is offset or loose, thereby improving the detection accuracy of the calibration mechanism on the position of the detection mechanism.

For example, in some embodiments, each detection mechanism is arranged in correspondence with a calibration mechanism, so that the detection accuracy of each detection mechanism is improved. In some embodiments, the reference line of the calibration mechanism runs through the entire field of view of the detection mechanism, making it easier for the detection mechanism to detect the position of the reference line. In some embodiments, the calibration mechanism includes a laser aligner or a fixed-size calibration block to detect the position of the calibration mechanism. For example, after adjusting the brightness and angle of a light source of the detection mechanism to the best effect, each pixel point of the detection mechanism is calibrated using the laser calibrator or fixed-size calibration block to determine a value range of the optimal position of the detection mechanism. When the resolution of a single pixel point of the detection mechanism changes, it means that the detection mechanism has been skewed, and the calibration mechanism will issue a prompt message to remind the staff to adjust the position of the detection mechanism.

Therefore, in the above technical solution, with the calibration mechanism, the position of the detection mechanism can be detected during the use of the detection mechanism, reducing the risk of problems such as the detection mechanism being offset, and helping to reduce the risk of data distortion caused by the position offset of the detection mechanism. The calibration mechanism can provide a reference line, which brings convenience for the detection mechanism to determine the material position based on the reference line. The reference line will not be offset due to the position offset of the detection mechanism, which is conducive to calibrating the position of the detection mechanism based on the reference line to determine whether the detection mechanism is offset, thereby improving the position accuracy and detection precision of the detection mechanism.

The following describes, with reference to FIG. 18, the winding device 100 according to some specific embodiments of the present application.

Referring to FIG. 18, the winding device 100 provided in a first embodiment of the present application includes a first feeding mechanism 11, a third feeding mechanism 21, a second feeding mechanism 12, a fourth feeding mechanism 22, a first combining mechanism 31, a sixth combining mechanism 36 and a winding mechanism 40. The winding device 100 further includes a first cutting mechanism 61, a second cutting mechanism 62, a third cutting mechanism 63 and a sixth temporary storage mechanism 86. The first feeding mechanism 11, the third feeding mechanism 21 and the second feeding mechanism 12 are arranged on a feed side of the first combining mechanism 31, the winding mechanism 40 is arranged on a discharge side of the first combining mechanism 31, and the sixth temporary storage mechanism 86 is arranged downstream of the first combining mechanism 31; the fourth feeding mechanism 22 is arranged downstream of the first combining mechanism 31, and the winding mechanism 40 includes a turret 41 and a plurality of winding needles 42.

The working principle of the winding device 100 is as follows: the first electrode plate a, the second electrode plate b and the first separator c are unwound, and the first electrode plate a and the second electrode plate b cover the first separator c in the middle and are combined together through the first combining mechanism 31 to form a first composite plate e. The first image acquisition apparatus 71 is used to detect whether the first composite plate e has defects. During subsequent transmission and winding, the first electrode plate a, the second electrode plate b and the first separator c will not misalign relative to each other; then, the first composite plate e passes through the sixth temporary storage mechanism 86 and merges with the second separator d through the sixth combining mechanism 36 to form a sixth composite plate k. The sixth image acquisition apparatus 76 detects whether the sixth composite plate k has defects, which can guide the separator rectification.

The following describes, with reference to FIG. 19, the winding device 100 according to some specific embodiments of the present application.

With reference to FIG. 19, compared with the embodiment shown in FIG. 18, the third cutting mechanism 63 is located upstream of the winding mechanism 40, and the winding device 100 further includes a first conveying member 91 disposed between the third cutting mechanism 63 and the winding mechanism 40.

The working principle of the winding device 100 is as follows: the first electrode plate a, the second electrode plate b and the first separator c are unwound, and the first electrode plate a and the second electrode plate b cover the first separator c in the middle and are combined together through the first combining mechanism 31 to form a first composite plate e. The first image acquisition apparatus 71 is used to detect the first composite plate e. During subsequent transmission and winding, the first electrode plate a, the second electrode plate b and the first separator c will not misalign relative to each other; then, the first composite plate e passes through the sixth temporary storage mechanism 86 and merges with the second separator d to form a sixth composite plate k. The sixth image acquisition apparatus 76 detects the sixth composite plate k, which can guide the separator rectification.

The following describes, with reference to FIG. 20, the winding device 100 according to some specific embodiments of the present application.

With reference to FIG. 20, compared with the embodiment shown in FIG. 19, the fourth feeding mechanism 22 is disposed on one side of the winding mechanism 40, and the winding needle 42 on the winding station 4101 is used to allow the second separator d and the first composite plate e to merge. The first electrode plate a, the second electrode plate b and the first separator c are unwound, and the first electrode plate a and the second electrode plate b cover the first separator c in the middle and are combined together through the first combining mechanism 31 to form a first composite plate e. The first composite plate e is detected by the first image acquisition apparatus 71; the first composite plate e and the second separator d are respectively fed into the winding needle 42.

The following describes, with reference to FIG. 21, the winding device 100 according to some specific embodiments of the present application.

With reference to FIG. 21, compared with the embodiment shown in FIG. 20, there are two third cutting mechanisms 63, one third cutting mechanism 63 is disposed between the first combining mechanism 31 and the winding mechanism 40 and is used to cut the first separator c, and the other third cutting mechanism 63 is disposed between the fourth feeding mechanism 22 and the winding mechanism 40 and is used to cut the second separator d. The winding device 100 may further include a second conveying member 92 and a third conveying member 93 respectively arranged between the two third cutting mechanisms 63 and the winding mechanism 40. The first electrode plate a, the second electrode plate b and the first separator c are unwound, and the first electrode plate a and the second electrode plate b cover the first separator c in the middle and are combined together through the first combining mechanism 31 to form a first composite plate e. The first composite plate e is detected by the first image acquisition apparatus 71; and then the first composite plate e and the second separator d are respectively fed into the winding needle 42.

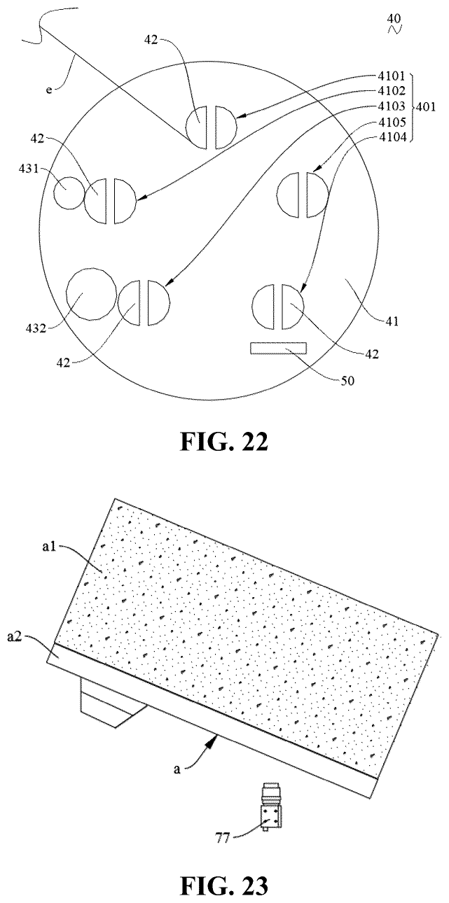

The following describes, with reference to FIG. 22, the winding mechanism 40 according to some specific embodiments of the present application.

With reference to FIG. 22, in some embodiments, the winding mechanism 40 includes a turret 41 and a winding needle 42. The turret 41 is provided with a plurality of workstations 401, and the plurality of workstations 401 are sequentially distributed along the circumferential direction of the turret 41. The winding needle 42 is disposed on the turret 41 and can rotate to each workstation 401 in sequence along with the turret 41. The turret 41 is a device capable of driving the winding needle 42 to rotate. The winding needle 42 is a component capable of rotating to wind the electrode assembly 200.

Based on the above structure, under the rotation of the turret 41, the winding needle 42 can rotate with the turret 41 to the plurality of workstations 401 in sequence, so as to perform corresponding processing operations at each workstation 401. In this way, the first composite plate e can be wound to form the electrode assembly 200 after passing through multiple workstations 401 in sequence, thereby ensuring the molding quality of the electrode assembly 200 to a certain extent.

In some embodiments, referring to FIG. 22, there are a plurality of winding needles 42, and the plurality of winding needles 42 are sequentially arranged on the turret 41 along the circumferential direction, and the plurality of winding needles 42 can be located at the plurality of workstations 401, respectively.

The plurality of winding needles 42 are respectively located at the plurality of workstations 401, so that the plurality of winding needles 42 can perform processing operations at the corresponding workstations 401, thereby improving the winding efficiency of the winding mechanism 40 and improving the production efficiency of the electrode assembly 200.

As an example, as shown in FIG. 22, the number of workstations 401 is the same as the number of winding needles 42, and the plurality of winding needles 42 can be located in a one-to-one correspondence at the plurality of workstations 401.

Since the assembly operation and the winding operation of the positive and negative plates are set separately, there is no need to combine and wind at the winding needles 42 of the winding mechanism 40 intensively, so that there may be a large space between the corresponding feeding mechanism and the winding mechanism 40. Since there is a large space near the winding mechanism 40, which can be used to arrange the above-mentioned winding needles 42 and workstations 401. This is conducive to improving the production efficiency of the electrode assembly 200.

In some embodiments, referring to FIG. 22, the plurality of workstations 401 include a winding workstation 4101 and a gluing workstation 4103. One winding needle 42 at the winding workstation 4101 is used to wind the first composite plate e, and one winding needle 42 at the gluing workstation 4103 is used to glue the electrode assembly 200.

It can be understood that the number of the above-mentioned workstations 401 is at least two, where the two workstations 401 are the winding workstation 4101 and the gluing workstation 4103 respectively.

Based on the above structure, when the winding mechanism 40 works, the turret 41 first rotates to rotate the winding needle 42 to the winding station 4101, and the winding needle 42 winds the first composite plate e at the winding station 4101 to form the electrode assembly 200. Then, the turret 41 rotates to rotate the winding needle 42 and the electrode assembly 200 thereon to the gluing station 4103 for the electrode assembly 200 to undergo final gluing. In this way, the problem of the electrode assembly 200 being scattered can be alleviated, ensuring the quality of the electrode assembly 200 to a certain extent.

In some embodiments, referring to FIG. 22, the winding mechanism 40 may further include a gluing roller 432. The gluing roller 432 is located at the gluing station 4103 and is used to apply glue to the electrode assembly 200.

Based on the above structure, when the winding needle 42 and the electrode assembly 200 thereon rotate to the gluing station 4103, the electrode assembly 200 will slide relative to the gluing roller 432 under the rotation of the turret 41, so that the gluing roller 432 can glue the electrode assembly 200.

In some embodiments, referring to FIG. 22, the direction of rotation of the gluing roller 432 is opposite to that of the turret 41, so that the gluing roller 432 can apply glue to the electrode assembly 200 during the rotation of the turret 41.

In some embodiments, referring to FIG. 22, the plurality of workstations 401 may further include a finishing workstation 4102. The winding workstation 4101, the finishing workstation 4102, and the gluing workstation 4103 are sequentially distributed along the circumferential direction. The winding needle 42 is used at the finishing workstation 4102 to finish the electrode assembly 200.

It can be understood that the number of workstations 401 mentioned above is at least three, where the three workstations 401 include the winding station 4101, the finishing station 4102, and the adhesive application station 4103.

Based on the above structure, when the winding mechanism 40 works, the turret 41 first rotates to rotate the winding needle 42 to the winding station 4101, and the winding needle 42 winds the first composite plate e at the winding station 4101 to form the electrode assembly 200. Then, the turret 41 rotates to rotate the winding needle 42 and the electrode assembly 200 thereon to the finishing station 4102 for the electrode assembly 200 to undergo finishing. Then, the turret 41 rotates to rotate the winding needle 42 and the electrode assembly 200 thereon to the gluing station 4103 for the electrode assembly 200 to undergo gluing.

In this way, by adding the finishing station 4102, the electrode assembly 200 can be finished, which facilitates the subsequent gluing of the electrode assembly 200 and alleviates the problem of the electrode assembly 200 being scattered, ensuring the quality of the electrode assembly 200 to a certain extent.

In some embodiments, referring to FIG. 22, the winding mechanism 40 may further include a finishing roller 431. The finishing roller 431 is located at the finishing station 4102 and is used to finish the electrode assembly 200.

Based on the above structure, when the winding needle 42 and the electrode assembly 200 thereon rotate to the finishing station 4102, the electrode assembly 200 will slide relative to the finishing roller 431 under the rotation of the turret 41, so that the finishing roller 431 rolls the finishing position of the electrode assembly 200 to achieve the finishing of the electrode assembly 200, facilitating the smooth progress of the subsequent gluing operation of the electrode assembly.

In some embodiments, referring to FIG. 22, the direction of rotation of the finishing roller 431 is opposite to that of the turret 41, so that the finishing roller 431 can perform finishing operation to the electrode assembly 200 during the rotation of the turret 41.

In some embodiments, as shown in FIG. 22, the plurality of workstations 401 may further include a blanking station 4104. The winding station 4101, the gluing station 4103, and the blanking station 4104 are arranged sequentially along the circumferential direction. The winding needle 42 at the blanking station 4104 is used for blanking of the electrode assembly 200.

Based on the above structure, when the winding mechanism 40 works, the turret 41 first rotates to rotate the winding needle 42 to the winding station 4101, and the winding needle 42 winds the first composite plate e at the winding station 4101 to form the electrode assembly 200. Then, the turret 41 rotates to rotate the winding needle 42 and the electrode assembly 200 thereon to the gluing station 4103 for the electrode assembly 200 to undergo gluing. Then, the turret 41 rotates to rotate the winding needle 42 and the electrode assembly 200 thereon to the blanking station 4104 for blanking of the electrode assembly 200.

In this way, by adding the blanking station 4104, the electrode assembly 200 can be blanked at the blanking station 4104 without affecting the work of other winding needles 42.

In some embodiments, referring to FIG. 22, the winding mechanism 40 may further include a blanking mechanism 50. The blanking mechanism 50 is used for blanking of the electrode assembly 200 from the blanking station 4104.

The blanking mechanism 50 is a mechanism for blanking of the electrode assembly 200. The blanking mechanism 50 may be, but is not limited to, a clamping jaw 51.

It can be understood that the turret 41 may include the winding station 4101, the finishing station 4102, the gluing station 4103 and the blanking station 4104, and the winding station 4101, the finishing station 4102, the gluing station 4103 and the blanking station 4104 are distributed in sequence along the circumferential direction. When the winding mechanism 40 works at the workstation 401, the turret 41 first rotates to rotate the winding needle 42 to the winding station 4101, and the winding needle 42 winds the first composite plate e at the winding station 4101 to form the electrode assembly 200. Then, the turret 41 rotates the winding needle 42 and the electrode assembly 200 thereon to the finishing station 4102, and the electrode assembly 200 is subjected to the finishing operation by the finishing roller 431 of the finishing station 4102. Then, the turret 41 rotates the winding needle 42 and the electrode assembly 200 thereon to the gluing station 4103, so that the electrode assembly 200 is subjected to gluing by the gluing roller 432. Then, the turret 41 rotates the winding needle 42 and the electrode assembly 200 thereon to the blanking station 4104, so that the electrode assembly 200 is subjected to blanking by the blanking mechanism 50. Then, the turret 41 rotates the winding needle 42 to the winding station 4101 so that the winding needle 42 can wind the next electrode assembly 200.

Referring to FIG. 22, the turret 41 may also include a retraction station 4105. The winding station 4101, the finishing station 4102, the gluing station 4103, the blanking station 4104 and the retraction station 4105 are distributed in sequence along the circumferential direction. It can be understood that the turret 41 rotates the winding needle 42 and the electrode assembly 200 thereon to the blanking station 4104, and after blanking of the electrode assembly 200 through the blanking mechanism 50, the turret 41 rotates the winding needle 42 to the retraction station 4105, and the winding needle 42 retracts into the turret 41. Finally, the turret 41 rotates the winding needle 42 to the winding station 4101, and the winding needle 42 extends to wind the first composite plate e to form the electrode assembly 200. By adding the retraction station 4105, the winding needle 42 retracts and then extends, which makes it easier for the winding needle 42 to clamp and wind the first composite plate e.

Referring to FIG. 22, there are five winding needles 42. The five winding needles 42 can be distributed one by one at the winding station 4101, the finishing station 4102, the gluing station 4103, the blanking station 4104 and the retraction station 4105. The five winding needles 42 can be rotated to the winding station 4101 in sequence, or to the finishing station 4102 in sequence, or to the gluing station 4103 in sequence, or to the gluing station 4103 in sequence, or to the blanking station 4104 in sequence, or to the retraction station 4105 in sequence. This is conducive to improving the winding efficiency of the winding mechanism 40, thereby improving the production efficiency of the electrode assembly 200.

Referring to FIG. 22, the winding mechanism 40 includes the turret 41 and a plurality of winding needles 42 disposed on the turret 41. The plurality of winding needles 42 are circumferentially spaced apart on the turret 41. The turret 41 is provided with the winding station 4101, the finishing station 4102, the gluing station 4103, the blanking station 4104 and the retraction station 4105 which are distributed in sequence along the circumferential direction The turret 41 is rotatable, and the winding needle 42 can rotate with the turret 41 in sequence to the winding station 4101, the finishing station 4102, the gluing station 4103, the blanking station 4104 and the retraction station 4105, and the plurality of winding needles 42 can be located at the winding station 4101, the finishing station 4102, the gluing station 4103, the blanking station 4104 and the retraction station 4105 in one to one correspondence. This is conducive to improving the winding efficiency of the winding mechanism 40, thereby improving the production efficiency of the electrode assembly 200.

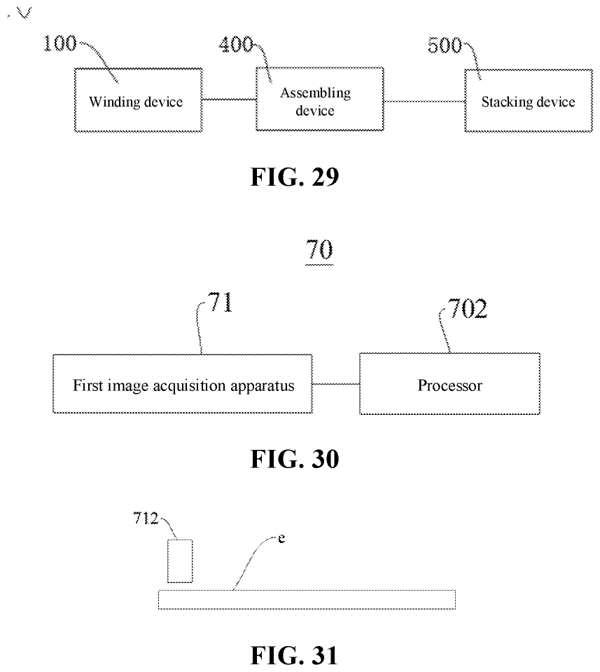

As shown in FIG. 29, the present application further proposes a battery processing device 1001. The battery processing device 1001 includes a winding device 100 of any of the above embodiments. The winding device 100 is configured to process an electrode assembly 200.

In some embodiments, as shown in FIG. 29, the battery processing device 1001 may further include an assembling device 400, which is configured to combine the electrode assembly 200, a housing 3011, etc. to obtain a battery cell 301.

In some embodiments, as shown in FIG. 29, the battery processing device 1001 may further include a stacking device 500. The stacking device 500 is configured to stack a plurality of battery cells to form a battery.

Referring to FIG. 29, the battery processing device 1001 provided in the embodiment of the present application includes a winding device 100. The winding device 100 in this embodiment may be the winding device 100 of any of the above embodiments, which will not be described in detail here.

According to the battery production device 1001 provided in the embodiment of the present application, by using the winding device 100 described in the above embodiments, the layout rationality of the winding device 100 may be improved to improve the layout rationality of the battery processing device 1001, thereby helping to improve the quality of the electrode assembly 200 to improve the quality of the battery 300.

In some embodiments, referring to FIG. 29, the battery processing device 1001 further includes an assembling device 400 and a stacking device 500. The assembling device 400 is configured to assemble the electrode assembly 200 to obtain a battery cell 301, and the stacking device 500 is configured to stack a plurality of battery cells 301 to form a battery 300. With such configuration, the battery 300 can be manufactured.

As shown in FIG. 29, the present application further proposes a battery production line 1000, and the battery production line 1000 may include a winding device 100 of any of the above embodiments or a battery processing device 1001 of any of the above embodiments. According to the battery production line 1000 provided in the embodiment of the present application, by using the winding device 100 or battery processing device 1001 described in the above embodiments, the layout rationality of the winding device 100 may be improved to improve the layout rationality of the battery processing device 1001, thereby helping to improve the quality of the electrode assembly 200 to improve the quality of the battery 300.

It should be noted that the embodiments in the present application and features in the embodiments may be mutually combined in the case of no conflict.

The above descriptions are merely preferred embodiments of the present application and are not intended to limit the present application. For those skilled in the art, the present application may have various modifications and changes. Any modifications, equivalent substitutions, improvements, etc. made within the spirit and principles of the present application shall fall into the scope of protection of the present application.

What is claimed is:

1. A winding device for producing an electrode assembly, the electrode assembly comprising a first electrode plate, a second electrode plate, a first separator and a second separator, wherein the winding device comprises:
a first combining mechanism configured to combine incoming materials including at least the first electrode plate, the first separator and the second electrode plate into a first composite plate;
a winding mechanism located downstream of the first combining mechanism and configured to wind the incoming material including at least the first composite plate into the electrode assembly; and
a first detection apparatus comprising a first image acquisition apparatus and a processor;
wherein the first image acquisition apparatus is located between the first combining mechanism and the winding mechanism and is configured to obtain edge position images of at least one of the first electrode plate and the second electrode plate in the first composite plate; and
the processor is configured to determine an edge distance based on the edge position images and judge whether the edge distance meets a threshold.

2. The winding device according to claim 1, wherein the first image acquisition apparatus is configured to obtain edge position images of the first electrode plate and the first separator in the first composite plate, and the edge distance comprises an edge distance between the first electrode plate and the first separator.

3. The winding device according to claim 1, wherein the first image acquisition apparatus is configured to obtain edge position images of the second electrode plate and the first separator in the first composite plate, and the edge distance comprises an edge distance between the second electrode plate and the first separator.

4. The winding device according to claim 1, wherein the first image acquisition apparatus is configured to obtain edge position images of the first electrode plate and the second electrode plate in the first composite plate; or the first image acquisition apparatus is configured to obtain edge position images of the first electrode, the second electrode plate and the first separator in the first composite plate; and the edge distance comprises an edge distance between the first electrode plate and the second electrode plate.

5. The winding device according to claim 1, wherein the first image acquisition apparatus is configured to obtain widthwise-side edge position images of the first composite plate in a width direction, and the processor is configured to determine an edge distance of one and/or both widthwise sides based on the widthwise-side edge position images, and judge whether the edge distance meets a corresponding threshold.

6. The winding device according to claim 5, wherein the first image acquisition apparatus comprises a first acquisition unit, the first acquisition unit comprises two groups of CCD cameras, the two groups of CCD cameras are arranged, in a thickness direction of the first composite plate, on two sides of the first composite plate respectively, and the two groups of CCD cameras are respectively configured to obtain the widthwise-side edge position images of the first composite plate in the width direction.

7. The winding device according to claim 6, wherein each group of CCD cameras in the first acquisition unit comprises two CCD cameras, the two CCD cameras in the same group are spaced apart in the width direction of the first composite plate, and the two CCD cameras in the same group are respectively configured to obtain the widthwise-side edge position images of edge positions of two sides of the first composite plate in the width direction.

8. The winding device according to claim 5, wherein the first image acquisition apparatus comprises a second acquisition unit, the second acquisition unit comprises an X-ray camera, and the X-ray camera is configured to obtain the widthwise-side edge position images of the first composite plate in the width direction.

9. The winding device according to claim 1, wherein the first image acquisition apparatus is configured to obtain lengthwise-end edge position images of the first electrode plate and the second electrode plate in a length direction of the first composite plate, and the processor is configured to determine an edge distance between the heads and/or tails of the first electrode plate and the second electrode plate based on the lengthwise-end edge position images of the first electrode plate and the second electrode plate, and judge whether the edge distance meets a corresponding threshold, wherein
the first image acquisition apparatus comprises a third acquisition unit, the third acquisition unit comprises two groups of CCD cameras, the two groups of CCD cameras are arranged, in a thickness direction of the first composite plate, on two sides of the first composite plate, and the two groups of CCD cameras are respectively configured to obtain edge position images of heads or tails of the first electrode plate and the second electrode plate in the length direction of the first composite plate; and/or
the first image acquisition apparatus comprises a fourth acquisition unit, the fourth acquisition unit comprises an X-ray camera, and the X-ray camera is configured to obtain edge position images of the heads or tails of the first electrode plate and the second electrode plate in the length direction of the first composite plate.

10. The winding device according to claim 1, further comprising:
a rejection mechanism between the first image acquisition apparatus and the winding mechanism, wherein the rejection mechanism is configured to reject a first composite plate that fails to meet the threshold based on a signal, indicating that the edge distance does not meet the threshold, sent by the processor.

11. The winding device according to claim 1, wherein the winding device comprises a first feeding mechanism, a second feeding mechanism, a third feeding mechanism, and a fourth feeding mechanism; the first feeding mechanism is configured to release the first electrode plate; the second feeding mechanism is configured to release the second electrode plate; the third feeding mechanism is configured to release the first separator; the fourth feeding mechanism is configured to release the second separator; the fourth feeding mechanism is arranged upstream of the first combining mechanism, and the first combining mechanism is configured to combine the incoming materials comprising at least the first electrode plate, the first separator, the second electrode plate, and the second separator into a first composite plate, wherein
the first combining mechanism is an edge sealing mechanism and is configured to seal and connect at least one of two side edges of the first separator and the second separator in a width direction; and/or
the winding device further comprises:
a second combining mechanism located upstream of the first combining mechanism and downstream of the first feeding mechanism and the third feeding mechanism and configured to combine the first electrode plate and the first separator into a second composite plate.

12. The winding device according to claim 11, wherein
the second combining mechanism is a composite mechanism and is configured to fixedly connect the first electrode plate and the first separator in the second composite plate;
the winding device further comprises:
a second image acquisition apparatus located between the second combining mechanism and the first combining mechanism and configured to detect the second composite plate;
the winding device further comprises:
a first temporary storage mechanism disposed between the second combining mechanism and the first combining mechanism and configured to store the second composite plate temporarily, wherein the winding device comprises a first cutting mechanism configured to cut the first electrode plate and disposed between the first feeding mechanism and the second combining mechanism; and/or
the second electrode plate and the second separator are separately fed into the first combining mechanism, and the winding device comprises a second cutting mechanism configured to cut the second electrode plate and disposed between the second feeding mechanism and the first combining mechanism, wherein the second cutting mechanism comprises a cam cutter.

13. The winding device according to claim 11, wherein the winding device further comprises:
a third combining mechanism located upstream of the first combining mechanism and downstream of the second feeding mechanism and the fourth feeding mechanism and configured to combine the second electrode plate and the second separator into a third composite plate, wherein the third combining mechanism is a composite mechanism and is configured to fixedly connect the second electrode plate and the second separator in the third composite plate;
the winding device further comprises:
a third image acquisition apparatus located between the third combining mechanism and the first combining mechanism and configured to detect the third composite plate; and/or
the winding device further comprises:
a second temporary storage mechanism disposed between the third combining mechanism and the first combining mechanism and configured to store the third composite plate temporarily, wherein the winding device comprises a second cutting mechanism configured to cut the second electrode plate and disposed between the second feeding mechanism and the third combining mechanism.

14. The winding device according to claim 11, wherein the winding device further comprises:
a fifth combining mechanism located upstream of the first combining mechanism and downstream of the third feeding mechanism, the second feeding mechanism, and the fourth feeding mechanism and configured to combine the first separator, the second electrode plate, and the second separator into a fifth composite plate, wherein
the fifth combining mechanism is an edge sealing mechanism and is configured to seal and connect at least one of two side edges of the first separator and the second separator in a width direction;
the fifth combining mechanism is a composite mechanism and is configured to fixedly connect the second electrode plate, the first separator and the second separator in the fifth composite plate, respectively;
the first combining mechanism is a composite mechanism and is configured to fixedly connect the fifth composite plate and the first electrode plate;
the winding device further comprises:
a fifth image acquisition apparatus located between the fifth combining mechanism and the first combining mechanism and configured to detect the fifth composite plate; and/or
the winding device further comprises:
a fourth temporary storage mechanism disposed between the fifth combining mechanism and the first combining mechanism and configured to store the fifth composite plate temporarily.

15. The winding device according to claim 14, wherein the winding device comprises a second cutting mechanism configured to cut the second electrode plate and disposed between the second feeding mechanism and the fifth combining mechanism.

16. The winding device according to claim 14, wherein the winding device further comprises:
a fifth temporary storage mechanism disposed between the first combining mechanism and the winding mechanism and configured to store the first composite plate temporarily.

17. The winding device according to claim 16, wherein the winding device further comprises a first cutting mechanism configured to cut the first electrode plate and disposed between the first feeding mechanism and the first combining mechanism.

18. The winding device according to claim 11, wherein the winding device comprises a third cutting mechanism configured to cut the first separator and the second separator and disposed between the first combining mechanism and the winding mechanism.

19. The winding device according to claim 1, wherein the winding device comprises a first feeding mechanism, a second feeding mechanism, a third feeding mechanism, and a fourth feeding mechanism; the first feeding mechanism is configured to release the first electrode plate; the second feeding mechanism is configured to release the second electrode plate; the third feeding mechanism is configured to release the first separator; the fourth feeding mechanism is configured to release the second separator; and the second separator and the first composite plate are combined at a position downstream of the first image acquisition apparatus, wherein the winding device further comprises:
a sixth temporary storage mechanism disposed between the first combining mechanism and the winding mechanism and configured to store the first composite plate temporarily.

20. The winding device according to claim 19, wherein the first combining mechanism is a composite mechanism and is configured to fixedly connect both the first electrode plate and the second electrode to the first separator, in the first composite plate.

21. The winding device according to claim 19, wherein the winding device further comprises:
a sixth combining mechanism located between the first combining mechanism and the winding mechanism, wherein the fourth feeding mechanism is located upstream of the sixth combining mechanism and the sixth combining mechanism and is configured to combine the first composite plate and the second separator into a sixth composite plate.

22. The winding device according to claim 21, wherein the sixth combining mechanism is an edge sealing mechanism, and is configured to seal and connect edges of two sides of the first separator and the second separator in a width direction, wherein the winding device further comprises:
a sixth image acquisition apparatus located between the sixth combining mechanism and the winding mechanism and configured to detect the sixth composite plate.

23. The winding device according to claim 21, wherein the winding device comprises a third cutting mechanism configured to cut the first separator and the second separator and disposed between the sixth combining mechanism and the winding mechanism.

24. The winding device according to claim 23, wherein the winding device comprises a first cutting mechanism for cutting the first electrode plate and a second cutting mechanism for cutting the second electrode plate; the first cutting mechanism is disposed between the first feeding mechanism and the first combining mechanism, and the second cutting mechanism is disposed between the second feeding mechanism and the first combining mechanism.

25. The winding device according to claim 19, wherein the first electrode plate, the first separator, and the second electrode plate are fed into the first combining mechanism separately.

26. The winding device according to claim 19, wherein the fourth feeding mechanism and the first composite plate are combined at the winding mechanism.

27. A battery processing device, comprising the winding device according to claim 1.

28. A battery production line, comprising the winding device according to claim 1 or comprising the battery processing device according to claim 27.
